(19) United States
(12) Patent Application Publication
(10) Pub. No.: US 2013/0018791 A1
(43) Pub. Date: Jan. 17, 2013

(54) FRAUD DATA EXCHANGE SYSTEM

(71) Applicants: Frank J. Mendicino, Huntersville, NC (US); Victoria Lynn Dravneek, Charlotte, NC (US)

(72) Inventors: Frank J. Mendicino, Huntersville, NC (US); Victoria Lynn Dravneek, Charlotte, NC (US)

(73) Assignee: Bank of America Corporation, Charlotte, NC (US)

(21) Appl. No.: 13/217,214

(22) Filed: Aug. 24, 2011

Related U.S. Application Data
(60) Provisional application No. 61/508,010, filed on Jul. 14, 2011.

(51) Int. Cl. G06Q 40/00

(52) U.S. Cl. 705/44

(57) ABSTRACT

A fraud data exchange system performs a method for processing a transfer request using shared fraud data including receiving a transfer request comprising information corresponding to an account to be debited and information corresponding to an account to be credited, approving the information corresponding to the account to be debited, and accessing a database to retrieve fraud data. The database includes fraud data shared among two or more financial institutions, and the fraud data includes a plurality of entries, each entry corresponding to one or more accounts and comprising one or more data fields. Each data field corresponds to a characteristic of the accounts and tends to indicate whether the transfer request is fraudulent. The method includes determining a likelihood of fraudulent activity, based on the accessed fraud data and determining, based at least in part on the determined likelihood of fraudulent activity, whether to complete the transfer.

### CLAIM OF PRIORITY UNDER 35 U.S.C. §119

This Non-provisional patent application claims priority to Provisional Patent Application Ser. No. 61/508,010 titled “Fraud Data Exchange System” filed Jul. 14, 2011, assigned to the assignee hereof and hereby expressly incorporated by reference herein.

### FIELD

In general, embodiments of the invention relate to a fraud data exchange system. More specifically, embodiments of the invention relate to systems for processing a transfer request using shared fraud data.

### BACKGROUND

With the wide adoption of credits cards, debit cards, electronic payment devices, online shopping systems, and online banking systems, very few people today carry a lot of cash or write many checks. However, people still need to transfer money to each other for all sorts of reasons. For example, a person may want to pay a friend back for money recently borrowed from the friend, or a person may want to send money to a relative as a gift. Giving or lending money to another person, however, can be difficult when you don't have cash on hand and/or if the person is not physically present. The process may need to involve going to an automated teller machine (ATM) or mailing the person a check, both of which can be time consuming and inconvenient depending on the situation.

Money can be transferred from one person to another using electronic banking systems, but these systems traditionally require that the sender know account information for the receiver in order to instruct the bank to transfer money to the proper account. Most people do not know the account numbers of their friends, nor do most people want to widely publicize their account numbers for security reasons.

Some third party service providers try to facilitate payments from one person to another, but many people do not like these systems because they require opening yet another account with another online entity, remembering yet another username and password, and disclosing confidential financial institution account information to these other companies. In addition to the inconvenience and the security concerns, these systems generally take time set up and are not user-friendly.

Furthermore, financial institutions continually strive to improve fraud detection during transfer activity.

### BRIEF SUMMARY

Embodiments of the invention address these and/or other needs by providing an innovative person-to-person (P2P) payment system along with a user-friendly interface and process for sending and receiving P2P payments. Advantageously, embodiments of the invention do not necessarily require users to share confidential account information with others in order to send and receive payments. In fact, embodiments of the invention do not require that the payment sender know any information about the financial accounts of the intended payment recipient. Furthermore, embodiments of the invention enable users to attempt to make payments to persons that are not customers of the same financial institution and to persons that are not customers of any financial institution. Embodiments of the invention also create a “viral” account opening and payment system registration process whereby one person's use of the system encourages others to use the system.

More specifically, embodiments of the invention allow an entity to transfer funds to another entity using a mobile telephone number, electronic mail (email) address, and/or other alias of the transfer recipient. The assignee of the present application describes some embodiments of such an invention in U.S. Provisional Patent Application No. 60/991,172, filed on Nov. 29, 2007, and co-pending U.S. patent application Ser. No. 12/038,177, filed on Feb. 27, 2008, as well as in U.S. patent application Ser. Nos. 12/881,071, 12/881,073, 12/881,074, and 12/881,080 continuing therefrom. Embodiments of the invention may include and build off of those earlier embodiments to provide an improved P2P payment system and a more user-friendly, secure, and convenient user interface and method as well as a fraud data exchange system.

Furthermore, embodiments of the invention include and build off of the following applications sharing a common assignee with the present application: U.S. Provisional Patent Application No. 61/410,085, filed on Nov. 4, 2010; U.S. Provisional Patent Application No. 61/410,087, filed on Nov. 4, 2010; U.S. Design Patent Application No. 29/378,420, filed on Nov. 4, 2010; and U.S. Design Patent Application No. 29/378,418, filed on Nov. 4, 2010, and as such, herein incorporate these applications by reference.

As described in greater detail below, the user interface can be incorporated into the online banking website of a bank or other financial institution. A user can authenticate her identity using the online banking authentication system and the user's authentication information and procedures that are already known to the user for interacting with online banking. The user can then use the online banking interface to register a mobile phone number, email address, or other alias by associating the number, address, or other alias with one of the user's financial institution accounts. This association is then stored in a data repository that can later be accessed by the bank and, in some cases, other financial institutions. Some embodiments of the invention provide a system for verifying that the alias is owned, held, or otherwise associated with the user, the system including immediately sending a code to the user's device using the alias (e.g., sending a code in a text or email) and having the user enter the code into the online banking interface shortly thereafter.

The online banking interface can also be used to initiate transfers to others using aliases. In some embodiments of the invention, a user can create a transfer recipient by entering the recipient's name, alias (e.g., mobile phone number or email address), and a descriptive name for the person, commonly referred to as a nickname. The user can then create a transfer request by using the online banking interface to select an account associated with the user's online banking account, enter or select the nickname of the saved recipient, and enter a monetary amount. The banking system then accesses the data repository to determine whether the alias is registered and thereby associated with a financial institution account. If the alias is registered, the banking system sends a transfer notification to the recipient using the alias and/or initiates the funds transfer. If the alias is not registered, then the banking system uses the alias to send the transfer recipient a notification (e.g., a text message, email or the like), the notification telling the person that there is a pending transfer that will be processed if the person registers her alias with an existing financial institution account and/or opens a new financial institution account. The notification then provides a link to the online banking website, a mobile banking website, or a mobile banking application that allows the person to easily register an existing account or open a new account.

Embodiments of the invention also provide a user interface that makes it easy for users to monitor their current, future, pending, and past person-to-person (P2P) and/or person-to-merchant (P2M) funds transfers as well as their saved transfer recipient list, alias registrations, incoming transfers, and/or other related information.

It should be appreciated that at least some embodiments of the invention provide a more convenient, user friendly, and secure P2P payment system because it is provided by the user's bank, through the bank's online banking system with which the user is already familiar. In at least some embodiments, the user may not need to share personal or confidential information, such as account information, with people or businesses outside of the user's bank. The user can feel more secure having P2P payment services handled by their bank and having the convenience of being able to directly send money from and/or receive money into the user's one or more financial institution accounts.

According to other embodiments of the invention, a method for processing a transfer request using shared fraud data includes receiving, at a computing device, a transfer request comprising information corresponding to an account to be debited and information corresponding to an account to be credited; approving, using a computing device, the information corresponding to the account to be debited; accessing, using a computing device, a database to retrieve fraud data, the database comprising fraud data shared among two or more financial institutions, the fraud data comprising a plurality of entries, each entry corresponding to one or more accounts and comprising one or more data fields, each corresponding to a characteristic of the one or more accounts and tending to indicate whether the transfer request is fraudulent; determining, using a computing device, a likelihood of fraudulent activity, based at least in part on the accessed fraud data; and determining, based at least in part on the determined likelihood of fraudulent activity, whether to complete the transfer.

In some embodiments, the database comprises a plurality of registered aliases, each associated with a user owning one or more accounts. In some such embodiments, the method also includes determining whether an alias received along with the transfer request is registered in the database. In some of these embodiments, accessing the database to retrieve fraud data comprises accessing fraud data associated with the alias received along with the transfer request.

In some embodiments, the fraud data comprises one or more of age of an account, state of an account, overdrawn information, email address change information, online banking enrollment information, online banking password change information, IP address information, or cookie information. In some embodiments, the fraud data comprises only publicly available information. In some embodiments, the fraud data comprises non-sensitive information.

According to other embodiments of the invention, a system for processing a transfer request using shared fraud data has a computing device configured for receiving a transfer request comprising information corresponding to an account to be debited and information corresponding to an account to be credited; approving the information corresponding to the account to be debited; accessing a database to retrieve fraud data, the database comprising fraud data shared among two or more financial institutions, the fraud data comprising a plurality of entries, each entry corresponding to one or more accounts and comprising one or more data fields, each corresponding to a characteristic of the one or more accounts and tending to indicate whether the transfer request is fraudulent; determining a likelihood of fraudulent activity, based at least in part on the accessed fraud data; and determining, based at least in part on the determined likelihood of fraudulent activity, whether to complete the transfer.

In some embodiments, the database comprises a plurality of registered aliases, each associated with a user owning one or more accounts. In some such embodiments, the computing device is further configured for determining whether an alias received along with the transfer request is registered in the database. In some of these embodiments, accessing the database to retrieve fraud data comprises accessing fraud data associated with the alias received along with the transfer request.

In some embodiments, the fraud data comprises one or more of age of an account, state of an account, overdrawn information, email address change information, online banking enrollment information, online banking password change information, IP address information, or cookie information. In some embodiments, the fraud data comprises only publicly available information. In some embodiments, the fraud data comprises non-sensitive information.

According to embodiments of the invention, a computer program product includes a non-transient computer-readable medium having computer-executable instructions for processing a transfer request using shared fraud data. The instructions include instructions for receiving a transfer request comprising information corresponding to an account to be debited and information corresponding to an account to be credited; instructions for approving the information corresponding to the account to be debited; instructions for accessing a database to retrieve fraud data, the database comprising fraud data shared among two or more financial institutions, the fraud data comprising a plurality of entries, each entry corresponding to one or more accounts and comprising one or more data fields, each corresponding to a characteristic of the one or more accounts and tending to indicate whether the transfer request is fraudulent; instructions for determining a likelihood of fraudulent activity, based at least in part on the accessed fraud data; and instructions for determining, based at in part on the determined likelihood of fraudulent activity, whether to complete the transfer.

In some embodiments, the database comprises a plurality of registered aliases, each associated with a user owning one or more accounts. In some such embodiments, the instructions further comprise instructions for determining whether an alias received along with the transfer request is registered in the database. In some such embodiments, the instructions for accessing the database to retrieve fraud data comprise instructions for accessing fraud data associated with the alias received along with the transfer request.

In some embodiments, the fraud data comprises one or more of age of an account, state of an account, overdrawn information, email address change information, online banking enrollment information, online banking password change information, IP address information, or cookie information. In some embodiments, the fraud data comprises only publicly available information. In some embodiments, the fraud data comprises non-sensitive information.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a combination flowchart and block diagram of a system and method for making P2P payments in accordance with example embodiment of the invention;

FIG. 2 is a block diagram illustrating the various ways through which a customer may make P2P payments in accordance with various embodiments of the invention;

FIG. 3 provides a block diagram illustrating an online banking P2P payment system and environment in accordance with an embodiment of the invention;

FIG. 4 provides a block diagram illustrating the first user's personal computing device of FIG. 3, in accordance with an embodiment of the invention;

FIG. 5 provides a block diagram illustrating the second user's personal computing device of FIG. 3, in accordance with an embodiment of the invention;

FIG. 6 provides a block diagram illustrating the financial institution's online banking system of FIG. 3, in accordance with an embodiment of the invention;

FIG. 7 provides a block diagram illustrating the alias data repository of FIG. 3, in accordance with an embodiment of the invention;

FIGS. 8A-8D provide flow charts illustrating a process for sending P2P payments, in accordance with embodiments of the invention;

FIGS. 9A-9G provide screenshots of a graphical user interface used during the process described in FIGS. 8A-8D, in accordance with embodiments of the invention;

FIGS. 10A-10C provide flow charts illustrating a process for receiving P2P payments, in accordance with embodiments of the invention;

FIGS. 11A-11F provide screenshots of a graphical user interface used during the process described in FIGS. 10A-10C, in accordance with an embodiment of the invention;

FIGS. 12A-12C provide screenshots of a graphical user interface used during the processes of accessing the list of outbound transfer recipients and inbound transfer options, editing a transfer recipient's information, and deleting a transfer recipient's information, in accordance with embodiments of the invention;

FIG. 13 provides a block diagram illustrating a mobile banking P2P payment system and environment, in accordance with an embodiment of the invention;

FIG. 14 provides a block diagram illustrating the first user's mobile computing device of FIG. 13, in accordance with an embodiment of the invention;

FIG. 15 provides a block diagram illustrating the second user's personal computing device of FIG. 13, in accordance with an embodiment of the invention;

FIG. 16 provides a block diagram illustrating the financial institution's mobile banking system of FIG. 13, in accordance with an embodiment of the invention;

FIG. 17 provides a block diagram illustrating the alias data repository of FIG. 13, in accordance with an embodiment of the invention;

FIGS. 18A-18E provide flow charts illustrating a process for sending P2P payments, in accordance with embodiments of the invention;

FIGS. 19A-19G provide screenshots of a graphical user interface used during the process described in FIGS. 18A-18E, in accordance with embodiments of the invention;

FIGS. 20A-20C provide flow charts for receiving P2P payments, in accordance with embodiments of the invention, in accordance with embodiments of the invention;

FIG. 21 provides a flowchart for sending P2P payments via text message, in accordance with an embodiment of the invention;

FIGS. 22A-22D provide illustrations of a graphical user interface used during the process described in FIG. 21, in accordance with embodiments of the invention;

FIG. 23 provides a block diagram illustrating a fraud data exchange system according to embodiments of the invention;

FIGS. 24A and 24B provide combined block diagrams and flow charts illustrating processes for fraud data exchange; and

FIG. 25 provides a flow chart illustrating a process for fraud data exchange.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. In specific embodiments of the invention, use of the term “bank,” is limited to a financial entity in which account-bearing customers conduct financial transactions, such as account deposits, withdrawals, transfers and the like.

Some embodiments of the invention provide a system and method for online banking integrated person-to-person (P2P) payments. Embodiments of the invention allow customers of a financial entity to make payments directly from their accounts, whether their accounts be checking, savings, line of credit, credit card, and/or other accounts, to a payment recipient, including financial entity customers and non-financial entity customers, without having to share any confidential account information and without having to know account information for the intended payment recipient. Embodiments of the invention also allow customers and non-customers to receive payments from others directly into their financial institution accounts without requiring the customer to share account information with the payment sender. It should be noted that some embodiments of the invention allow a customer to make payments to and/or receive payments from a merchant in the same way that a customer can make payments to and/or receive payments from another person. As such, as used herein, the phrase person-to-person (P2P) is intended to include person-to-merchant (P2M), merchant-to-merchant (M2M), and merchant-to-person (M2P) unless specifically stated otherwise. Moreover, embodiments of the invention permit a sender to send money from the sender's financial institution account directly to the recipient's financial institution account using the alias of the recipient without the involvement of an intermediary or a third party. This allows for greater security as no party apart from the sender, the recipient, and the bank is ever a part of the transfer.

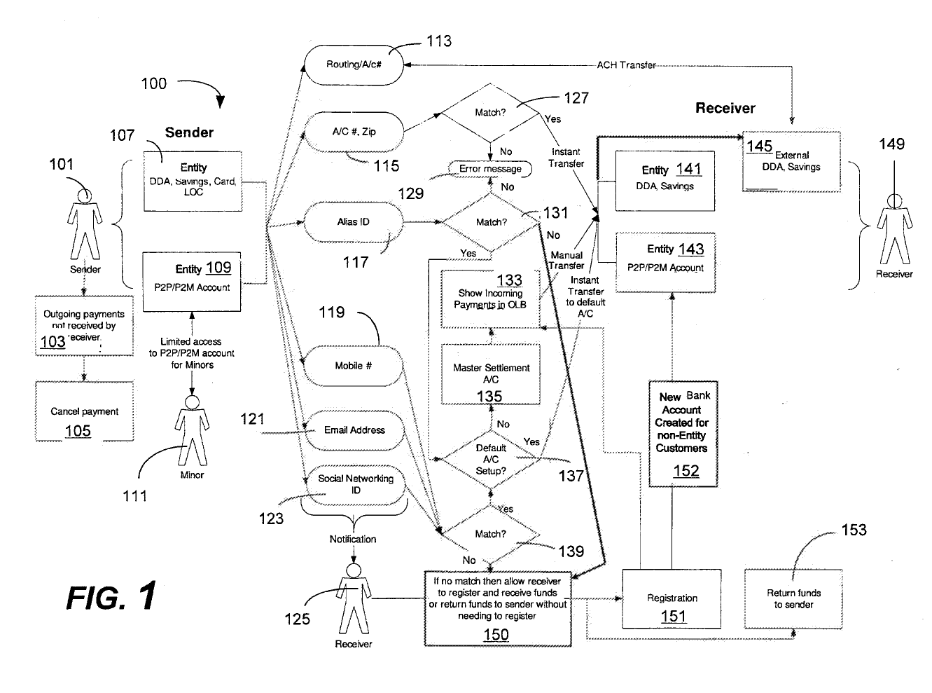

FIG. 1 is a combination block diagram and flowchart providing an overview of a system and method 100 for making P2P payments, in accordance with one or more embodiments of the invention. A customer 101 with an eligible account 107, e.g., checking (demand deposit account or “DDA”), savings, money market, line of credit, credit card, etc., of a financial entity is be able to register and make use of this service. During the registration process, the customer 101 is able to set up an alias identifier (ID) 117 (or simply an “alias”) that maps back to the customer's account. The alias 117 may be any unique identifier other than the customer's financial institution account number. Typically, the alias 117 is an identifier that friends, family, and/or other members of the public uniquely associate with the customer 101. For example, the alias 117 may be a mobile telephone number 119, an email address 121, a social networking ID 123, and/or the like. The embodiments of the invention described herein in the other figures generally permit the customer 101 to use either a mobile telephone number 119 or an email address 121 as the account alias, but it will be appreciated that, in view of this disclosure, other embodiments of the invention may allow use of other types of aliases.

The information provided by the customer 101 during registration of an alias may be verified to confirm that the customer 101 does have access to the mobile number 119, email address 121, social networking ID 123, or other alias 117 provided. For example, as described in greater detail below, the financial institution (or other entity that maintains a database of aliases and associates them with financial institution accounts) may send a communication to the customer 101 using the alias and require the customer 101 confirm access to the alias by responding to the notice in some way. For example, if the alias registered by the customer 101 is a mobile telephone number 119, the financial institution may send a text message to the mobile telephone number 119 with a code and then require that the customer 101 enter the code into a mobile banking or online banking application to confirm that the mobile telephone number is associated with the customer 101. Once the alias information is verified, then the alias is linked to one or more of the customer's financial institution accounts in a data repository maintained by the financial institution or some other entity that provides an alias registry service to the financial institution.

The customer 101 can also use embodiments of the invention to make payments to other entity's, such as receiver 125, using an alias of the receiver 125. In some embodiments of the invention, the customer 101 is able to set preferences for accounts to be used for outgoing payments, and default account(s) for incoming payments. In some embodiments of the invention, the financial institution places limits (e.g., maximums and/or minimums) on how much money can be sent or received over a specified period of time using P2P payment aliases, and such limits may be based on the sender, the receiver, whether the receiver is a customer of the financial institution or a partner financial institution, account history, credit ratings, customer status, whether the customer has registered the alias, and/or any other relevant information. In some embodiments, the customer 101 can also establish limits on P2P payments. For example, a customer 101 may want to set a maximum of $1000 for P2P payments where an alias is used for the recipient as opposed to an account number.

In some embodiments of the invention, the customer 101 may also have an option of opening a new P2P account 109 with the financial institution that the customer may use exclusively for making and/or receiving P2P payments. This financial entity P2P account 109 may be like any other account hosted at the financial entity and so money may be moved instantly into this account 109 through the regular online banking transfer process for moving money between a customer's accounts. This account 109 may be a type of checking account except that it may come with certain limitations, e.g., no checks, maximum balance limits, number of daily transactions or the like, and may be opened by customers by providing much less information as compared to a regular checking account. The financial entity may, at a minimum, require customers to provide certain information, such as name, address, date of birth, and social security number, in order to comply with Anti-Money Laundering (AML) regulations. Customers 101 of the financial entity may also have an option to set up P2P accounts 109 (i.e., sub-accounts) for minors 125, other dependents, or related entities. Customers 101 are able to access these accounts just like any of their other accounts. In addition, customers 101 are able to set up an online banking access ID for the minor 125 that the minor 125 may use to sign into online banking but have access only to the specific minor P2P account 109 set up for them. These P2P-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

Referring again to FIG. 1, customers 101 of the financial entity are able to make payments to other people through any of a number of different methods. Payments may be made by a routing number/account number 113. Payments may also be made by providing an account number and an additional identifier, such as a zip code 115. If there is a match to an existing financial entity account in 127, then the funds are transferred instantly to that account. Else, an error message 129 may be generated.

In accordance with embodiments of the invention, payments may be made by providing an alias 117. In general, as described in greater detail below, the customer 101 initiates a P2P payment using an alias by communicating an alias 117 and an associated payment amount to the financial institution. The financial institution then accesses an alias database, or other type of data repository, to determine if the entered alias 117 has been registered by the alias holder and is, thereby, associated with a particular financial institution account. If the alias 117 does have a match to another customer in 131 or financial institution account of another customer 131, then the payment may be initiated to that person, as described in greater detail below. If there is no match, then either an error message 129 is generated or, if possible, the alias 117 may be used to contact the intended recipient 125 and allow this person to register the alias 117 and thereby associate the alias with a financial institution account. At any time, if outgoing payments or payment notifications are not received by a receiver (as represented by block 103), the payment may be canceled (as represented by block 105).

In some embodiments of the invention, an alias 117 may be associated with multiple financial institution accounts of the alias holder. In some such embodiments, the alias holder may be a able to establish a default account when registering the alias 117 or afterwards. Consequently, if a receiver 125 does have a default account for incoming payments in 137, then the funds may be transferred instantly to that account(s). If the receiver 125 has not set up a default account in 137 but the receiver 125 does have multiple accounts associated with the alias 117, then the funds may be moved to a master settlement account 135 and the receiver 125 may see the payment as an incoming payment within online banking 133. The receiver 125 may then be able to use the online banking application to move the funds instantly to any of the receiver's others accounts. In other embodiments, however, each alias 117 is associated only with one financial institution account and, therefore, steps 137 and 135 are not needed and the payment is deposited directly into the one financial institution account associated with the alias 117.

As further illustrated in FIG. 1, the alias 117 may be a mobile telephone number 119 and, as such, payment may be made by the customer 101 providing a mobile phone number 119 (the mobile telephone number 119 being the mobile telephone number of the intended payment recipient 125) along with an associated payment amount. This operation may perform exactly as described above for the alias 117 if there is a match in 139 on the mobile number. If there is no match in 139, then a text message may be sent to the mobile number 119 provided (as represented by block 150). If the receiver 125 of the message is an existing financial institution customer (or, in some embodiments, if the receiver 125 is a customer of a partner financial institution), then that person may be allowed to sign into their online or mobile banking account, register the phone number as illustrated by block 151 (thereby associating the phone number with a financial institution account for P2P payment purposes), and then receive funds similar to the process described above for the alias 117. If the receiver 125 is not a financial entity customer with an account eligible for receiving funds, then the receiver 125 may be given the option to sign up (as represented by block 152) for a financial institution account 141 or 143 at the financial institution or return funds to the sender (as represented by block 153).

As further illustrated in FIG. 1, the alias 117 may be an email address 121 and, as such, payment may be made by the customer 101 providing an email address 121 (the email address 121 being an email address of the intended payment recipient 125) along with an associated payment amount. This operation may perform exactly as described above for a mobile number 119 except that the notification message (with the registration or account opening option if appropriate) is sent to the email address 121 provided.

In some embodiments of the invention, payment may be made by providing a social networking ID 123, such as a unique ID associated with the receiver 125 on a particular social networking Internet site. In such a situation, the process operates in the same way as described above for mobile phone number 119 and email address 121 except the social networking platform may be used to notify the receiver based on the social networking ID 123 provided.

In all cases described above, if the receiver 125 is already a customer of the financial institution or a partner financial institution and has already registered the alias 117 provided by the sender 101, a text message, email, online banking notice, mobile banking notice, or other type of message may be sent to receiver 125 based on the alias 117 entered by the sender 101 or irrespective of information entered by sender if there is other contact information found in the receiver's profile, the notification notifying the receiver 125 of the payment. In some embodiments, the receiver 125 may be allowed to reject or re-route the payment. In some embodiments of the invention, the sender 101 is permitted to include a note to the recipient 125 along with the payment, such as a note explaining to the recipient what the purpose of payment.

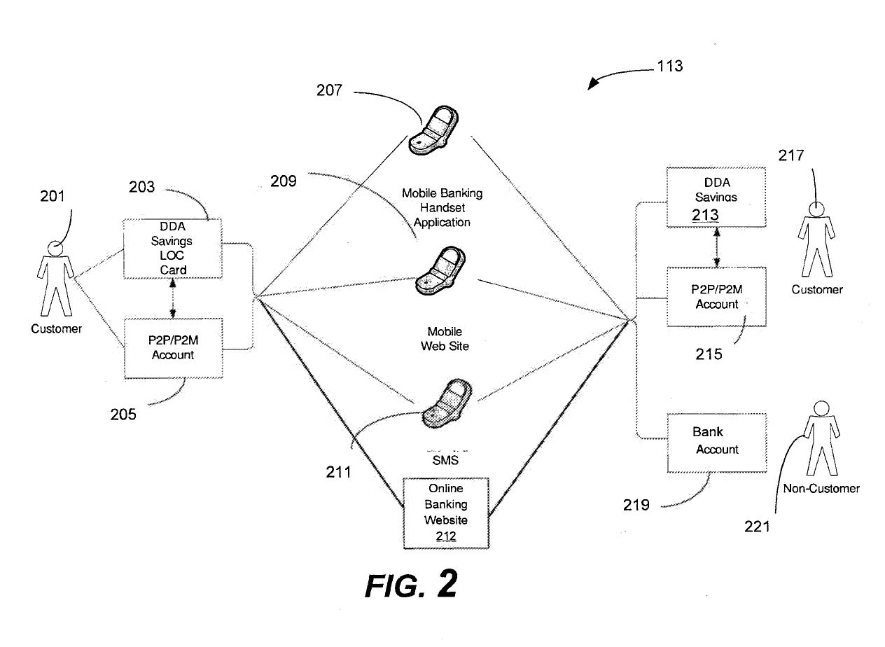

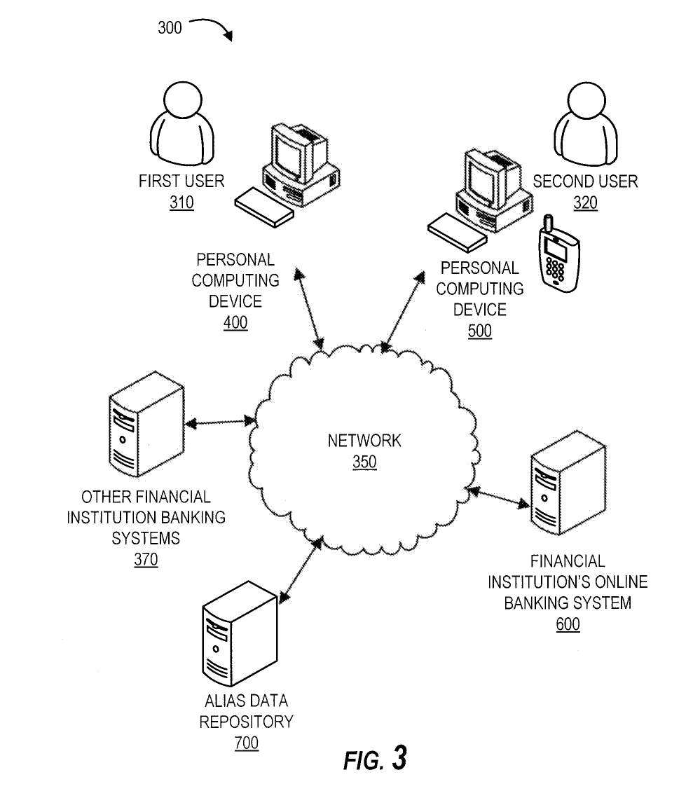

FIG. 2 is a block diagram illustrating the various ways through which a customer may make P2P payments in accordance with various embodiments of the invention. As illustrated, in some embodiments of the invention, a customer 201 who is signed up for the P2P payment service has the option to initiate P2P payments from a DDA, savings, line of credit, and/or credit card account 203 of the financial entity (and/or from a P2P-specific account 205 with the financial entity) through the financial entity's mobile banking website 209 or a mobile banking handset application 207 by providing any of the above-described alias information, e.g., phone number, email address, social networking ID, and/or other alias, along with a payment amount. In some embodiments of the invention, customers can alternatively or additionally initiate payments by sending a text message 211 to the financial entity, the text message including the receiver's phone number, email address, social networking ID, nickname, or other alias. In some embodiments, customers can alternatively or additionally use the financial institution's online banking website 212 to initiate a payment using an alias, as described in greater detail below with respect to FIGS. 3-12C. Whether via a mobile banking handset application 207, mobile website 209, short message service 211, or online banking website 212, a receiver 217 associated with the financial entity may receive funds at the receiver's financial institution account (e.g., DDA, savings, or credit account 213 or P2P-specific account 215). A receiver 221 not associated with the financial entity 221 may receive funds at the receiver's financial institution account 219 at another partner financial institution if the account is registered and associated with the alias and/or the receiver 221 may be prompted to register for the service and/or open an account with the financial institution in order to receive the payment from the sender 201.

It should be appreciated that embodiments of the invention described above permit an entity to send money to another entity even if the sending entity does not know any account information for the recipient entity and only knows a mobile telephone number or email address of the recipient entity. This can also result in better protection of personal account information. It should also be appreciated that some embodiments of the invention create a viral registration and/or account opening system that allows for customers of a financial institution to send payments to anyone outside the financial entity using an alias. In such embodiments, the non-customers are contacted using the alias and they are allowed to quickly open and/or register an account with the financial institution in order to receive the funds from the sender.

As described above, FIGS. 1 and 2 provide an overview of the alias-type P2P payment system and process of embodiments of the invention. FIGS. 3-12C, described below, provide a more detailed description of some systems and methods of implementing embodiments the invention in an online banking environment. Specifically, embodiments of the invention described below disclose a user-friendly online banking interface and associated method that may be used by a financial institution to: (1) allow customers to send P2P payments using an alias of the intended recipient; (2) allow customers to register a customer's aliases and then receive alias-type P2P payments from others; and (3) allow customers to easily manage their P2P payments.

### Online Banking P2P Payment System and Environment

FIG. 3 provides a block diagram illustrating an online banking P2P payment system and environment 300, in accordance with an embodiment of the invention. As illustrated in FIG. 3, the P2P payment environment 100 includes a first user 310 and a second user 320 where one user wants to send funds to the other user. A user of the system may be a person, but may also be a business (e.g., a merchant) or any other entity capable of sending or receiving money.

The environment 300 also includes a personal computing device 400 and 500 for the first user 310 and second user 320, respectively. Each personal computing device may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, or other mobile device.

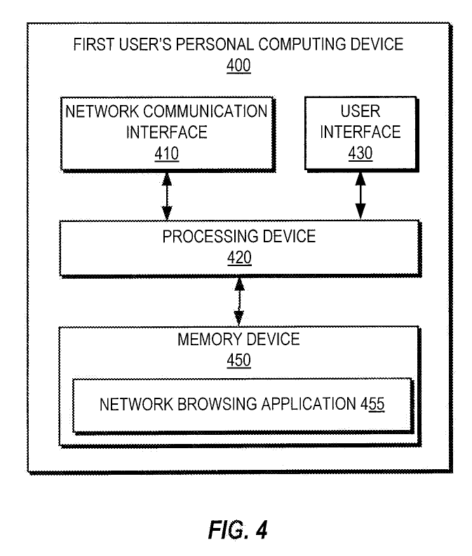

The personal computing devices 400 and 500 are configured to communicate over a network 350 with a financial institution's online banking system 600 and, in some cases, one or more other financial institution banking systems. The first user's personal computing device 400, the second user's personal computing device 500, the financial institution's online banking system 600, an alias data repository 700, and any other participating financial institution's banking systems 370 are each described in greater detail below with reference to FIGS. 4-7. The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet.

In general, a personal computing device 400 is configured to connect with the network 350 to log the first user 310 into an online banking system 600. The online banking system 600 involves authentication of a first user in order to access the first user's account on the online banking system 600. For example, the online banking system 600 is a system where a first user 310 logs into his/her account such that the first user 310 or other entity can access data that is associated with the first user 310. For example, in one embodiment of the invention, the online system 600 is an online banking system maintained by a financial institution. In such an embodiment, the first user 310 can use the personal computing device 400 to log into the online banking system to access the first user online banking account. Logging into the online banking system 600 generally requires that the first user 310 authenticate his/her identity using a user name, a passcode, a cookie, a biometric identifier, a private key, a token, and/or another authentication mechanism that is provided by the first user 310 to the online banking system 600 via the personal computing device 400.

The financial institution's online banking system 600 is in network communication with other devices, such as other financial institutions' banking systems 370, an alias data repository 700, and a second personal computing device 500 that is configured to communicate with the network 350 to log a second user 320 into the online banking system 600.

In some embodiments of the invention, the alias data repository 700 is configured to be controlled and managed by one or more third-party data providers (not shown in FIG. 3) over the network 350. In other embodiments, the alias data repository 700 is configured to be controlled and managed over the network 350 by the same entity that maintains the financial institution's online banking system 300. In other embodiments, the alias data repository 700 is configured to be controlled and managed over the network 350 by the financial institution implementing the online payment system of the invention. In still other embodiments, the alias data repository 700 is a part of the online banking system 600.

Referring now to FIG. 4, the personal computing device 400 associated with the first user 310 includes various features, such as a network communication interface 410, a processing device 420, a user interface 430, and a memory device 450. The network communication interface 410 includes a device that allows the personal computing device 400 to communicate over the network 350 (shown in FIG. 3). In addition, a network browsing application 455 is stored in the memory device 450. The network browsing application 455 provides for the first user to establish network communication with the online banking system 600 (shown in FIG. 4) for the purpose of initiating online payment, in accordance with embodiments of the invention.

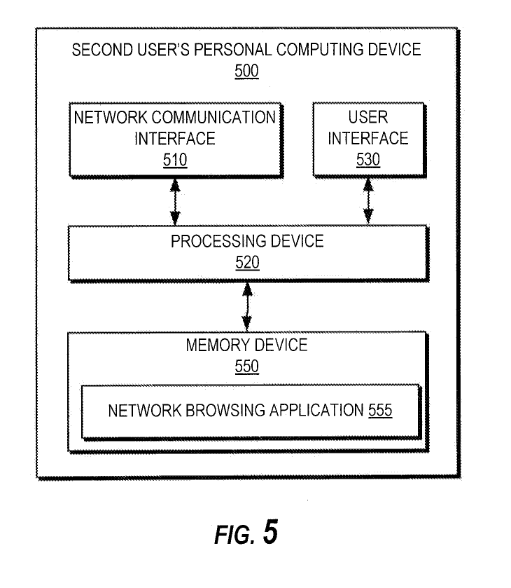

Referring now to FIG. 5, the personal computing device 500 associated with the second user 320 also includes various features, such as a network communication interface 510, a processing device 520, a user interface 530, and a memory device 550. The network communication interface 510 includes a device that allows the personal computing device 500 to communicate over the network 350 (shown in FIG. 3). In addition, a network browsing application 555 is stored in the memory device 550. The network browsing application 455 provides for the second user to establish network communication for the purpose of registering and account and/or alias with the online payment system and/or receiving online payment, in accordance with embodiments of the invention.

As used herein, a “processing device,” such as the processing device 420 or the processing device 520, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 420 or 520 may further include functionality to operate one or more software programs based on computer-executable program code thereof, which may be stored in a memory. As the phrase is used herein, a processing device 420 or 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 430 or 530 generally includes a plurality of interface devices that allow a customer to input commands and data to direct the processing device to execute instructions. As such, the user interface 430 or 530 employs certain input and output devices to input data received from the first user 310 or second user 320 or output data to the first user 310 or second user 320. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 450 or 550 generally refers to a device or combination of devices that store one or more forms of computer-readable media and/or computer-executable program code/instructions. Computer-readable media is defined in greater detail below. For example, in one embodiment, the memory device 450 or 550 includes any computer memory that provides an actual or virtual space to temporarily or permanently store data and/or commands provided to the processing device 420 or 520 when it carries out its functions described herein.

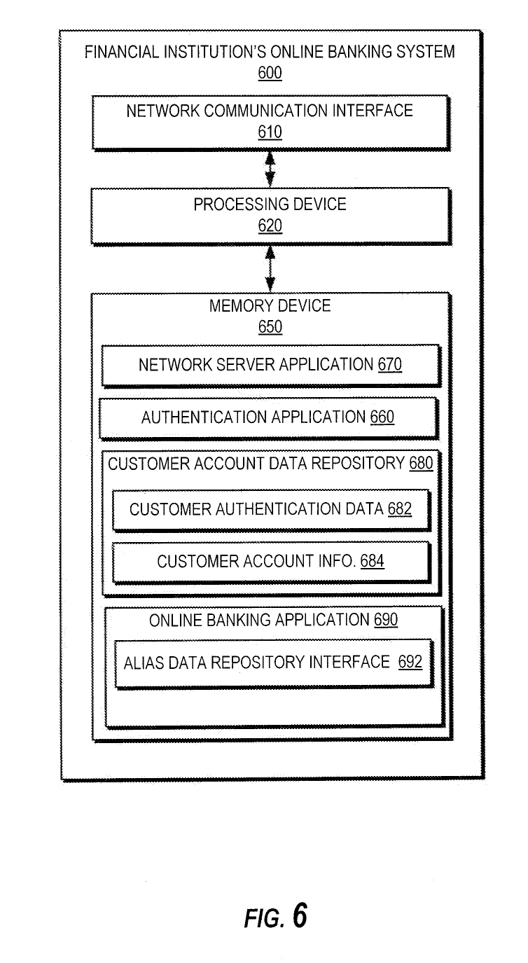

FIG. 6 provides a block diagram illustrating the online banking system 600 in greater detail, in accordance with embodiments of the invention. As illustrated in FIG. 6, in one embodiment of the invention, the online banking system 600 includes a processing device 620 operatively coupled to a network communication interface 610 and a memory device 650. In certain embodiments, the online banking system 600 is operated by a first entity, such as a financial institution, while in other embodiments, the online banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the online banking system 600 described herein. For example, in one embodiment of the online banking system 600, the memory device 650 includes, but is not limited to, a network server application 670, an authentication application 660, a customer account data repository 680, which includes customer authentication data 680 and customer account information 684, and an online banking application 690, which includes an alias data repository interface 692 and other computer-executable instructions or other data. The computer-executable program code of the network server application 670, the authentication application 660, or the online banking application 690 may instruct the processing device 620 to perform certain logic, data-processing, and data-storing functions of the online system 600 described herein, as well as communication functions of the online banking system 600.

In one embodiment, the customer account data repository 680 includes customer authentication data 682 and customer account information 684. The network server application 670, the authentication application 660, and the online banking application 690 are configured to implement customer account information 684, the customer authentication data 682, and the alias data repository interface 692 when authenticating the customer 101 to the online banking system 600. The customer account information 684, the customer authentication data 682, and the alias data repository interface 692 are discussed in more detail in a later section.

As used herein, a “communication interface” generally includes a modem, server, transceiver, and/or other device for communicating with other devices on a network, and/or a user interface for communicating with one or more customers. Referring again to FIG. 6, the network communication interface 610 is a communication interface having one or more communication devices configured to communicate with one or more other devices on the network 350, such as the personal computing device 400 or 500, the online banking system 600, the other financial institution banking systems 370, and the alias data repository 700. The processing device 620 is configured to use the network communication interface 610 to transmit and/or receive data and/or commands to and/or from the other devices connected to the network 350.

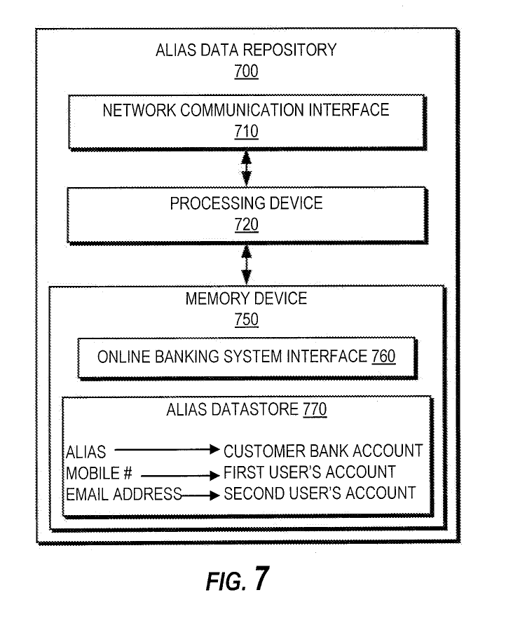

FIG. 7 provides a block diagram illustrating an alias data repository 700, in accordance with an embodiment of the invention. In one embodiment of the invention, the alias data repository 700 is operated by a second entity that is a different or separate entity from the first entity (e.g., the financial institution) that, in one embodiment of the invention, implements the online banking system 600. In one embodiment, the alias data repository 700 could be part of the online banking system 600. In another embodiment, the alias data repository 700 is a distinct entity from the online banking system 600. As illustrated in FIG. 7, the alias data repository 700 generally includes, but is not limited to, a network communication interface 710, a processing device 720, and a memory device 750. The processing device 720 is operatively coupled to the network communication interface 710 and the memory device 750. In one embodiment of the alias data repository 700, the memory device 750 stores, but is not limited to, an online banking system interface 760 and an alias data store 770. The alias data store 770 stores data including, but not limited to, an alias for the customer's financial institution account, mobile number or email address for the first user's 310 account, and a mobile number and/or email address for the second user's 320 account. In one embodiment of the invention, both the online banking system interface 760 and the alias data store 770 may associate with applications having computer-executable program code that instructs the processing device 720 to operate the network communication interface 710 to perform certain communication functions involving the alias data store 770 described herein. In one embodiment, the computer-executable program code of an application associated with the alias data store 770 may also instruct the processing device 720 to perform certain logic, data processing, and data storing functions of the application associated with the alias data store 770 described herein. An alias, as defined in this invention, is not limited to just a mobile device number or an email address.

The network communication interface 710 is a communication interface having one or more communication devices configured to communicate with one or more other devices on the network 350. The processing device 720 is configured to use the network communication interface 710 to receive information from and/or provide information and commands to a personal computing device 400 or 500, other financial institution banking systems 370, the alias data repository 700, the online banking system 600 and/or other devices via the network 350. In some embodiments, the processing device 720 also uses the network communication interface 710 to access other devices on the network 350, such as one or more web servers of one or more third-party data providers. In some embodiments, one or more of the devices described herein may be operated by a second entity so that the third-party controls the various functions involving the alias data repository 700. For example, in one embodiment of the invention, although the online system 600 is operated by a first entity (e.g., a financial institution), a second entity operates the alias data repository 700 that stores the alias details for the customer's financial institution accounts and other information about customers.

As described above, the processing device 720 is configured to use the network communication interface 710 to gather data from the various data sources. The processing device 720 stores the data that it receives in the memory device 750. In this regard, in one embodiment of the invention, the memory device 750 includes datastores that include, for example: (1) aliases for customer financial institution account numbers and routing information, (2) information about sending and receiving users' mobile device numbers, email addresses, or other contact information, which may have been received from the online banking system 600; (3) a list of customer IDs or authentication data received from the online banking system 600; and/or (4) customer credentials (e.g., a customer ID) received from the customer's personal computing device 400 or received from the online system 300 in response to the customer accessing the online banking system 600.

### Online Banking P2P Payment Send Process and Interface

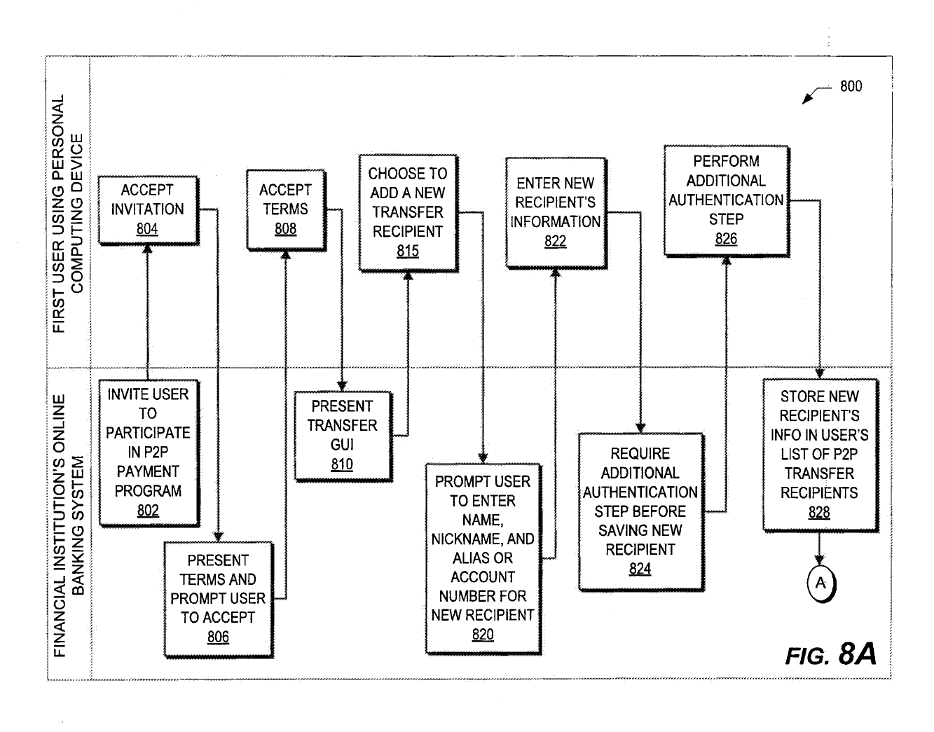

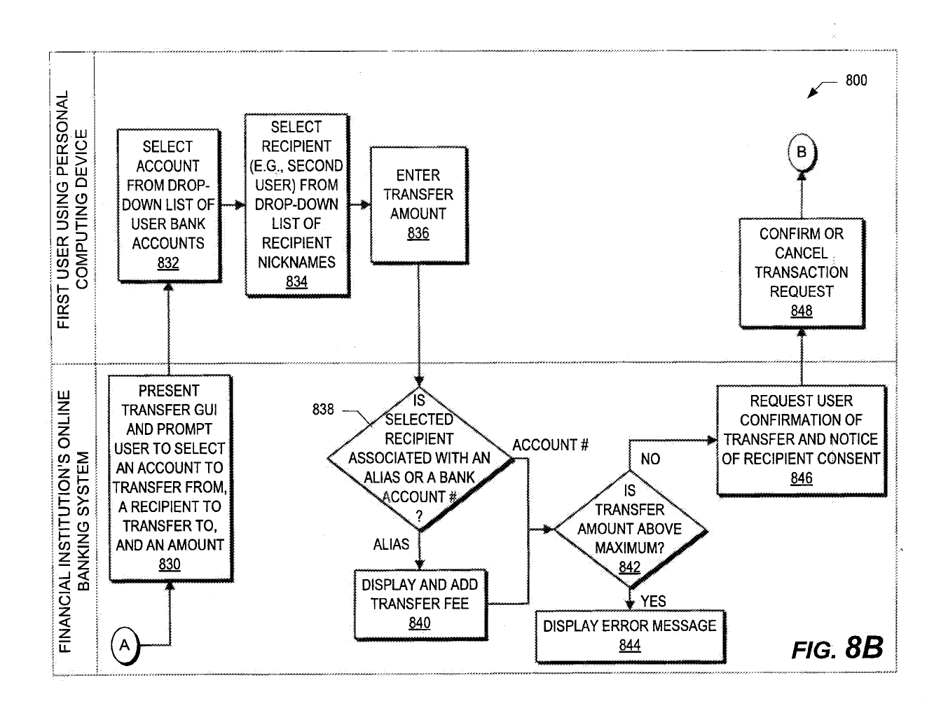

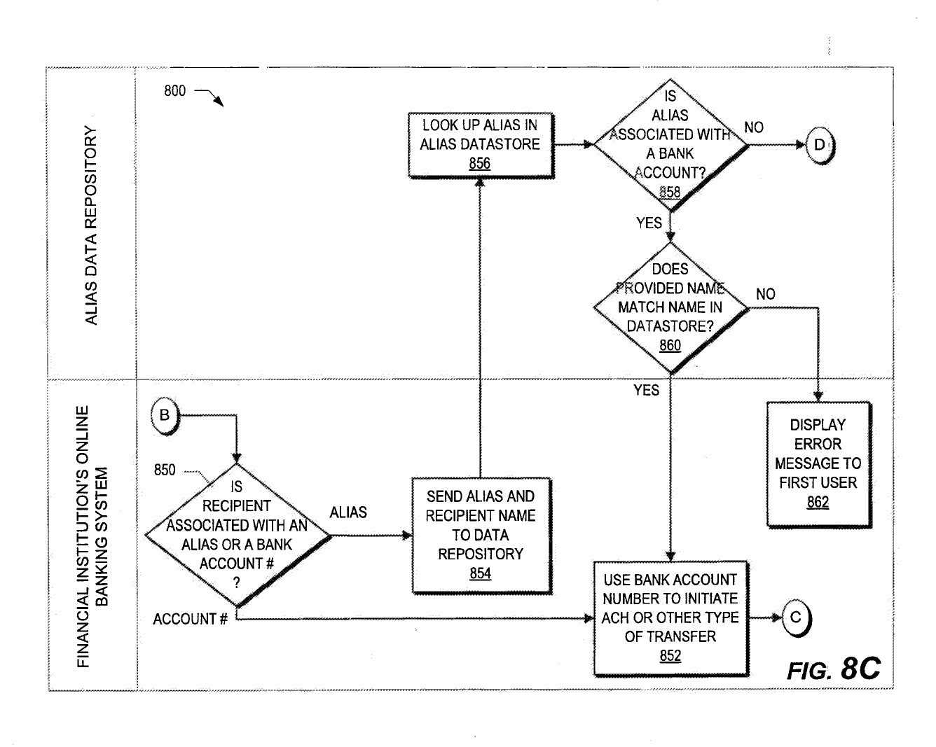

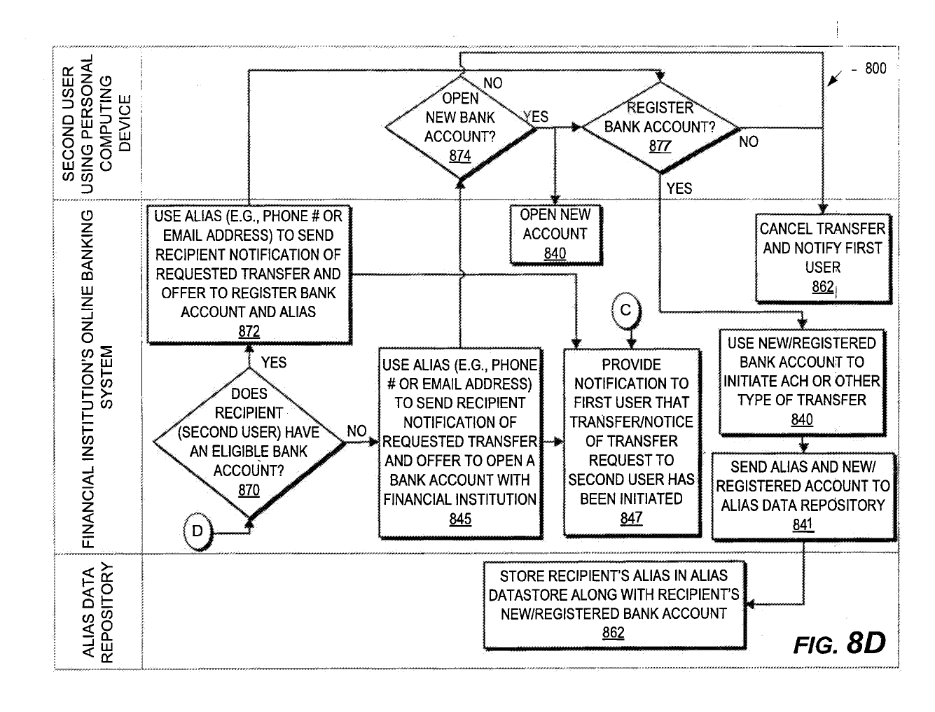

FIGS. 8A-8D provide flow charts illustrating a process 800 for sending P2P payments using an alias, in accordance with an embodiment of the invention. FIGS. 8A-8D illustrate the flow chart in terms of “swim lanes” associated with entities which may perform the operations in each respective swim lane. The entities illustrated in the exemplary Figures are a financial institution's online banking system, a first user using a first personal computing device, an alias data repository, and a second user using a second personal computing device. However, it should be noted that other entities could also be involved and some embodiments of the invention may not be limited to the four entities illustrated in FIGS. 8A-8D. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

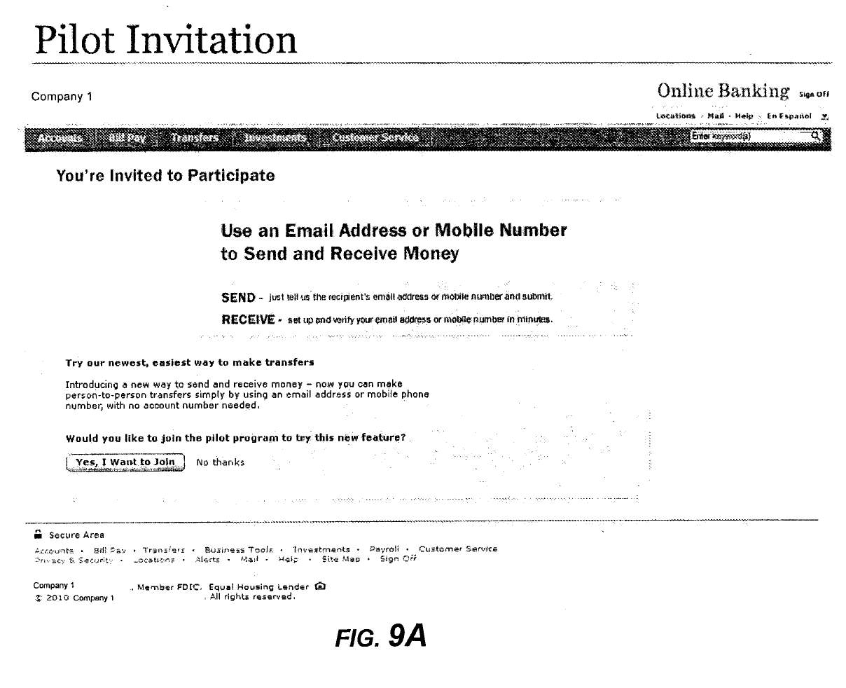

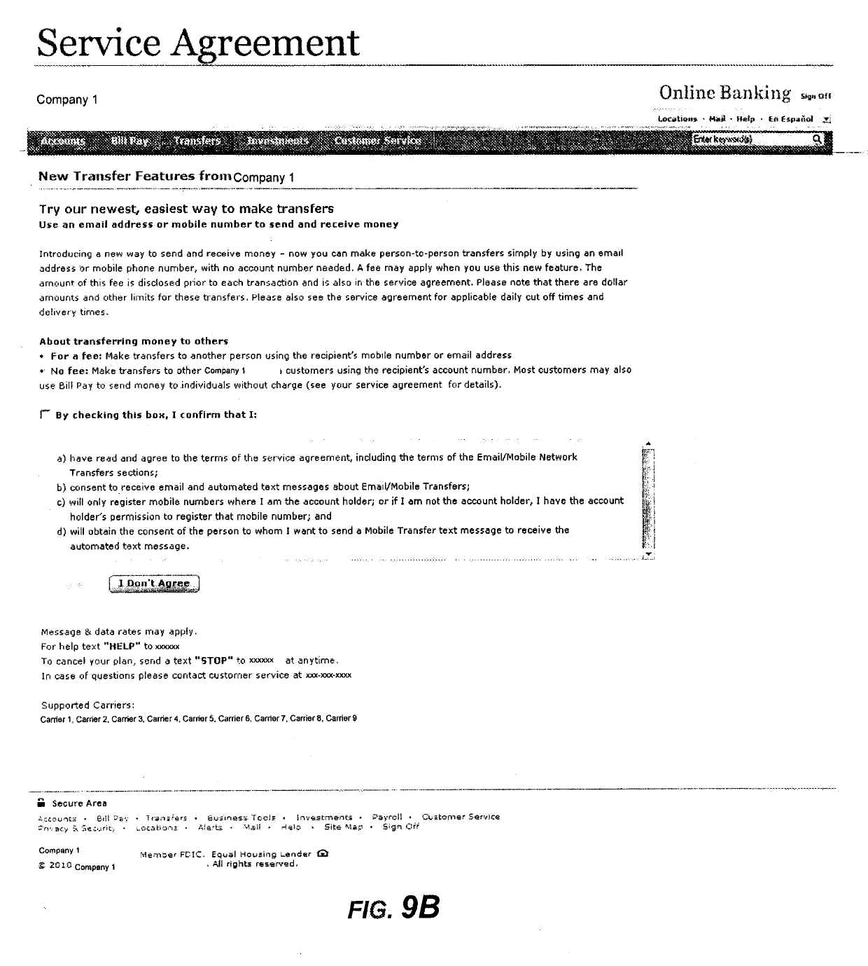

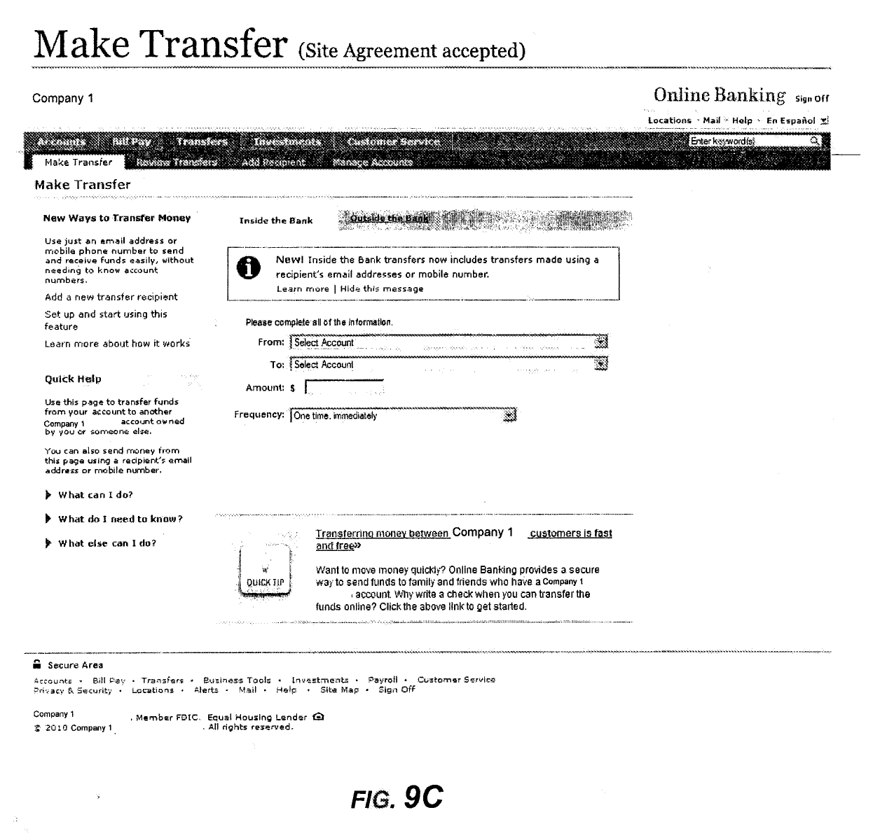

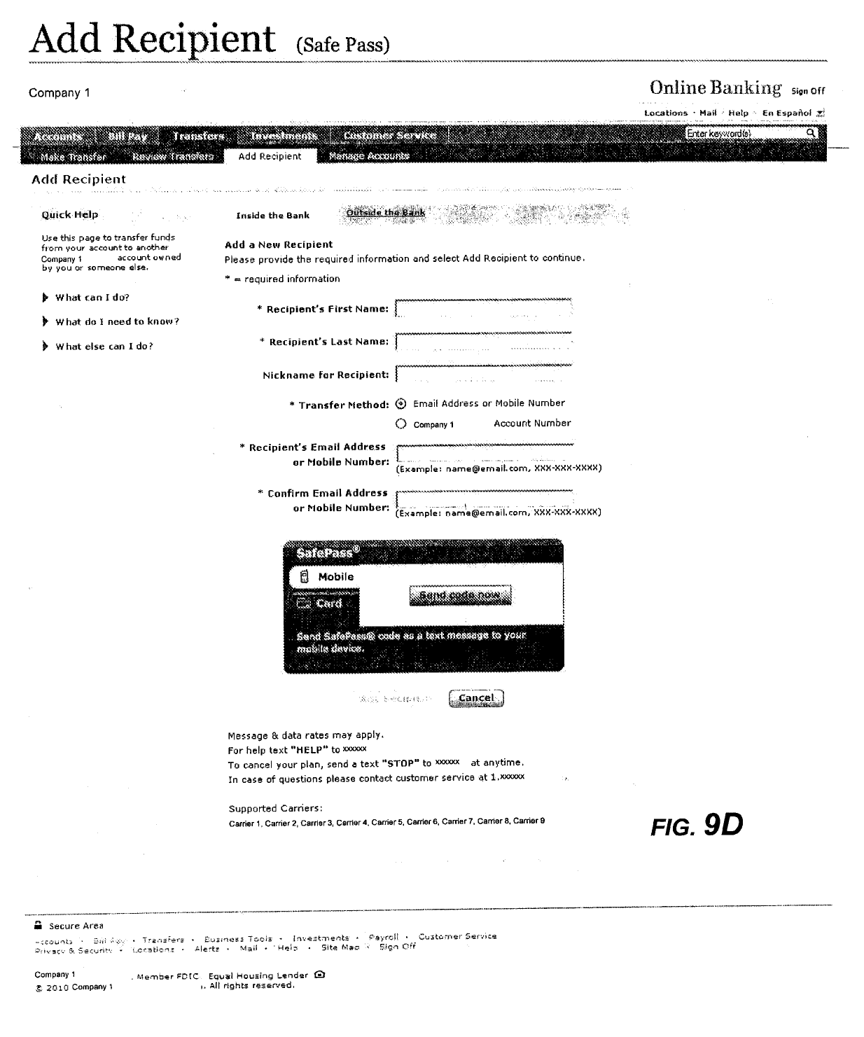

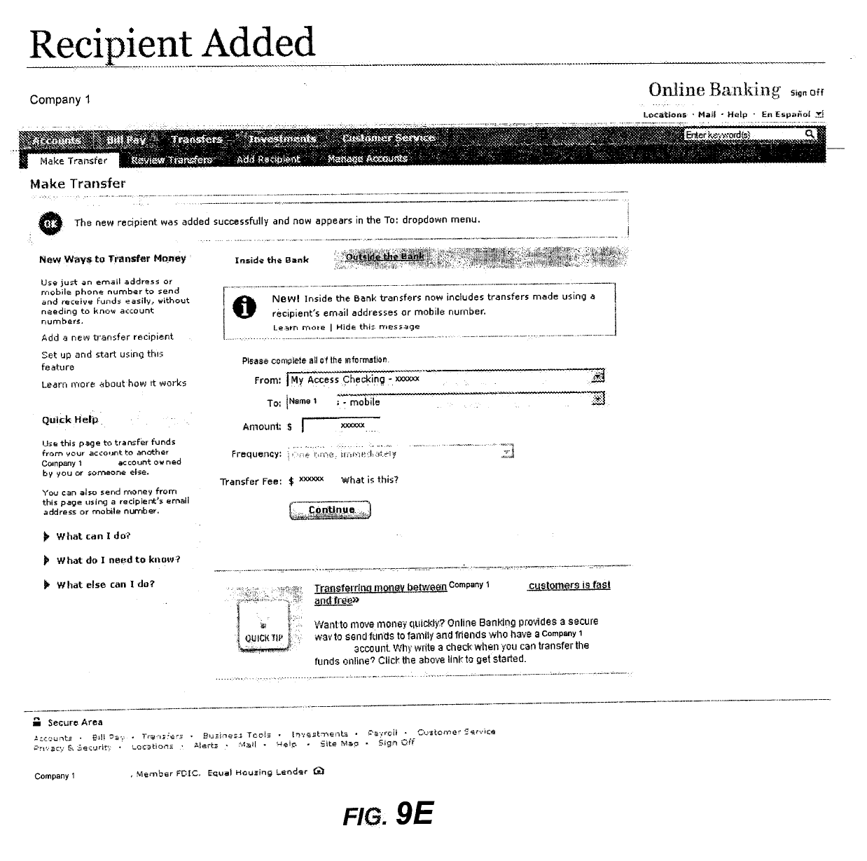

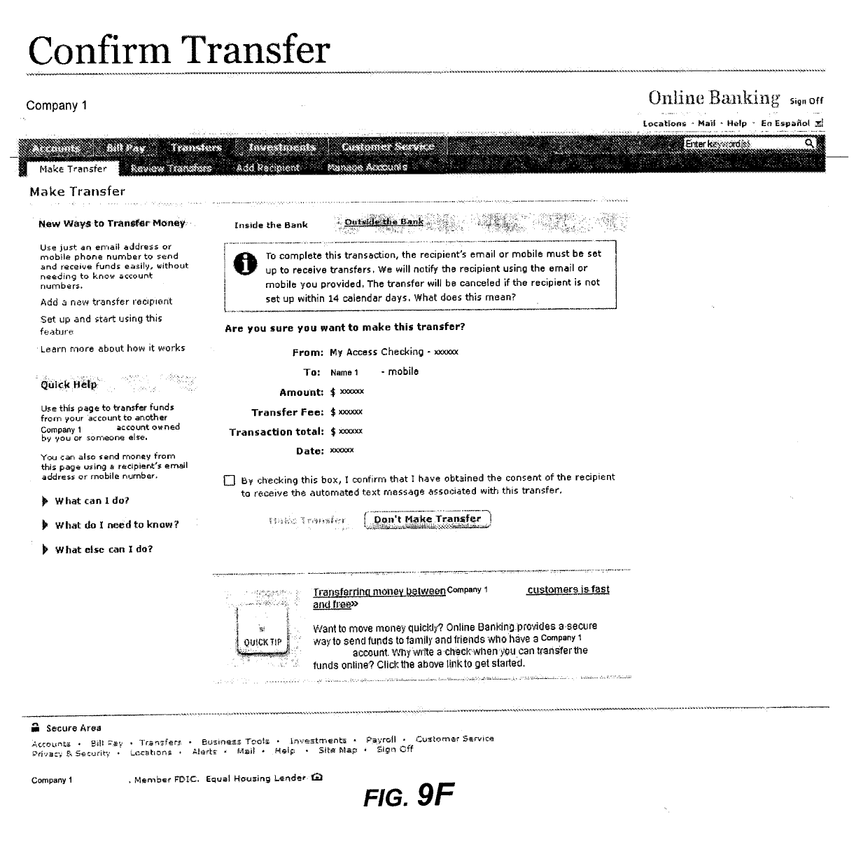

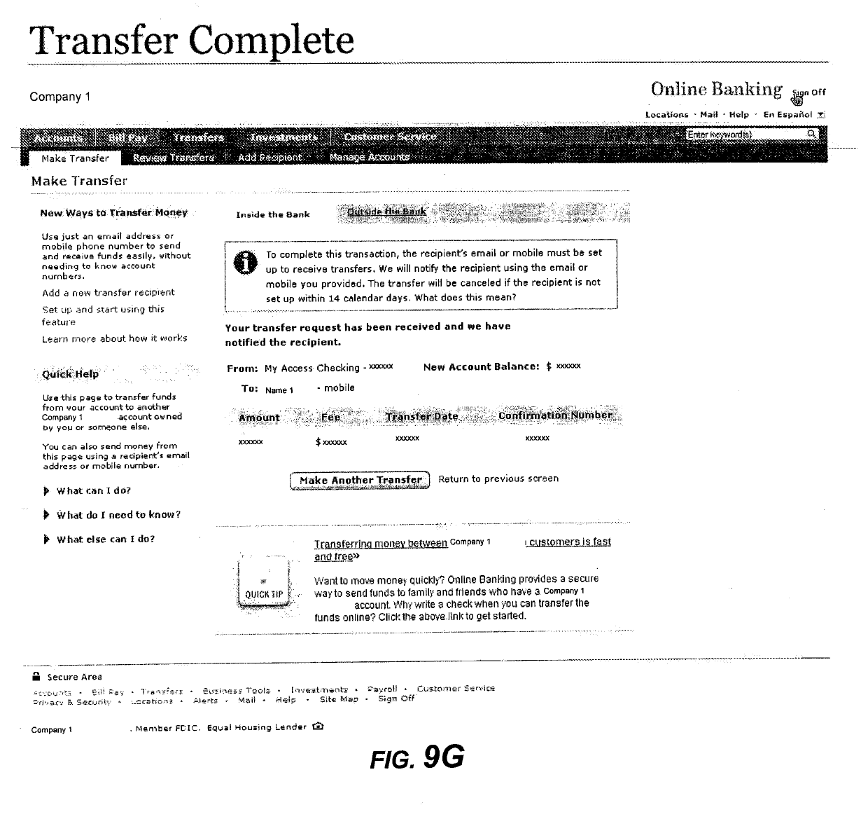

The process begins at block 802 of FIG. 8A where a financial institution's online banking system 600 invites a user to participate in a P2P payment program. FIG. 9A provides a screenshot of a graphical user interface used during the process of inviting a user to participate in a P2P payment program. In the illustrated embodiment, the screenshot is located under the “Transfers” tab on a first user's online banking homepage. Although in other embodiments the information depicted in the screenshot of FIG. 9A may be presented elsewhere within the online banking system. In certain embodiments, the page illustrated in the screenshot is available after the first user has logged into the first user's online banking account. In another embodiment, the page illustrated in the screenshot may be available before the first user has logged into the first user's online banking account. The other tabs on the first user's online banking homepage are a tab related to accounts, a tab related to paying bills, a tab related to investments and a tab related to customer service. In one embodiment shown in FIG. 9A, the online banking system 600 indicates to the first user that he or she is invited to participate in the P2P transfer service via an alias. The information provided in the screenshot of FIG. 9A is configured to inform the first user that he or she can send money to a recipient's email address or mobile number or, in other embodiments, some other alias and can receive money using just an email address or mobile number or, in other embodiments, another alias as identifying information. The online banking system 600 informs the first user in FIG. 9A that the first user can send money to a second user by submitting to the online banking system 600 the second user's email address or mobile number. As shown in FIG. 9A, the online banking system 600 informs the first user that the first user can receive money from a second user by setting up the first user's P2P account on the online banking system 600 and verifying the first user's email address or mobile number. As shown in FIG. 9A, the online banking system 600 also informs the user that the P2P service is the newest and easiest way to make transfers, and that money can be transferred without providing a recipient's account number. As shown in FIG. 9A, the online banking system 600 finally asks the first user whether he or she would like to try this P2P feature. As shown in FIG. 9A, the online banking system 600 provides two buttons for the first user to communicate his or her decision to the online banking system 600. A first user can activate the “Yes, I want to Join” button if the first user wishes to initiate the process of using the P2P service. Alternatively, the first user can activate the “No thanks” button if the first user wishes to decline the invitation extended by the online banking system 600. In certain embodiments of the invention, the online banking system 600 only invites certain existing online banking customers who fit certain criteria, including, but not limited to, pre-determined minimum account balance, number of years since the customer first opened an account, customer status, etc. Thus, in such embodiments, the information provided in the screenshot of FIG. 9A may only be accessible to those qualified customers as determined by the financial institution.

Returning to FIG. 8A, the process then moves to block 804 where the first user 310 using personal computing device 400 accepts the invitation that is shown on FIG. 9A by activating the button that reads “Yes, I Want to Join.”

The process then moves to block 806 of FIG. 8A where the online banking system 600 presents to the first user the terms of the P2P transfer feature that will govern the transfer of funds. A screenshot for this process is shown in FIG. 9B. FIG. 9B shows that the online banking system 600 informs the user of the merits of using the P2P transfer service. As shown in FIG. 9B, these merits include, but are not limited to, making person-to-person transfers of money by using an email address or phone number, without the need of providing an account number. Additionally, the information provided in the screenshot depicted in FIG. 9B informs the first user that a fee is associated with transferring funds to another person using the recipient's mobile number or email address or other alias. The online banking system 600 also informs the first user that the amount of any fee is disclosed prior to making the P2P transfer via alias. The online banking system 600 also informs the first user that he or she can read more details about this fee in the service agreement that is linked into the page displayed as a screenshot in FIG. 9B. The online banking system 600 also informs the first user that there may be dollar amounts and other limits that apply for these P2P transfers via alias. As shown in FIG. 9B, the online banking system 600 further informs the first user that the first user may find in the service agreement applicable daily cut off times and delivery times for making these P2P transfers via alias. The information provided in the screenshot of FIG. 9B also informs the first user that no fee is associated with transferring funds to another person if the first user provides the recipient's account number. In the illustrated embodiment the recipient's account number must be an account associated with the financial institution implementing the online banking system, however, in other embodiments the recipient's account number may be an account number associated with another financial institution. FIG. 9B also illustrates a confirmation check box which the first user may activate if the first user confirms that he or she a) has read and agrees to the terms of the service agreement, including the terms of the Email/Mobile Network Transfer section; b) consents to receive email and automated text messages about Email/Mobile Transfers; c) will only register mobile numbers where he or she is the account holder; or if he or she is not the account holder, then he or she has the account holder's permission to register that mobile number; and d) will obtain the consent of the person to whom he or she wants to send a Mobile Transfer text message to receive the automated text message. As shown in FIG. 9B, the online banking system 600 is configured to provide the service agreement label as a hyperlink or some other activatable form, which may be activated so that the user can read the service agreement that governs the P2P transfer via alias. As shown in FIG. 9B, the online banking system 600 provides a checkbox that the first user has to click to confirm he or she has met each of the four requirements listed above. Until the first user activates this checkbox to confirm that he or she meets the four requirements listed above, the online banking system 600 provides a non-activatable “I Agree” button and an activatable “I Don't Agree” button. If the first user activates the “I Don't Agree” button, the online banking system 600 will not permit the first user to continue with setting up the P2P transfer via alias. Once the first user activates the confirmation check box, the online banking system 600 will turn the non-activatable “I Agree” button into a activatable “I Agree” button. Then, the user still has a choice of either activating the “I Agree” button or activating the “I Don't Agree” button. If the user activates the “I Don't Agree” button, the online banking system 600 will not permit the first user to continue with setting up the P2P payment transfer via alias. FIG. 9B also shows that the first user can get help about learning about the P2P transfer process or the service agreement by texting a code to a number listed on the page. FIG. 9B also shows that the first user can cancel the first user's plan by texting a code to a number listed on the page. FIG. 9B also shows that the first user can call a number listed on the webpage to get more help.

Returning to FIG. 8A, the process then moves to block 808 of FIG. 8A. The first user accepts the terms of the P2P service by activating the checkbox that confirms that the first user meets all the four requirement described in the previous paragraph, and then activating the “I Agree” button to indicate the first user's willingness to proceed with setting up the P2P transfer via alias.

The process then moves to block 810 of FIG. 8A where the online banking system 600 presents a transfer GUI so that the first user can input all the information required to make the transfer. FIG. 9C shows this transfer GUI where the online banking system 600 presents four sub-tabs under the tab heading. These four sub-tabs are a sub-tab for a making a transfer, a sub-tab for reviewing transfers, a sub-tab for adding recipients, and a sub-tab for managing accounts. FIG. 9C also shows that under the sub-tab for making transfers, the first user has the option of making a transfer within the financial institution by activating a corresponding tab and the first user also has the option of making a transfer outside the financial institution by activating the corresponding tab. As shown in FIG. 9C, the online banking system 600 also presents activatable hyperlinks for adding a new transfer recipient, setting up and starting the use of the P2P feature via alias, and for learning more about the P2P feature via alias. As shown in FIG. 9C, the online banking system 600 also presents a help box that is configured to provide hyperlinks to help information, including a link to (1) what the first user can do using the online banking system 600, (2) what the first user needs to know, and (3) what else the first user can do using the online banking system 600. As shown in FIG. 9C, the online banking system 600 also presents a message to the first user that transferring money within the bank is fast and free. As shown in FIG. 9C, the online banking system 600 also indicates to the customer that the feature of making a P2P transfer using a recipient's email address or mobile number is a new feature.

Referring again to FIG. 8A, the process then moves to block 815 of FIG. 8A. The first user chooses to add a new transfer recipient to their P2P profile. Adding a new transfer recipient may be accomplished by activating the “add recipient” sub-tab shown on the screenshot of FIG. 9C. By doing so, the first user indicates that the first user wishes to add a new transfer recipient. By doing so, the first user also indicates that the intended recipient is not listed on the drop-down list shown in FIG. 9C which is presented when the first user activates the drop-down list, entitled “To”, that includes all the available recipients/destinations to whom the first user can transfer money.

Returning once again to FIG. 8A, the process then moves to block 820 where the user is prompted to enter new recipient information including, but not necessarily limited to, the name of the recipient, the nickname of the recipient and the alias or account number for the new recipient. FIG. 9D provides for the corresponding screenshot in the online banking system 600 for adding a new recipient. The screenshot of FIG. 9D may be displayed by activating the “Add Recipient” sub-tab. As shown in FIG. 9D, the online banking system 600 prompts the first user to enter the intended recipient's first name and last name in corresponding textboxes. In one embodiment, the page displays an indicator, such as an asterisk or the like, that indicates that information fields are required to be completed by the user, as opposed to optional fields which are not designated with the indicator. Additionally, the screenshot of FIG. 9D is configured to prompt the first user to optionally enter the intended recipient's nickname in a textbox. The online banking system 600 is configured to display first and second transfer method radio buttons for choosing between alternate transfer methods. First radio button is configured to allow for the first user to indicate that he or she wants to transfer money using the intended recipient's email address or mobile number or, in alternate embodiments, some other alias, and second radio button is configured to allow the first user to indicate that he or she wants to transfer money using an intended recipient's financial institution account number. Activating the first radio button, as shown, provides for display of entry fields for the new recipient's email address or mobile telephone number. The screenshot/page of FIG. 9D also provides an entry field for re-entering the intended recipient's email address or mobile device number as a confirmation step. Activating the second radio button, as not shown in FIG. 9D, provides for display of entry fields for the new recipients account number. In one embodiment, the online banking system 600 also presents a help box that is configured to provide hyperlinks to help information, including a link to (1) what the first user can do using the online banking system 600, (2) what the first user needs to know, and (3) what else the first user can do using the online banking system 600. In one embodiment, the online banking system 600 also presents two buttons, an first button to cancel the process of adding a new recipient, and a second button to add a new recipient. The second button is only activatable after the first user enters all the required information on the page displayed in FIG. 9D and is authenticated by the widget displayed in FIG. 9D and discussed infra.

Returning once again to the flow of FIG. 8A, the process then moves to block 822 at which point the first user enters the new recipient's information in the appropriate fields. As shown in FIG. 9D, the first user enters the first and last name of the new recipient in the associated fields. Additionally, in optional embodiments, the first user may enters the nickname of the new recipient in the designated field. This nickname can be any name that the first user chooses to associate with the intended recipient for the purpose of subsequently identifying the recipient based on the nickname. In addition, the first user chooses the desired transfer method from among the options presented by the online banking system 600. In one embodiment, the first user activates the radio button indicating the first user wishes to make the transfer using the intended recipient's email address or mobile device number. In such embodiments, the first user enters the intended recipient's email address or mobile device number in the designated fields and re-enters the same in the designated confirmation field. In another embodiment, the first user activates the radio button indicating the first user wishes to make the transfer using the intended recipient's account number. In such embodiments, the first user enters the intended recipient's account number in the designated field and re-enters the same in the designated confirmation field.

Referring again to FIG. 8A, the process then moves to block 824 in which additional authentication may be required prior to adding the new recipient to the database. As illustrated in the screenshot of FIG. 9D, the online banking system 600 may display a widget, such as a widget entitled SafePass®, a registered trademark of Bank of America Corporation, which serves as an additional authenticating step before adding the information of the new intended recipient to the database. The online banking system 600 indicates to the first user that by activating the button for a sending a code, the first user will receive a code on his or her mobile device.

Returning again to FIG. 8A, the process then moves to block 826 of FIG. 8A, in which the additional authentication step is completed. As indicated on the screenshot shown in FIG. 9D, the first user activates the widget's button for sending a code to the first user's mobile device. The first user then receives on his mobile device the code that he must input into an entry field in the widget, which is displayed based on activating the “Send code now” button. Once the first user inputs the received code into the widget and activates a button in the widget to confirm that the code is correct, the button that corresponds to adding a new recipient is activatable so that it can now be activated by the user. The user activates this button so that the online banking system 600 can store the intended recipient's information.

Returning to FIG. 8A, the process then moves to block 828 and the new intended recipient's information is stored in the first user's list of P2P transfer via alias recipients.

Turning the reader's attention to FIG. 8B, the process then moves to block 830 where the online banking system 600 presents a transfer GUI so that the first user can input all the information required to make the transfer. FIG. 9E shows that the online banking system 600 indicates to the first user that the new intended recipient has been successfully added based on the first user's previously entered information about the intended recipient. In addition, FIG. 9E shows the transfer GUI in which the online banking system 600 presents four sub-tabs under the “Transfers” tab described earlier. These four sub-tabs include a first sub-tab for a making a transfer, a second sub-tab for reviewing transfers, a third sub-tab for adding recipients, and a fourth sub-tab for managing accounts. FIG. 9E also show that under the first sub-tab for making transfers, the first user has the option of making an internal transfer (i.e., within the bank) by activating a corresponding tab and the first user also has the option of making an external transfer (i.e., outside the bank) by activating the corresponding tab. Under the sub-tab for making internal transfers, the online banking system 600 presents a drop-down list that lists all the accounts from which the first user can transfer money. The online banking system 600 also presents a drop-down list that lists all the recipients (full name or nickname and either a corresponding alias type or financial institution account type) to whom the first user can transfer money. In one embodiment, only the nickname of the recipient and the associated alias type or financial institution account type are listed in the drop-down list. The online banking system 600 also presents a text box where the first user can input the amount of money that the first user intends to transfer to the intended recipient. In one embodiment, the online banking system 600 presents a drop-down list which lists several frequency options if the first user wants to periodically make the same transfer. In addition, the frequency drop-down list is configured to allow the first user to select a one-time transfer option with the transfer occurring immediately or at a preconfigured time in the future. The online banking system 600 also presents the fee that the first user will incur if the first user proceeds with the P2P transfer. As previously discussed, in specific embodiments, user fees may be associated with alias type transfers, (i.e., transfers to an email address, mobile telephone number, etc.) while no fee may be associated with a financial institution account transfer. The online banking system 600 also presents to the user activatable help text near the transfer fee if the user wants to understand how the transfer fee was computed. The online banking system 600 also presents a button to indicate to the online banking system 600 that the first user has entered all the required information and intends to continue with the P2P transfer.

Returning the reader to FIG. 8B, the process then moves to block 832, at which a transfer account is selected from the drop-down list of user bank accounts. As indicated in FIG. 9E, under the sub-tab for making internal transfers within the bank, the first user selects the appropriate account from drop-down list that lists all the accounts from which the first user can transfer money.

The process then moves to block 834 of FIG. 8B, at which a transfer recipient (i.e., second user) is selected from the drop-down list of recipient nicknames. As indicated in FIG. 9E, the first user also selects the appropriate recipient from a drop-down list that lists all the recipients to whom can transfer money. In one embodiment, the person selected by the first user is the newly added recipient whose information was added by the first user on FIG. 9D.

The process then moves to block 836 of FIG. 8B, at which the transfer amount is entered. As indicated in FIG. 9E, the first user inputs into the amount textbox the amount of money that the first user intends to transfer to the intended recipient. In one embodiment, the first user selects an appropriate frequency option from a drop-down list which lists several frequency options, such as, a one-time, immediate transfer, a one-time future transfer, a periodic transfer over a preconfigured cycle or the like.

The process then moves to block 838 of FIG. 8B. Here, the online banking system 600 determines whether the recipient selected by the first user in block 834 is associated with an alias or a financial institution account number. If the selected recipient is associated with an alias, then the process moves to block 840 where the online banking system 600 displays a pre-confirmation page where the transfer fee is added to the amount entered in block 836. This pre-confirmation page is displayed in FIG. 9F and is described in greater detail below. If the selected recipient is associated with a financial institution account and, thus, no fee is required or once the fee has been added to the alias-type transfer, the process moves to block 842.

In block 842, the online banking system 600 determines whether the total transfer amount exceeds the maximum permitted in the transaction. In one embodiment, the maximum amount that can be transferred using the P2P service is dependent on several factors including, but not limited to, the first user's identity, the recipient's identity, the length and nature of the first user's relationship with the financial institution, the length and nature of the recipient's relationship with the financial institution, the amount of funds that the first user has deposited at the financial institution, the first user's financial institution status, etc. In one embodiment, the maximum amount that can be transferred using the P2P transfer method is dynamically determined at the time the transfer is set-up by a supporting application that works in conjunction with or is embedded within the online banking system 600.

If the transfer amount is above the maximum permitted in this particular transaction, the process moves to block 844 of FIG. 8B and the online banking system 600 displays an error message to the first user.

If the transfer amount is below or equal to the maximum permitted in this particular transaction, the process moves to block 846 of FIG. 8B where the online banking system 600 requests the first user's confirmation of the transfer and notice of recipient consent as indicated on the screenshot provided in FIG. 9F. As shown in FIG. 9F, the online banking system 600 displays a text message asking whether the first user wants to make the transfer. As shown in FIG. 9F, the online banking system 600 also displays the account from which funds will be transferred if the first user chooses to proceed with the transfer, the recipient's nickname of the recipient and alias type or financial institution account type, the amount of money that will be transferred if the first user chooses to proceed with the transfer, the transfer fee that will be incurred by the first user if the first user chooses to proceed with the transfer, the total amount of the transaction if the first user chooses to proceed with the transfer, the account from which the first user executes the transfer if the first user chooses to proceed with the transfer, etc. In another embodiment of the invention, an entity or person other than the first user will incur the transfer fee. In one embodiment, only a few characters of the identifying information for the sending account are displayed. As shown in FIG. 9F, the online banking system 600 informs the first user that the selected recipient's email or mobile device must be set up to receive transfers via the P2P service described herein. As shown in FIG. 9F, the online banking system 600 also informs the first user that the online banking system 600 will notify the selected recipient using the email address or mobile number provided by the first user. As shown in FIG. 9F, the online banking system 600 also informs the first user that the transfer will be canceled if the selected recipient does not set up a P2P alias transfer account within a preconfigured number of days, for example fourteen days or the like. As shown in FIG. 9F, the online banking system 600 presents two decision buttons to the first user. The first decision button is activatable to confirm the first user's intention to make a transfer, and the second button is activatable to decline the transfer. As shown in FIG. 9F, the online banking system 600 also presents a checkbox to the first user where the first user, by checking or otherwise activating the box, confirms that the first user has obtained the consent of the selected recipient to receive text messages or other forms of communication associated with the transfer of funds from the first user to the selected recipient. Once the first user checks or otherwise activates this checkbox, the first button associated with confirming the first user's intention to make a transfer moves from a dormant state to an activatable state.

Returning to FIG. 8B, the process then moves to block 848 where the first user can activate the first button associated with confirming the first user's intention to make a transfer. Alternatively, the first user can activate the second button associated with canceling the transaction. Once the user activates the button confirming the transfer, as shown in FIG. 9G, the online banking system 600 displays a message to the first user that the transfer request has been received by the online banking system 600 and that the recipient has been notified. As shown in FIG. 9G, the confirmation page displays an identifier from the account from which money will be transferred along with the new account balance after the deducting the total amount for the transfer. As shown in FIG. 9G, the confirmation page also displays the nickname of the recipient to whom the money will be transferred and the associated alias type. The confirmation page also displays the amount transferred, the fee associated with the transaction, the transfer date, and a unique confirmation number. The online banking system 600 also provides a button on the page so that the first user can choose to make another transfer. The online banking system 600 also provides activatable text for the first user to return to the previous screen of the P2P transfer process. As shown in FIG. 9G, the online banking system 600 informs the first user that the selected recipient's email or mobile device must be set up to receive transfers via the P2P service. As shown in FIG. 9G, the online banking system 600 also informs the first user that the online banking system 600 will notify the selected recipient using the email address or mobile number provided by the first user. As shown in FIG. 9G, the online banking system 600 also informs the first user that the transfer will be canceled if the selected recipient does not set up a P2P transfer account within a pre-determined number of days.

Referring to FIG. 8C, the process then moves to block 850 where the online banking system 600 determines if the recipient is associated with an alias or a financial institution account number. If the recipient is associated with a financial institution account number, the process moves to block 852 where the online banking system 600 uses the financial institution account number to initiate an Automated Clearing House (ACH) transfer or other type of transfer. If the recipient is associated with an alias, then, the process moves to block 854 where the online banking system 600 sends the alias and the recipient's name to an alias data repository 700.

The process then moves to block 856 where the alias data repository 700 looks up the alias in an alias datastore. Then the process moves to block 858, where the alias data repository 700 determines whether the alias is associated with a financial institution account. If the alias is associated with a financial institution account, then the process moves to block 860 where, if the alias data repository 700 determines that the provided name matches the name in the datastore, then the process moves to block 852 of FIG. 8C where the online banking system 600 uses the financial institution account number to initiate an ACH transfer or other type of transfer. If in block 860 of FIG. 8C, the provided name does not match a name in datastore, then the online banking system 600 displays an error message to the first user that the transfer cannot be completed.

If in block 858 of FIG. 8C, the alias data repository 700 determines that the alias is not associated with a financial institution account, then the process moves to block 870 of FIG. 8D where the online banking system 600 determines if the recipient (second user) has an eligible financial institution account. If the recipient (second user) does not have an eligible financial institution account, then at block 845, the online banking system 600 uses an alias to send the recipient notification of requested transfer from the first user and an offer to open a financial institution account with the financial institution that manages the online banking system 600. In one embodiment, the alias is a phone number or an email address. Then the process moves to block 847 where the online banking system 600 provides notification to the first user that transfer or notice of transfer request to the second user has been initiated.

The process then moves on from block 845 to block 874 of FIG. 8D, where the second user decides if they desire to open a financial institution account at the financial institution associated with the online banking system 600. If the recipient does not desire to open an account, then at block 862, the online banking system 600 cancels the transfer and notifies the first user.

If in block 874 of FIG. 8D, the second user (recipient) decides to open a new financial institution account, the online banking system 600, in block 840, opens a new account for the second user. Subsequently, the second user (recipient) must determine in block 877 whether the second user registers the new financial institution account for the P2P service via alias.

As shown in FIG. 8D, if the second user in block 877 does not register the new financial institution account opened in block 874, then, at block 862, the online banking system 600 cancels the transfer and notifies the first user.

As shown in FIG. 8D, if the second user registers the new financial institution account in block 877 for P2P transfers via alias, then the online banking system 600, in block 840, uses the new registered financial institution account to initiate an ACH transfer or other type of transfer. The process then proceeds to block 841 where the online banking system 600 sends the alias and the new registered account information to the alias data repository 700. The process then proceeds to block 862 of FIG. 8D where the alias data repository stores recipient's alias in alias datastore along with recipient's new registered financial institution account.

If the recipient (second user) has an eligible financial institution account as determined by the online banking system 600 in block 870, then the process moves to block 872 in FIG. 8D where the online banking system 600 uses an alias (e.g., phone number or email address) to send recipient notification of requested transfer, and offers to register the recipient's financial institution account and alias. As shown in FIG. 8D, then the process moves to block 847 where the online banking system 600 provides notification to the first user that transfer or notice of transfer request to the second user has been initiated. As shown in FIG. 8D, the process then moves on to block 874 of FIG. 8D, where if the second user (recipient) decides not to register the second user's financial institution account for P2P transfers via alias, then the online banking system 600 cancels the transfer and notifies the first user.

As shown in FIG. 8D, if the second user registers the eligible financial institution account in block 877, then, at block 840, the online banking system 600 uses the new registered financial institution account to initiate ACH or other type of transfer. The process then proceeds to block 841 where the online banking system 600 sends alias and the new registered account information to the alias data repository. The process then proceeds to block 862 of FIG. 8D where the alias data repository stores recipient's alias in alias datastore along with recipient's new registered financial institution account.

### Online Banking Alias Registration and P2P Payment Receive Process and Interface

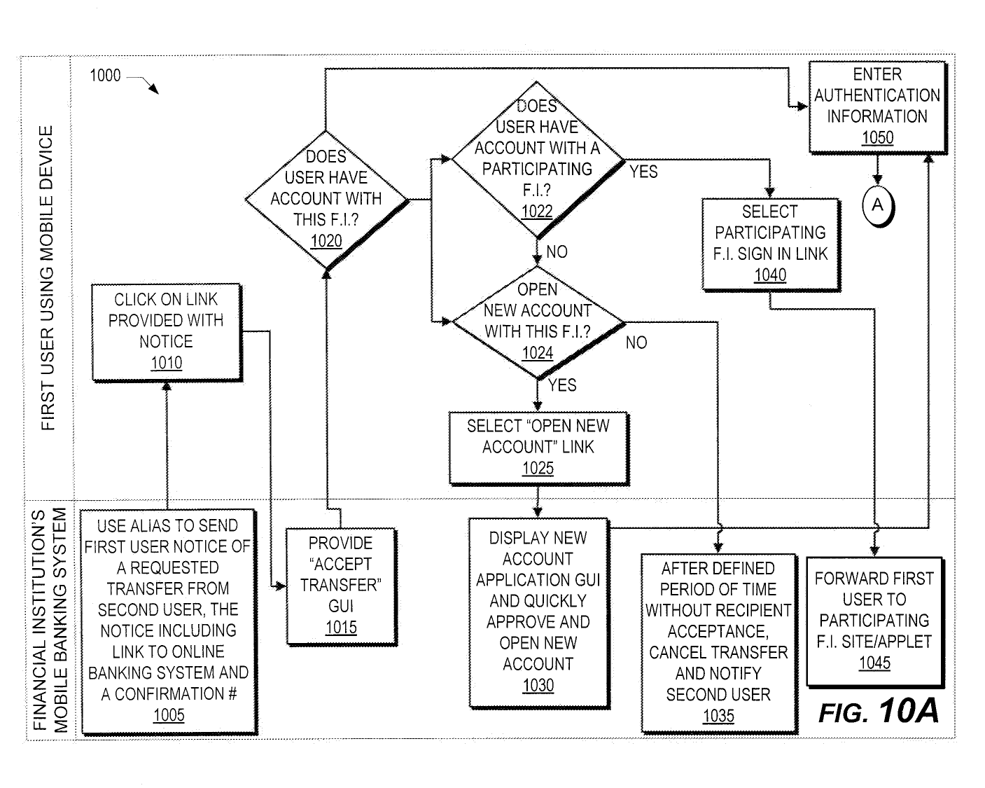

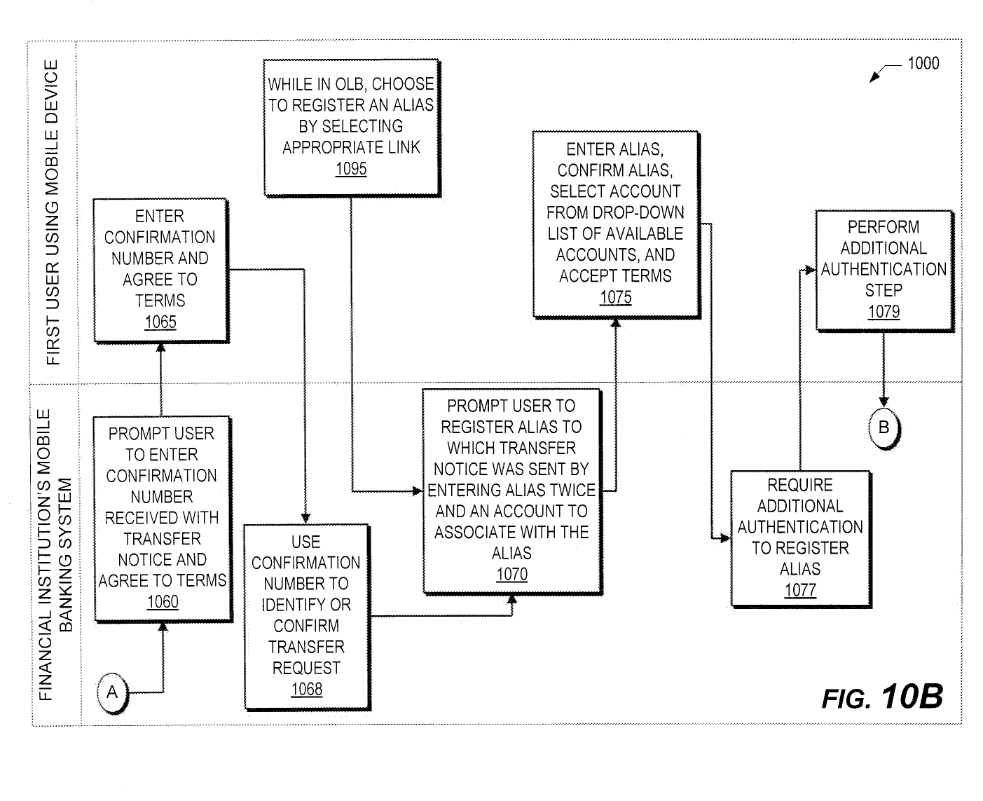

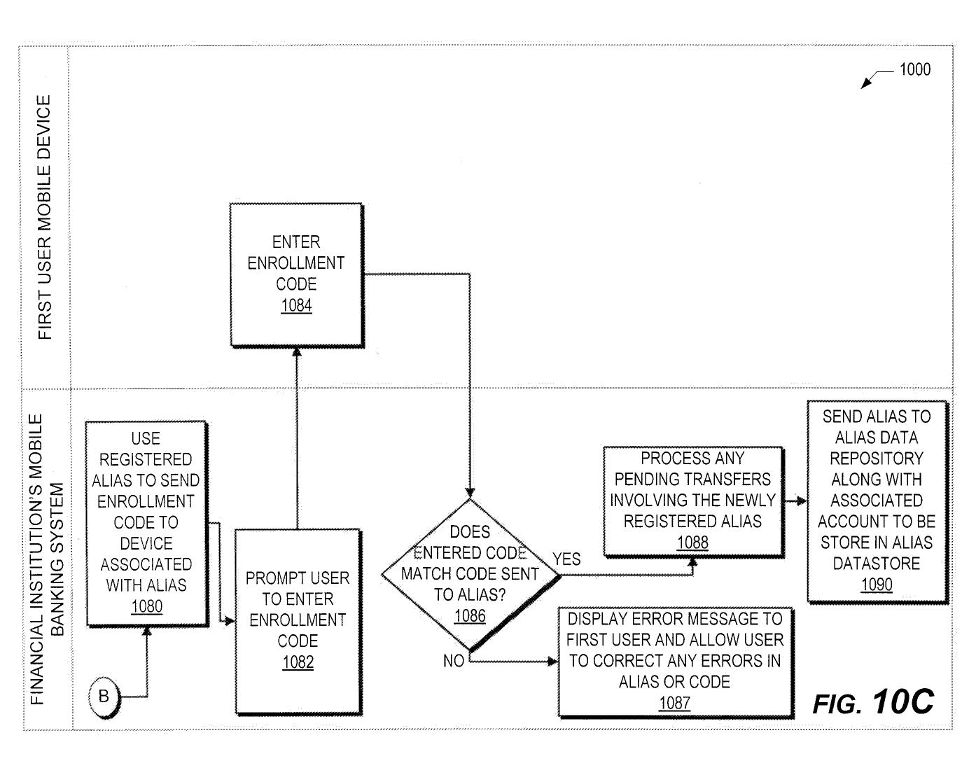

FIGS. 10A-10C provide flow charts illustrating a process 1000 for receiving P2P payments, in accordance with an embodiment of the invention. FIGS. 10A-10C illustrate the flow chart in terms of “swim lanes” associated with entities which may perform the operations in each respective swim lane. The entities illustrated in the exemplary Figures are a financial institution's online banking system and a first user (recipient) using a first personal computing device. However, it should be noted that other entities could also be involved and some embodiments of the invention may not be limited to the two entities illustrated in FIGS. 10A-10C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity (or even in the customer swim lane).

The process 1000 in FIG. 10A starts with block 1005 where an online banking system 600 using the alias, such as an email address or mobile telephone number, sends a first user (recipient) notice of a requested transfer from a second user, the notice including a link to the online banking system 600 and a confirmation number.

The process then proceeds to block 1010 where a first user (recipient) activates the link provided with the notice.

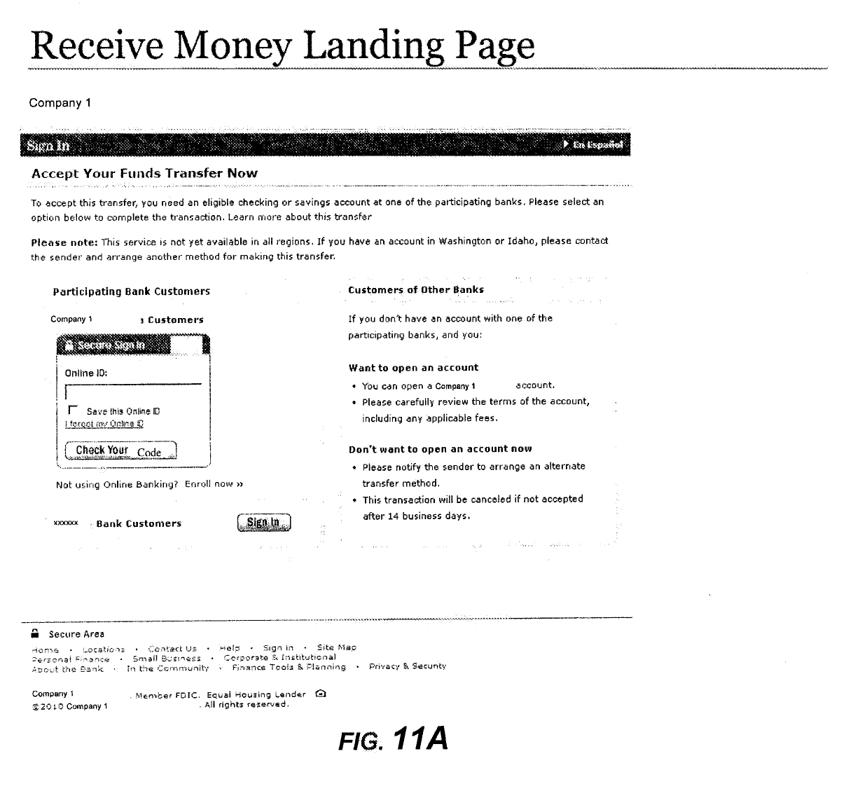

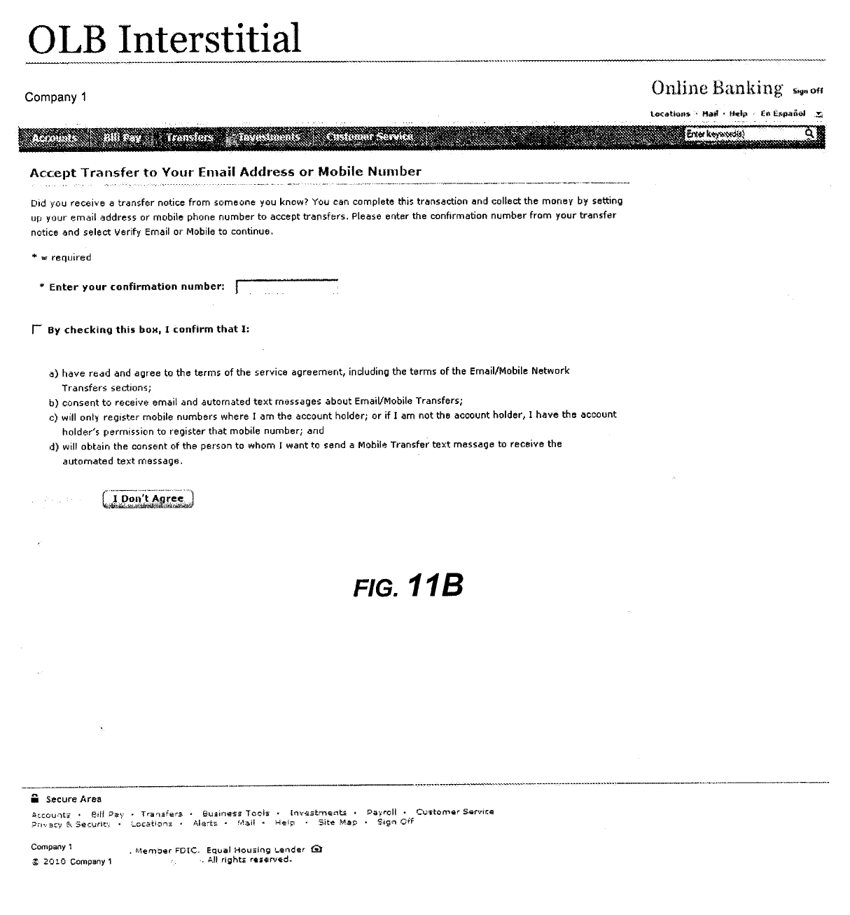

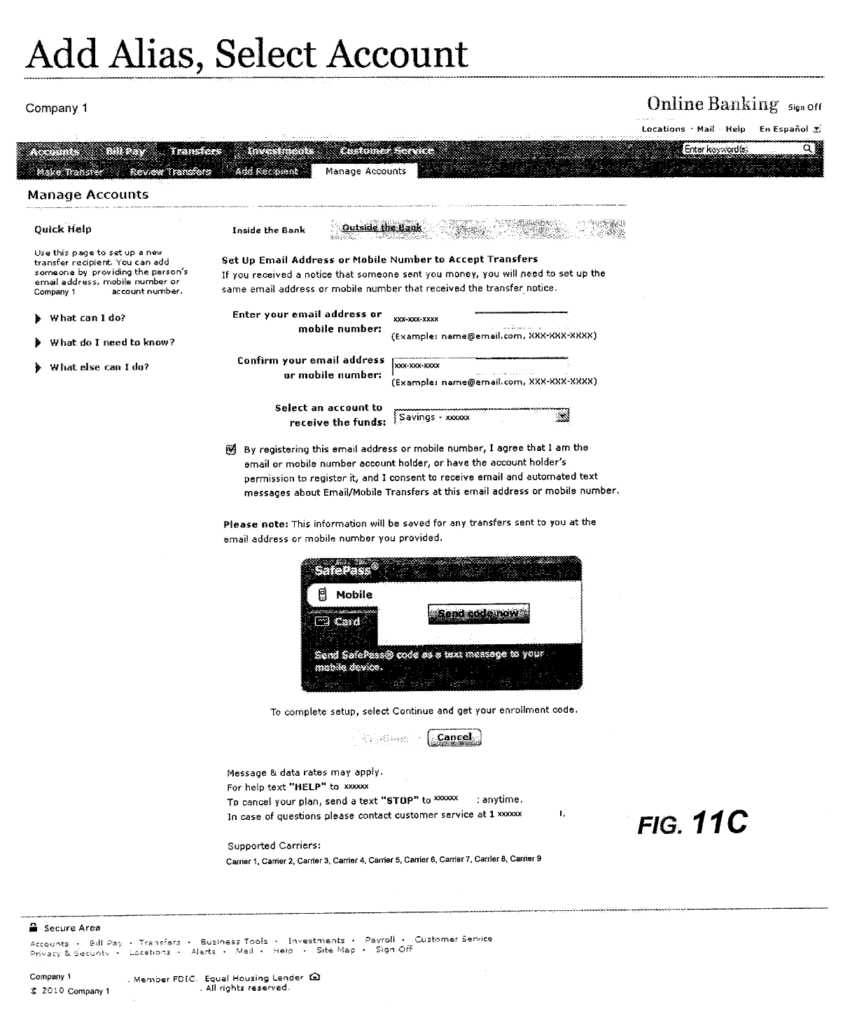

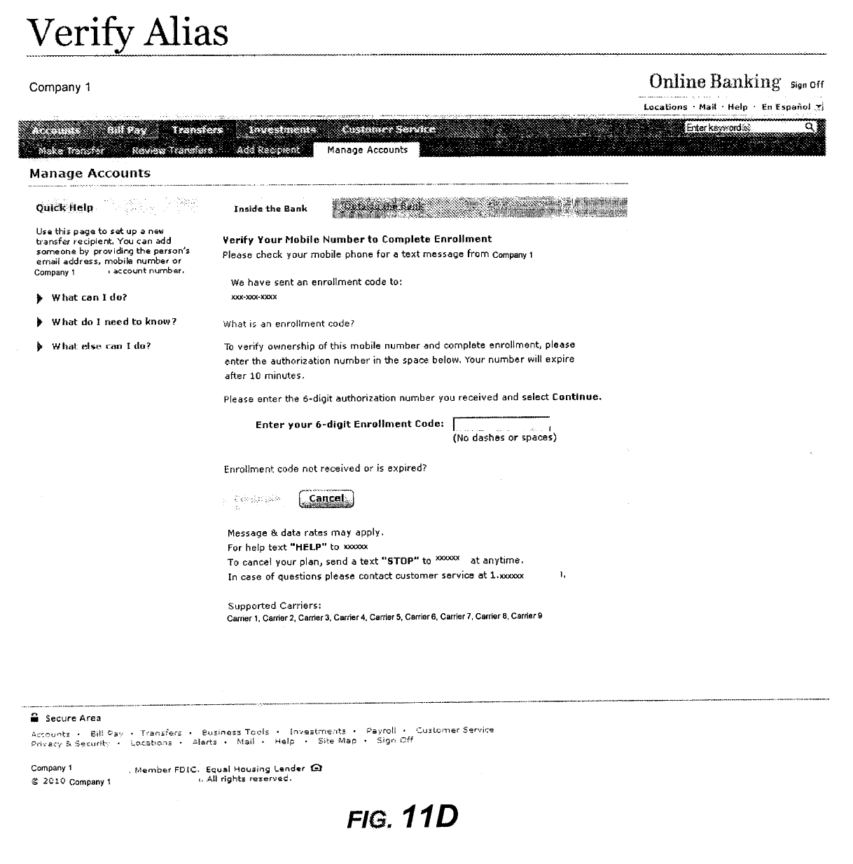

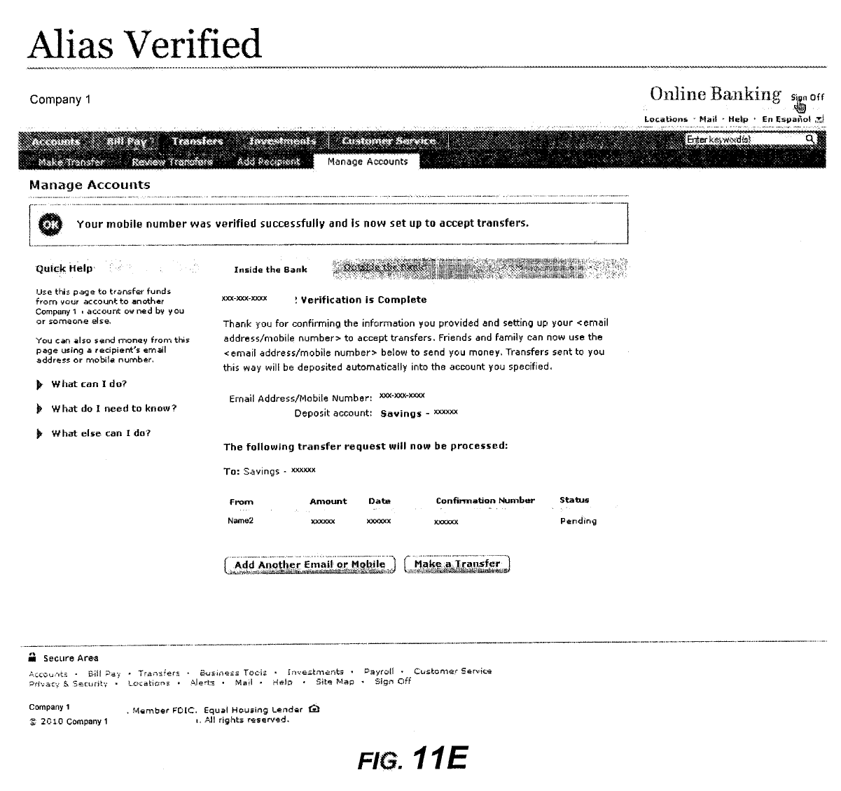

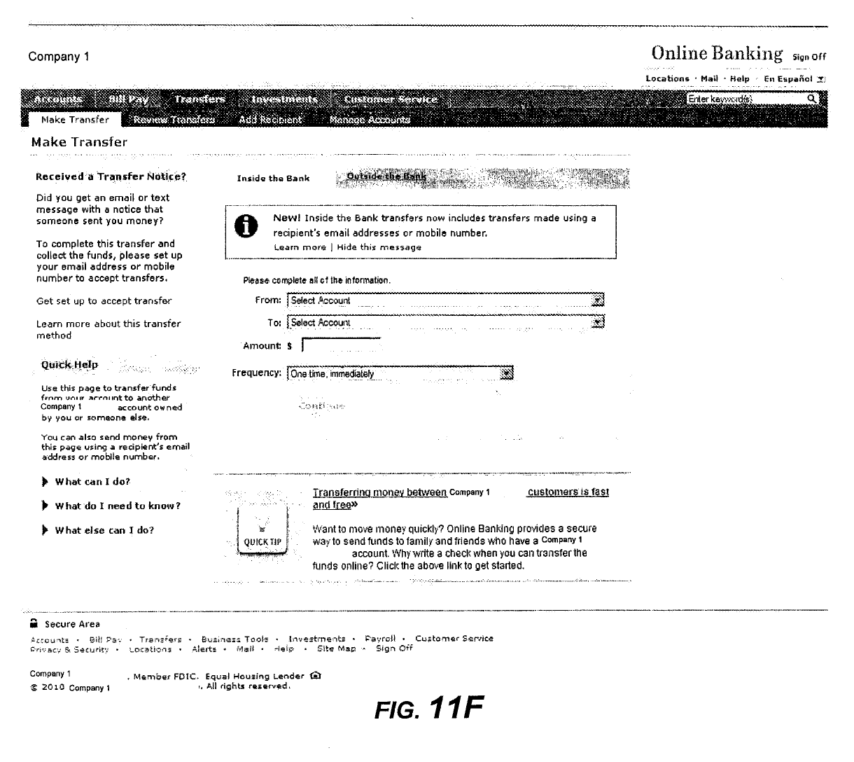

The process then proceeds to the screenshot of a page as shown in FIG. 11A where the online banking system 600 presents a sign-in page. The online banking system 600 alerts the first user (recipient) that to accept the transfer, the first user will need an eligible checking or saving account at a participating bank. For customers who hold accounts at the financial institution that manages the online banking system 600, the online banking system 600 presents a widget with a textbox that allows the first user to enter login or other authenticating information. The online banking system 600 also provides a link for the first user to enroll with the financial institution's online banking system. For customers of other participating financial institutions, the online banking system 600 provides a sign-in button, which may be configured to either display a sign-in widget on the instant page or provide a link to another page where the first user can enter login information for the participating financial institution. The online banking system 600 also notifies the first user that if the first user does not have an account with one of the participating banks, that first user can open an account at the financial institution that maintains the online banking system 600. The online banking system 600 notifies the first user that he or she may review the terms of opening a new account at this financial institution, including any fees that may be incurred by the first user in opening this new account. The online banking system 600 also notifies the first user that if the first user does not want to open a new financial institution account, the first user may notify the sender to arrange an alternate transfer method. The online banking system 600 also notifies the first user that the transaction will be canceled if it is not accepted within a pre-determined period of time.

The process then proceeds to block 1020 of FIG. 10A where the first user (recipient) determines whether the first user has an account with the financial institution that manages the online banking system 600. If the first user has a financial institution account with the financial institution that manages the online banking system 600, then the process proceeds to block 1050 where the first user enters authentication information into the textbox shown in FIG. 11A.

As shown in FIG. 10A, if the first user does not have a financial institution account with the financial institution that manages the online banking system 600 then the process proceeds to block 1022 where the first user determines whether the first user has an account with participating financial banks or financial institutions. If the first user has a financial institution account with a participating financial institution, the process proceeds to block 1040 where the first user can select the participating financial institution sign-in link as described previously and illustrated on FIG. 11A. The process then proceeds to block 1045 where the online banking system 600 forwards the first user to a participating financial institution's website or alternatively, the online banking system 600 opens a widget or an applet on the same window as that shown in FIG. 11A or a new pop-up window.

As shown in FIG. 10A, if, in block 1020, the first user does not have an account with the financial institution that manages the online banking system 600 and if, in block 1024, the first user (recipient) does not open a new account with the bank that manages the online banking system 600, then after a defined period of time without recipient (first user) acceptance, the online banking system 600 cancels the transfer and notifies the second user (sender).

As shown in FIG. 10A, in block 1024, if the first user opens a new account with the bank that manages the online banking system 600, then the first user, in block 1025, selects the link directing the first user to open a new account with the bank that manages the online banking system 600. This link described is shown in FIG. 11A and described previously.

As shown in FIG. 10A, the link in block 1025 directs the online banking system 600 to display a new account application GUI to the first user, which is readily approved and opened for the first user after receiving any pertinent information that may be required to open and approve a new account at the financial institution that manages the online banking system 600. The process then proceeds to block 1050 in FIG. 10A where the first user enters authentication information into the textbox shown in FIG. 11A.

The process then moves to block 1060 on FIG. 10B where the online banking system 600 prompts the first user to enter a confirmation number received with the transfer notice and agree to the terms governing the transfer. A screenshot for the GUI that handles this process is shown in FIG. 11B. As shown in FIG. 11B, the online banking system 600 indicates to the first user that this is the start of the procedure to accept a transfer to money to the first user's email address or mobile number. As shown in FIG. 11B, the online banking system 600 prompts the first user to enter the received confirmation number in a checkbox. As shown in FIG. 11B, the page also has two buttons—a first button configured for the first user to indicate the desire to proceed with accepting the transfer and a second button configured for the first user to indicate the desire to not proceed with the transfer. As shown in FIG. 11B, the first button can change from a dormant state to an activatable state by checking the check-box to confirm that the first user has a) has read and agrees to the terms of the service agreement, including the terms of the Email/Mobile Network Transfer section; b) consents to receive email and automated text messages about Email/Mobile Transfers; c) will only register mobile numbers where the first user is the account holder; or if the first user is not the account holder, he or she has the account holder's permission to register that mobile number; and d) will obtain the consent of the person to whom he or she wants to send a Mobile Transfer text message to receive the automated text message. In one embodiment, the first user has to always go through the procedure of accepting the transfer. In other embodiments, the first user does not have to go through the procedure accepting the transfer for any transfer after the first transfer.

Subsequently, in block 1065 of FIG. 10B, the first user enters a confirmation number in the appropriate textbox as shown in FIG. 11B and agrees to the terms that govern the transaction by activating the appropriate checkbox. The first user then activates the first button to continue the process of accepting the transfer.

The process then proceeds to block 1068 of FIG. 10B where the online banking system 600 uses the confirmation number entered in block 1065 to identify or confirm the transfer request.

Then the process proceeds to block 1070 of FIG. 10B where the online banking system 600 prompts the first user to register the alias to which transfer notice was sent. A screenshot of this registration page is shown in FIG. 11C. As shown in FIG. 11C, the online banking system 600 indicates to the first user that if the first user has received a notice that funds were sent to the first user, then the first user will need to set up to accept transfers to the same email address or mobile number that received the transfer notice. The page shows a first textbox where the user can enter the alias that received the transfer notice, and a second textbox where the user can confirm the alias entered in the first textbox by re-entering the alias in the second textbox. The online banking system 600 also prompts the user to select the appropriate account to link to the alias that will receive the funds by selecting the appropriate account from a drop down list. The online banking system 600 also prompts the user to check a checkbox, whereby the first user by checking the checkbox agrees that by registering the alias, he or she is the alias account holder, or has the alias account holder's permission to register it, and consents to receive email and text messages about alias transfers at this email address or phone number. In some embodiments, the online banking system 600 presents an authentication widget as shown in FIG. 11C and described in further detail below. The page also has two buttons—a first button configured to allow the first user to indicate a desire to proceed with receiving the transfer and a second button configured to allow the first user to indicate a desire not to proceed with receiving the transfer. This first button only becomes activatable after the first user enters all the required information on the page and has been further authenticated, as in some embodiments. In one embodiment, the online banking system 600 also saves the information entered on this page, so that the first user does not have to re-register an alias every time the first user receives a P2P transfer.

The process then proceeds to block 1075 where the first user enters the alias in the appropriate textbox, confirms the alias in the appropriate textbox, selects the account to receive the funds from the drop-down list shown in FIG. 11C, and checks the checkbox that indicates that the first user accepts the terms that govern the transfer. In some embodiments, the accounts listed in the drop-down list are identified by a few digits of the account number.

In some embodiments, the process then proceeds to block 1077 where the online banking system 600 requires additional authentication to register an alias. As illustrated on FIG. 11C, the online banking system 600 displays a widget which serves as an additional authenticating step before saving the information of the first user's associated alias. The online banking system 600 indicates to the first user that by activating the button in the widget for sending a code, the first user will receive a code on his or her mobile device. In another embodiment, the first user may receive a code through other means such as email, postal mail, etc. In one embodiment, the widget is a “SafePass®” widget and the user can send a Safe Pass code to the first user's mobile device.

The process then moves to block 1079 of FIG. 10B where the first user performs an additional authenticating step. As indicated on the screenshot shown in FIG. 11C, the first user activates the button within the widget for sending a code to the first user's mobile device. The first user than receives on his or her mobile device the code that he or she must input into the widget shown in FIG. 11C. Once the first user inputs the correct code into the widget and activates a button in the widget to confirm that the code is correct, the button that corresponds to adding a new recipient is activatable so that it can now be activated by the first user. The first user (recipient) activates this button so that the online banking system 600 can store the first user's alias. The first user can activate the first button on the page which indicates that the first user wishes to proceed with the transfer. The online banking system 600 indicates to the first user as shown in FIG. 11C that by activating the first button to continue with receiving the transfer, the first user will receive an enrollment code.

The process then moves to block 1080 of FIG. 10C where the online banking system 600 uses the registered alias to send an enrollment code to the device of the first user associated with the alias.

The process then moves to block 1082 of FIG. 10C where the online banking system 600 prompts the first user to enter the enrollment code that the first user received on the device associated with the alias. A page showing this block is captured on FIG. 11D. The online banking system 600 indicates to the first user that the first user must verify the alias (e.g., mobile number) to complete enrollment in the P2P transfer via system. In one embodiment, the page indicates to the first user that the first user should expect a text message from the bank that manages the online banking system 600. The page also has activatable text if the first user would like to know more about the use of enrollment codes. The page as shown in FIG. 11D indicates to the first user that the enrollment code must be entered into the appropriate textbook in order verify ownership of the mobile number or email address associated with the alias and complete enrollment with the P2P transfer service. As shown in FIG. 11D, the online banking system 600 also indicates to the first user that the enrollment number expires in a pre-determined number of minutes. After the enrollment number expires, the online banking system 600 will not be able use that enrollment code to verify ownership of the first user's mobile number associated with the transfer and will not be able to complete the enrollment of the first user (recipient). The page also has activatable text if the first user has not received an enrollment code or if the enrollment code has expired. The page indicates to the first user that messaging and data rates may apply for receiving the enrollment code. The page also has two buttons—a first button configured to allow the first user to indicate that the first user does not wish to proceed with the transaction and a second button configured to allow the first user to indicate that the first user desires to proceed with receiving the transfer. This second button only becomes activatable after the first user enters an enrollment code on the page. In some embodiments, this second button only becomes activatable after the first user enters a valid and unexpired enrollment code on the page.

The process then moves to block 1084 where the first user enters the enrollment code into the textbox that is shown in FIG. 11D.

The process then moves block 1086 where the online banking system 600 determines if the enrollment code entered by the first user matches the enrollment code sent by the online banking system 600 to the alias of the first user.

If the entered code in 1086 does not match the code sent to the alias, then, at block 1087, the online banking system 600 displays an error message to the first user that the transaction cannot proceed further. In one embodiment, the online banking system 600 allows the first user to correct any errors in the alias provided by the first user or in the code received by the first user. In one embodiment, the online banking system 600 only grants a pre-determined number of unsuccessful attempts to verify the code before rejecting the transfer.

If the entered code in 1086 matches the code sent to the alias, the process moves to block 1088 where the online banking system 600 processes any pending transfers involving the newly registered alias. As shown in FIG. 11E, the online banking system 600 indicates to the user that the verification of the alias has been completed. The online banking system 600 thanks the user for setting up an alias to accept transfers. The online banking system 600 indicates to the first user that people or entities can now send money to the first user using the first user's alias. The online banking system 600 indicates to the first user that any transfer to the first user's newly registered alias will be deposited to the account number shown on the page (see FIG. 11E). In one embodiment, the online banking system 600 only shows a pre-determined number of digits of the first user's financial institution account number. The page also indicates to the first user that the transfer request is now in process. As shown in FIG. 11E, the page shows details of the transfer, including, but not limited to the name of the sender, the amount, the date on which the sender sent the amount, the confirmation number, and the status of the transfer. The page also includes two buttons—the first button is configured to allow the first user to add another alias and the second button is configured to allow the first user to make a transfer using the newly registered alias.

The process then moves to block 1090 where the online banking system 600 sends the alias to the alias data repository 700 along with associated account information to be stored in the alias datastore.

FIG. 11F presents a GUI where the online banking system 600 presents four sub-tabs under the “Transfers” tab described earlier. These four sub-tabs are a first sub-tab for a making a transfer, a second sub-tab for reviewing transfers, a third sub-tab for adding recipients, and a fourth sub-tab for managing accounts. FIG. 11F also shows that under the first sub-tab for making transfers, the first user has the option of obtaining a set up to accept transfer by activating the associated link. The online banking system 600 indicates to the first user (recipient) that the first user may activate this link if the first user received a transfer notice, i.e., the first user received an email, text message, or other form of electronic communication that someone has sent funds to the first user. The online banking system 600 indicates to the first user that in order to complete the transfer and collect the funds, the first user must set up the first user's alias to accept transfers. The online banking system 600 also presents a activatable link configured to allow the first user to be directed to a page to learn more about this P2P transfer via alias method. The online banking system 600 also presents a help box where the first user can understand more about what the first user can do using the online banking system 600, what the first user needs to know, and what else the first user can do using the online banking system 600. The online banking system 600 also presents a message to the first user that transferring money within the bank is fast and free. The online banking system 600 also indicates to the customer that the feature of making a P2P transfer using a recipient's alias is a new feature, and that transfers within the bank now include transfers made using a recipient's alias. Alternatively, a user who intends to receive money using an alias can get set up by clicking on the activatable text associated with getting set up to accept transfers. This option is also illustrated by block 1095 of FIG. 10B where a user who accesses the online banking system 600 can register an alias by selecting an appropriate link. Therefore, in one embodiment, the user does not have to wait to receive a payment using the P2P transfer service before setting up an alias to receive transfers.

In one embodiment of the invention, both the sender and the recipient need to have financial institution accounts registered for P2P transfer via alias. In another embodiment of the invention, the sender needs to have a financial institution account registered for P2P transfer via alias, but the recipient does not need to have a financial institution account registered for P2P transfer via alias. In another embodiment of the invention, the recipient needs to have a financial institution account registered for P2P transfer via alias, but the sender does not need to have a financial institution account registered for P2P transfer via alias.

### Online Banking P2P Payment Management Process and Interface

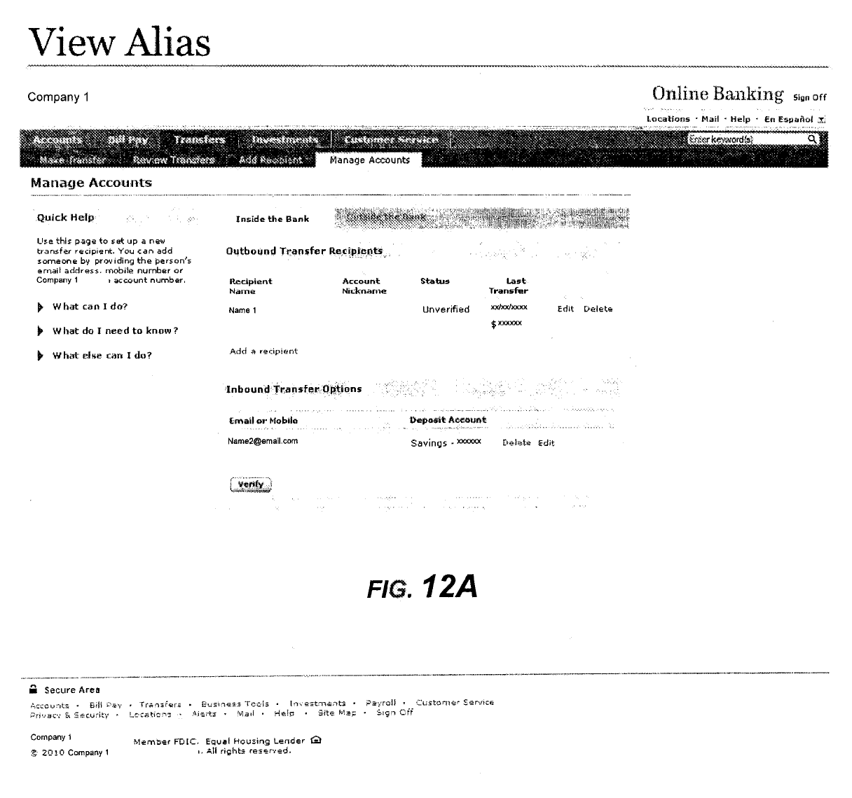

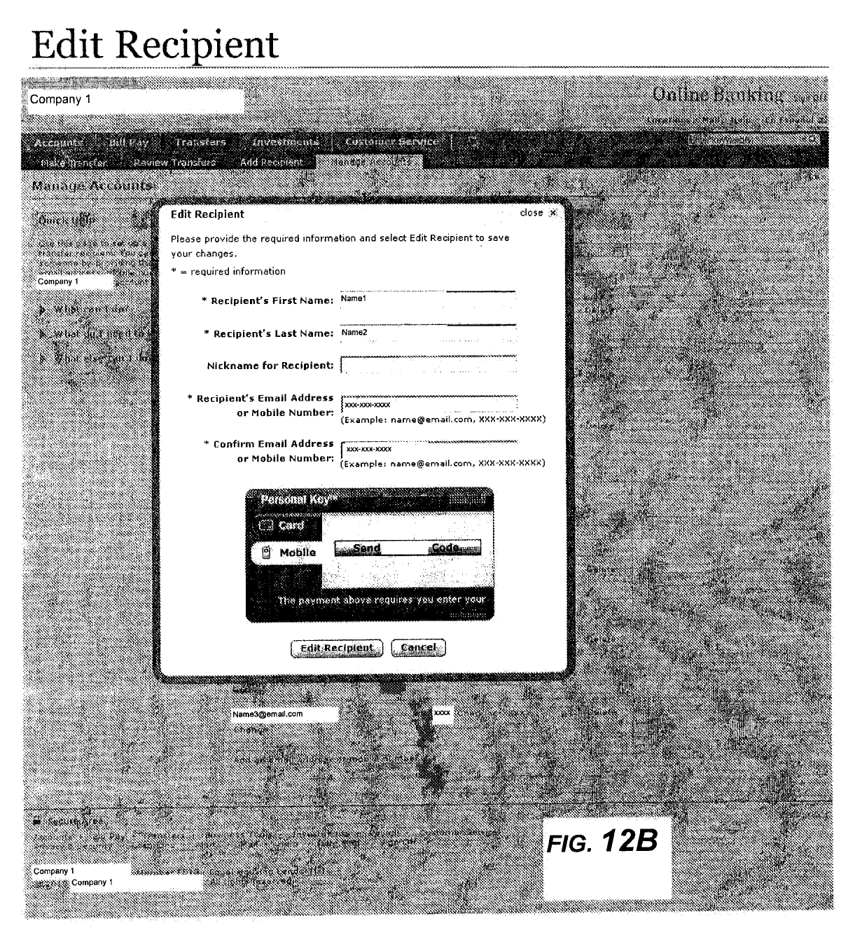

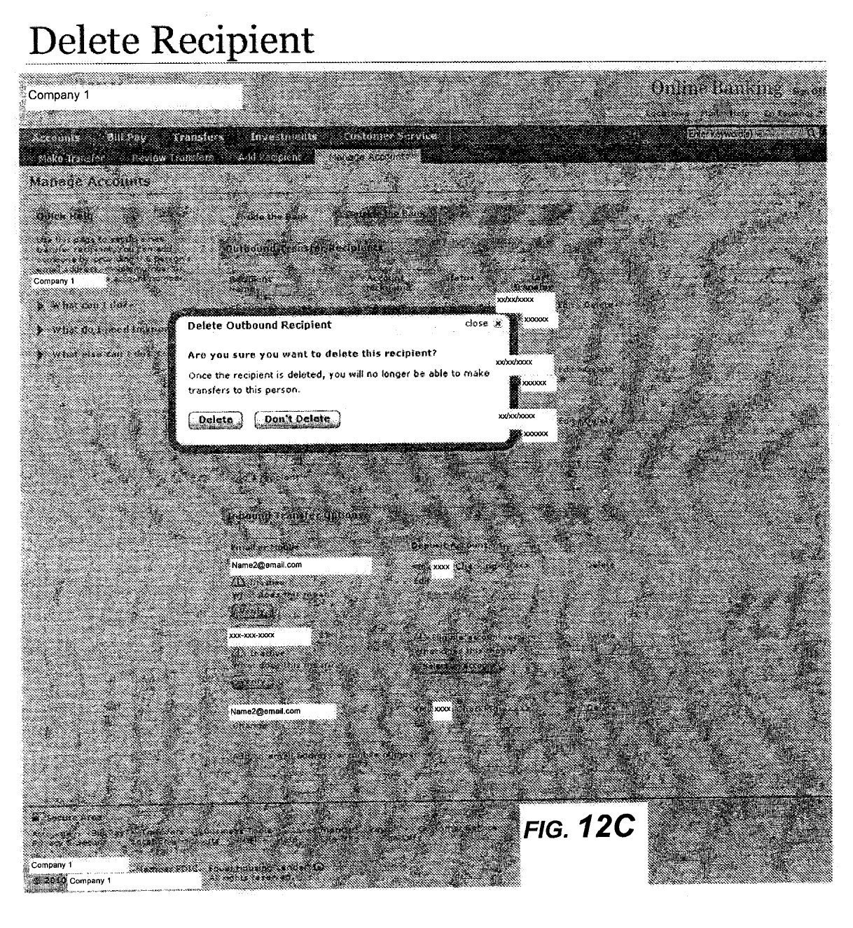

FIG. 12A presents a GUI where the online banking system 600 presents four sub-tabs under the “Transfers” tab described earlier. These four sub-tabs are a first sub-tab for a making a transfer, a second sub-tab for reviewing transfers, a third sub-tab for adding recipients, and a fourth sub-tab for managing accounts. FIG. 12A shows that under the first sub-tab for managing accounts, there are two lists. The first list is associated with outbound transfer recipients and indicates the status of transfers to recipients. The status page shows for each transfer the recipient's name, the recipient account's nickname, the status of the transfer, the date on which the transfer was made, and the amount of the transfer. The status page also provides activatable links for editing, deleting and adding selected information about outbound transfer recipients. The status page also provides an activable link for adding a recipient to the list of outbound transfer recipients. The second list under the first sub-tab for managing accounts is a list of inbound transfer options. The list contains information about the alias along with the account that the alias is linked to. As shown in FIG. 12A, there is an email alias listed that is associated with a particular account. The page also presents options (activable links) for a user to delete, add or edit information relating to inbound transfer options. As shown in FIG. 12A, the online banking system 600 describes the status of inbound transfer aliases. In one embodiment, if an alias has been inactive for a pre-determined number of days, the user may have to verify the alias by activating a verify button as shown in FIG. 12A. As shown in FIG. 12A, the online banking system 600 also displays a message to the user if the user has not associated an eligible account with an alias. In such a case, as shown in FIG. 12A, the page provides a button to select an eligible account to associate with an alias. In one embodiment of the invention, only a single alias can be linked to a financial institution account. In another embodiment of the invention, multiple aliases can be linked to a single financial institution account. In a further embodiment of the invention, a single alias can be linked to multiple financial institution accounts.

If, on FIG. 12A, a user activates the button for editing a recipient's information, the online banking system 600, in one embodiment, presents a pop-up window as shown in FIG. 12B where the user can change information regarding the recipient's first name, the recipient's last name, the nickname for the recipient as chosen by the user, and the recipient's alias. In one embodiment, the user has to re-enter the alias to confirm the alias. In one embodiment, the recipient's first name, the recipient's last name, the recipient's alias, and a confirmation of the recipient's alias must necessarily be entered, while the nickname is optional. In one embodiment, the pop-up window has two buttons: a first button to complete the process of editing the recipient's information and a second button to cancel the process of editing the recipient's information. In one embodiment, the editing button is not activatable until all the required information has been entered as shown in FIG. 12B and the information has been authenticated. In one embodiment, the user may not be able to edit the recipient's information until the user authenticates the information by activating a button in a widget to send a code to the user's mobile device, and subsequently enters that code into the textbox in the widget, as previously described. Once the user has been authenticated, the user can activate the appropriate button in the pop-up window shown in FIG. 12B to complete the process of editing the recipient's information.

If, in FIG. 12A, a user activates the button to delete a recipient, the online banking system 600, in one embodiment as shown in FIG. 12C, presents a pop-up window where the online banking system 600 asks the user whether the user is sure that he or she wants to delete the recipient from the list of outbound transfer recipients. The online banking system 600 notifies the user that once a recipient is deleted, the user will no longer be able to make transfers to that recipient. The pop-window of FIG. 12C also has two clickable buttons: a first button configured to confirm that the user wants to delete the recipient and a second button configured to retain the recipient on the list of outbound transfer recipients. Once the user activates on the button to delete a recipient, the recipient is removed from the list of outbound transfer recipients.

### Mobile Banking P2P Payment System and Environment

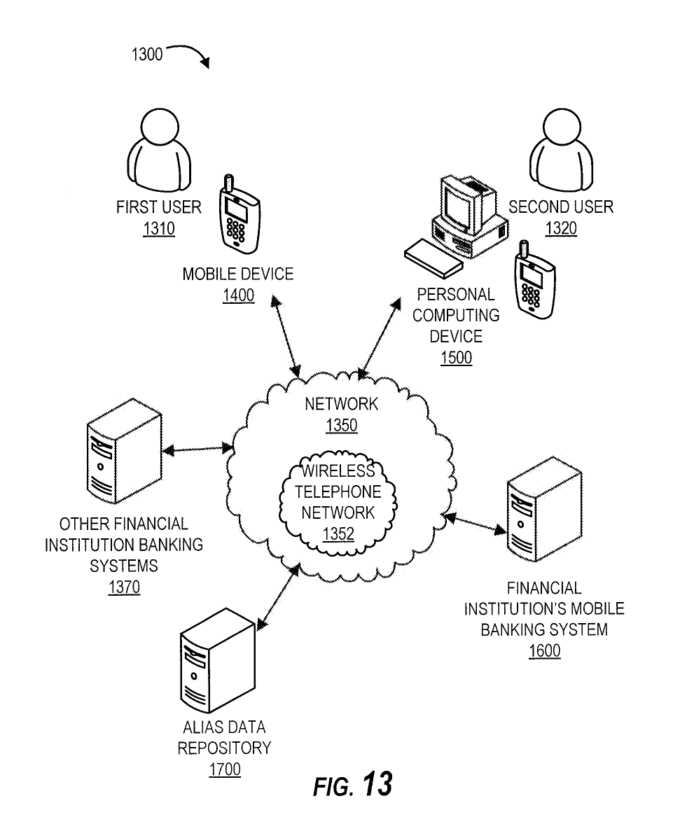

Referring now to FIGS. 13-22D, additional embodiments directed to a mobile payment system and method are discussed.

FIG. 13 provides a block diagram illustrating a mobile banking P2P payment system and environment 1300, in accordance with an embodiment of the invention. As illustrated in FIG. 13, the P2P payment environment 100 includes a first user 1310 and a second user 1320 where a first user wants to send funds to a second user. A user of the system may be a person, but may also be a business (e.g., a merchant) or any other entity capable of sending or receiving funds.

The environment 1300 also includes a mobile device 1400 and a personal computing device 1500 for the first user 1310 and second user 1320, respectively. The personal computing device 1500 may be any device that employs a processor and memory and can perform computing functions, such as a personal computer or a mobile device. As used herein, a “mobile device” 1400 is any mobile communication device, such as a cellular telecommunications device (i.e., a cell phone or mobile phone), personal digital assistant (PDA), a mobile Internet accessing device, or other mobile device.

The mobile device 1400 and the personal computing device 1500 are configured to communicate over a network 1350 with a financial institution's mobile banking system 1600 and, in some cases, one or more other financial institution banking systems 1370. The first user's mobile device 1400, the second user's personal computing device 1500, the financial institution's mobile banking system 1600, an alias data repository 1700, and any other participating financial institution's banking systems 1370 are each described in greater detail below with reference to FIGS. 14-17. The network 1350 may include a local area network (LAN), a wide area network (WAN), and/or a global area network (GAN). The network 1350 may provide for wireline, wireless, or a combination of wireline and wireless communication between devices in the network. In one embodiment, the network 1350 includes the Internet. In one embodiment, the network 1350 includes a wireless telephone network 1352.

In general, a mobile device 1400 is configured to connect with the network 1300 to log the first user 1310 into a mobile banking system 1600. The mobile banking system 1600 involves authentication of a first user in order to access the first user's account on the mobile banking system 1600. For example, the mobile banking system 1600 is a system where a first user 1310 logs into his/her account such that the first user 1310 or other entity can access data that is associated with the first user 1310. For example, in one embodiment of the invention, the mobile system 1600 is a mobile banking system maintained by a financial institution. In such an embodiment, the first user 1310 can use the mobile device 1400 to log into the mobile banking system to access the first user's mobile banking account. Logging into the mobile banking system 1300 generally requires that the first user 1310 authenticate his/her identity using a user name, a passcode, a cookie, a biometric identifier, a private key, a token, and/or another authentication mechanism that is provided by the first user 1310 to the mobile banking system 1600 via the mobile device 1400.

The financial institution's mobile banking system 1600 is in network communication with other devices, such as other financial institutions' transaction/banking systems 1370, an alias data repository 1700, and a personal computing device 1500 that is configured to communicate with the network 1350 to log a second user 1320 into the mobile banking system 1600. In one embodiment, the invention may provide an application download server such that software applications that support the mobile banking system 1600 can be downloaded to the mobile device 1400.

In some embodiments of the invention, the application download server is configured to be controlled and managed by one or more third-party data providers (not shown in FIG. 13) over the network 1350. In other embodiments, the application download server is configured to be controlled and managed over the network 1350 by the same entity that maintains the mobile banking system 1600.

In some embodiments of the invention, the alias data repository 1700 is configured to be controlled and managed by one or more third-party data providers (not shown) over the network 1350. In other embodiments, the alias data repository 1700 is configured to be controlled and managed over the network 1350 by the same entity that maintains the financial institution's mobile banking system 1600. In other embodiments, the alias data repository 1700 is configured to be controlled and managed over the network 1350 by the financial institution implementing the mobile payment system of the invention. In still other embodiments, the alias data repository 1700 is a part of the mobile banking system 1600.

FIG. 14 provides a block diagram illustrating the consumer mobile device 1400 of FIG. 13 in more detail, in accordance with embodiments of the invention. In one embodiment of the invention, the mobile device 1400 is a mobile telephone. However, it should be understood, however, that a mobile telephone is merely illustrative of one type of mobile device 1400 that may benefit from, employ, or otherwise be involved with embodiments of the invention and, therefore, should not be taken to limit the scope of embodiments of the invention. Other types of mobile devices 1400 may include portable digital assistants (PDAs), pagers, mobile televisions, gaming devices, laptop computers, cameras, video recorders, audio/video player, radio, GPS devices, or any combination of the aforementioned.

The mobile device 1400 generally includes a processor 1410 communicably coupled to such devices as a memory 1420, user output devices 1436, user input devices 1440, a network interface 1460, a power source 1415, a clock or other timer 1450, a camera 1480, and a positioning system device 1475. The processor 1410, and other processors described herein, generally include circuitry for implementing communication and/or logic functions of the mobile device 1400. For example, the processor 1410 may include a digital signal processor device, a microprocessor device, and various analog to digital converters, digital to analog converters, and/or other support circuits. Control and signal processing functions of the mobile device 1400 are allocated between these devices according to their respective capabilities. The processor 1410 thus may also include the functionality to encode and interleave messages and data prior to modulation and transmission. The processor 1410 can additionally include an internal data modem. Further, the processor 1410 may include functionality to operate one or more software programs, which may be stored in the memory 1420. For example, the processor 1410 may be capable of operating a connectivity program, such as a web browser application 1422. The web browser application 1422 may then allow the mobile device 1400 to transmit and receive web content, such as, for example, location-based content and/or other web page content, according to a Wireless Application Protocol (WAP), Hypertext Transfer Protocol (HTTP), and/or the like.

The processor 1410 is configured to use the network interface 1460 to communicate with one or more other devices on the network 1350. In this regard, the network interface 1460 includes an antenna 1476 operatively coupled to a transmitter 1474 and a receiver 1472 (together a “transceiver”). The processor 1410 is configured to provide signals to and receive signals from the transmitter 1474 and receiver 1472, respectively. The signals may include signaling information in accordance with the air interface standard of the applicable cellular system of the wireless telephone network 1352. In this regard, the mobile device 1400 may be configured to operate with one or more air interface standards, communication protocols, modulation types, and access types. By way of illustration, the mobile device 1400 may be configured to operate in accordance with any of a number of first, second, third, and/or fourth-generation communication protocols and/or the like. For example, the mobile device 1400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 1400 may also be configured to operate in accordance with non-cellular communication mechanisms, such as via a wireless local area network (WLAN) or other communication/data networks.

The network interface 1460 may also include a payment network interface 1470. The payment network interface 1470 may include software, such as encryption software, and hardware, such as a modem, for communicating information to and/or from one or more devices on a network 1350. For example, the mobile device 1400 may be configured so that it can be used as a credit or debit card by, for example, wirelessly communicating account numbers or other authentication information to a terminal of the network 1350.

As described above, the mobile device 1400 has a user interface that is, like other user interfaces described herein, made up of user output devices 1436 and/or user input devices 1440. The user output devices 1436 include a display 1490 (e.g., a liquid crystal display or the like) and a speaker 1432 or other audio device, which are operatively coupled to the processor 1410. The user input devices 1440, which allow the mobile device 1400 to receive data from a user such as the first user 1310, may include any of a number of devices allowing the mobile device 1400 to receive data from a user, such as a keypad, keyboard, touch-screen, touchpad, microphone, mouse, joystick, other pointer device, button, soft key, and/or other input device(s). The user interface may also include a camera 1480, such as a digital camera.

The mobile device 1400 may also include a positioning system device 1475 that is configured to be used by a positioning system to determine a location of the mobile device 1400. For example, the positioning system device 1475 may include a GPS transceiver. In some embodiments, the positioning system device 1475 is at least partially made up of the antenna 1476, transmitter 1474, and receiver 1472 described above. For example, in one embodiment, triangulation of cellular signals may be used to identify the approximate location of the mobile device 1400. In other embodiments, the positioning system device 1475 includes a proximity sensor or transmitter, such as an RFID tag, that can sense or be sensed by devices known to be located proximate a merchant or other location to determine that the consumer mobile device 1400 is located proximate these known devices.

The mobile device 1400 further includes a power source 1415, such as a battery, for powering various circuits and other devices that are used to operate the mobile device 1400. Embodiments of the mobile device 1400 may also include a clock or other timer 1450 configured to determine and, in some cases, communicate actual or relative time to the processor 1410 or one or more other devices.

The mobile device 1400 also includes a memory 1420 operatively coupled to the processor 1410. As used herein, memory includes any computer readable medium (as defined herein below) configured to store data, code, or other information. The memory 1420 may include volatile memory, such as volatile Random Access Memory (RAM) including a cache area for the temporary storage of data. The memory 1420 may also include non-volatile memory, which can be embedded and/or may be removable. The non-volatile memory can additionally or alternatively include an electrically erasable programmable read-only memory (EEPROM), flash memory or the like.

The memory 1420 can store any of a number of applications which comprise computer-executable instructions/code executed by the processor 1410 to implement the functions of the mobile device 1400 described herein. For example, the memory 1420 may include such applications as a conventional web browser application 1422 and/or a mobile P2P payment system client application 1421. These applications also typically provide a graphical user interface (GUI) on the display 1490 that allows the first user 1310 to communicate with the consumer mobile device 1400, the mobile banking system 1600, and/or other devices or systems. In one embodiment of the invention, when the first user 1310 decides to enroll in the mobile banking program, the first user 1310 downloads or otherwise obtains the mobile banking system client application from the mobile banking system 1600 or from a distinct application server. In other embodiments of the invention, the first user 1310 interacts with the mobile banking system 1600 via the web browser application 1422 in addition to, or instead of, the mobile P2P payment system client application 1421.

The memory 1420 can also store any of a number of pieces of information, and data, used by the mobile device 1400 and the applications and devices that make up the mobile device 1400 or are in communication with the mobile device 1400 to implement the functions of the mobile device 1400 and/or the other systems described herein. For example, the memory 1420 may include such data as user authentication information, etc.

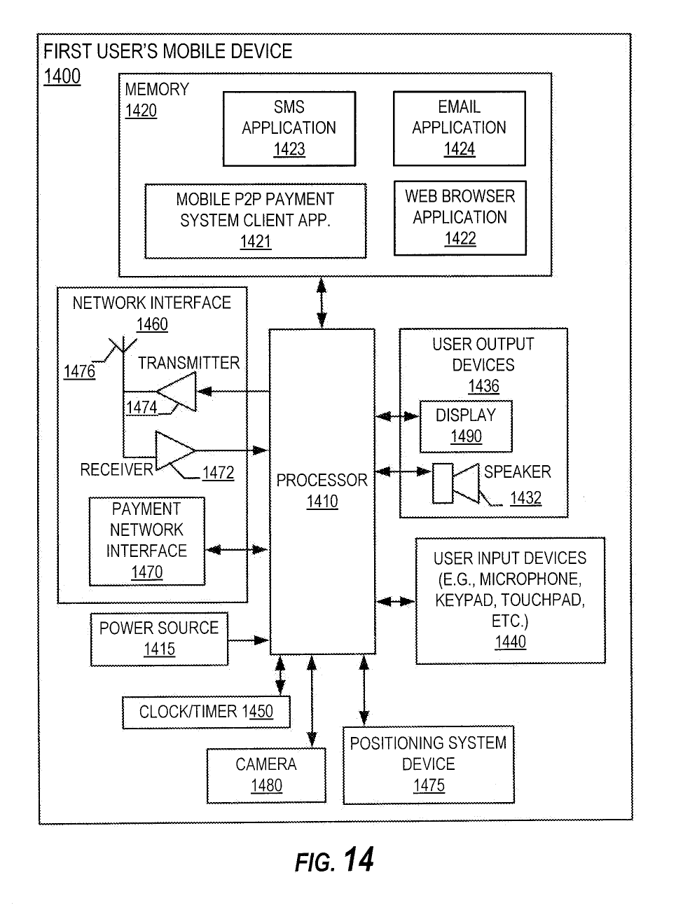

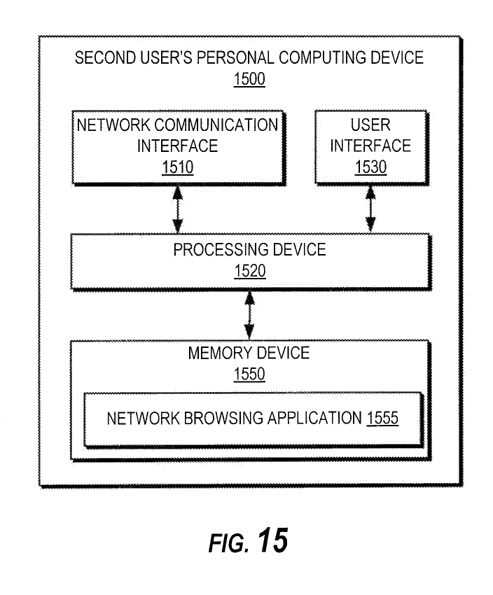

Referring now to FIG. 15, the personal computing device 1500 associated with the second user 1320 also includes various features, such as a network communication interface 1510, a processing device 1520, a user interface 1530, and a memory device 1550. The network communication interface 1510 includes a device that allows the personal computing device 1500 to communicate over the network 1350 (shown in FIG. 13). In one embodiment of the invention, a network browsing application 1555 provides for a user to establish network communication with a mobile banking system 1600 (shown in FIG. 13) for the purpose of initiating mobile payment and/or registering an account and/or alias with the mobile payment system and/or receiving mobile payment, in accordance with embodiments of the invention.

As used herein, a “processing device,” such as the processing device 1520, generally refers to a device or combination of devices having circuitry used for implementing the communication and/or logic functions of a particular system. For example, a processing device 1520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 1520 may further include functionality to operate one or more software programs based on computer-executable program code thereof, which may be stored in a memory. As the phrase is used herein, a processing device 1520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 1530 generally includes a plurality of interface devices and/or software that allow a customer to input commands and data to direct the processing device to execute instructions. For example, the user interface 1530 presented in FIG. 15 may include a graphical user interface (GUI) or an interface to input computer-executable instructions that direct the processing device 1520 to carry out specific functions. The user interface 1530 employs certain input and output devices to input data received from the first user 1310 or second user 1320 or output data to the first user 1310 or second user 1320. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 1550 generally refers to a device or combination of devices that store one or more forms of computer-readable media for storing data and/or computer-executable program code/instructions. Computer-readable media is defined in greater detail below. For example, in one embodiment, the memory device 1550 includes any computer memory that provides an actual or virtual space to temporarily or permanently store data and/or commands provided to the processing device 1520 when it carries out its functions described herein.

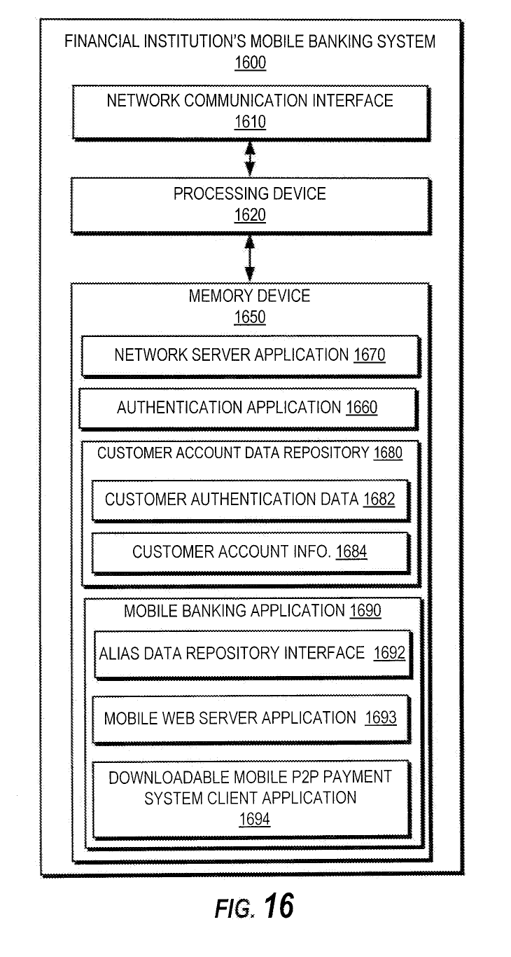

FIG. 16 provides a block diagram illustrating the mobile banking system 1600 in greater detail, in accordance with an embodiment of the invention. As illustrated in FIG. 16, in one embodiment of the invention, the mobile banking system 1600 includes a processing device 1620 operatively coupled to a network communication interface 1610 and a memory device 1650. In certain embodiments, the mobile banking system 1600 is operated by a first entity, such as a financial institution, while in other embodiments, the mobile banking system 1600 is operated by an entity other than a financial institution.

It should be understood that the memory device 1650 may include one or more databases or other data structures/repositories. The memory 1650 also includes computer-executable program code that instructs the processing device 1620 to operate the network communication interface 1610 to perform certain communication functions of the mobile banking system 1600 described herein. For example, in one embodiment of the mobile banking system 1600, the memory device 1650 includes, but is not limited to, a network server application 1670, an authentication application 1660, a customer account data repository 1680 which includes customer authentication data 1680 and customer account information 1684, a mobile banking application 1690 which includes an alias data repository interface 1692, a mobile web server application 1693, a downloadable mobile P2P payment system client application 1694 and other computer-executable instructions or other data. The computer-executable program code of the network server application 1670, the authentication application 1660, or the mobile banking application 1690 may instruct the processing device 1620 to perform certain logic, data-processing, and data-storing functions of the mobile banking system 1600 described herein, as well as communication functions of the mobile banking system 1600.

In one embodiment, the customer account data repository 1680 includes customer authentication data 1682 and customer account information 1684. The network server application 1670, the authentication application 1660, and the mobile banking application 1690 are configured to implement customer account information 1684, the customer authentication data 1682, and the alias data repository interface 1692 when authenticating the customer 101 (or the first user 1310) to the mobile banking system 1600. The customer account information 1684, the customer authentication data 1682, and the alias data repository interface 1692 are discussed in more detail in a later section.

As used herein, a “communication interface” generally includes a modem, server, transceiver, and/or other device for communicating with other devices on a network, and/or a user interface for communicating with one or more customers. Referring again to FIG. 16, the network communication interface 1610 is a communication interface having one or more communication devices configured to communicate with one or more other devices on the network 1350, such as the mobile device 1400, the personal computing device 1500, the mobile banking system 1600, the other financial institution banking systems 1370, and the alias data repository 1700. The processing device 1620 is configured to use the network communication interface 1610 to transmit and/or receive data and/or commands to and/or from the other devices connected to the network 1350.

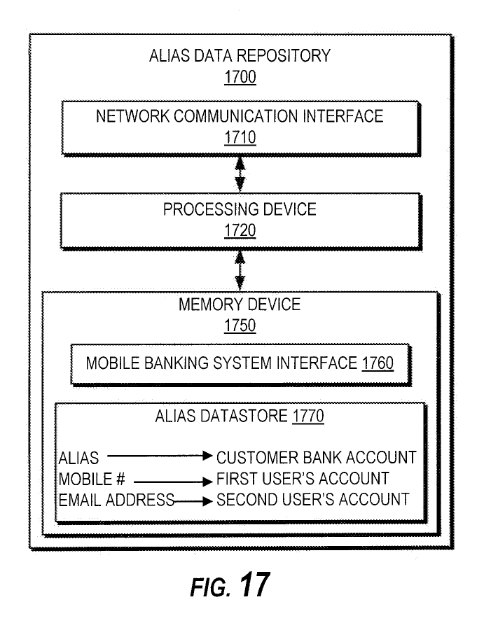

FIG. 17 provides a block diagram illustrating an alias data repository 1700, in accordance with an embodiment of the invention. In one embodiment of the invention, the alias data repository 1700 is operated by a second entity that is a different or separate entity from the first entity (e.g., the financial institution) that, in one embodiment of the invention, implements the mobile banking system 1600. In one embodiment, the alias data repository 1700 could be part of the mobile banking system 1600. In another embodiment, the alias data repository 1700 is a distinct entity from the mobile banking system 1600. As illustrated in FIG. 17, the alias data repository 1700 generally includes, but is not limited to, a network communication interface 1710, a processing device 1720, and a memory device 1750. The processing device 1720 is operatively coupled to the network communication interface 1710 and the memory device 1750.

In one embodiment of the alias data repository 1700, the memory device 1750 stores, but is not limited to, a mobile banking system interface 1760 and an alias data store 1770. The alias data store 1770 stores data including, but not limited to, an alias for the customer's financial institution account, mobile number or email address for the first user's 1310 account, and a mobile number and/or email address for the second user's 1320 account. In one embodiment of the invention, both the mobile banking system interface 1760 and the alias data store 1770 may associate with applications having computer-executable program code that instructs the processing device 1720 to operate the network communication interface 1710 to perform certain communication functions involving the alias data store 1770 described herein. In one embodiment, the computer-executable program code of an application associated with the alias data store 1770 may also instruct the processing device 1720 to perform certain logic, data processing, and data storing functions of the application associated with the alias data store 1770 described herein. An alias, as defined in this invention, is not limited to just a mobile device number or an email address.

The network communication interface 1710 is a communication interface having one or more communication devices configured to communicate with one or more other devices on the network 1350. The processing device 1720 is configured to use the network communication interface 1710 to receive information from and/or provide information and commands to a mobile device 1400, a personal computing device 1500, other financial institution banking systems 1370, the alias data repository 1700, the mobile banking system 1600 and/or other devices via the network 1350. In some embodiments, the processing device 1720 also uses the network communication interface 1710 to access other devices on the network 1350, such as one or more web servers of one or more third-party data providers. In some embodiments, one or more of the devices described herein may be operated by a second entity so that the third-party controls the various functions involving the alias data repository 1700. For example, in one embodiment of the invention, although the mobile banking system 1600 is operated by a first entity (e.g., a financial institution), a second entity operates the alias data repository 1700 that stores the alias details for the customer's financial institution accounts and other information about customers.

As described above, the processing device 1720 is configured to use the network communication interface 1710 to gather data from the various data sources. The processing device 1720 stores the data that it receives in the memory device 1750. In this regard, in one embodiment of the invention, the memory device 1750 includes datastores that include, for example: (1) aliases for customer financial institution account numbers and routing information, (2) information about sending and receiving users' mobile device numbers, email addresses, or other contact information, which may have been received from the mobile banking system 1600; (3) a list of customer IDs or authentication data received from the mobile banking system 1600; and/or (4) customer credentials (e.g., a customer ID) received from the customer's mobile device 1400 or received from the mobile banking system 1600 in response to the customer accessing the mobile banking system 1600.

In one embodiment of the invention, an application server is provided to support various supporting systems on the network 1350, including the wireless telephone network 1352. The application server includes a network communication interface, a processing device, and a memory device. The network communication interface and the processing device are similar to the previously described network communication interface 1610 and the processing device 1620 previously described. For example, the processing device is operatively coupled to the network communication interface and the memory device. In one embodiment of the application server, the memory device includes a network browsing application having computer-executable program code that instructs the processing device to operate the network communication interface to perform certain communication functions of the application download server described herein.

As discussed above, in one embodiment of the invention, an application download server might be provided. The application download server may include a network communication interface, a processing device, and a memory device. The network communication interface and processing device are similar to the previously described network communication interface 1610 and the processing device 1620 previously described. For example, the processing device is operatively coupled to the network communication interface and the memory device. In one embodiment of the application download server, the memory device includes a network browsing application having computer-executable program code that instructs the processing device to operate the network communication interface to perform certain communication functions of the application download server described herein. In some embodiments of the invention, the application download server provides applications that are to be downloaded to a qualified customer's mobile device or personal computing device.

### Mobile Banking P2P Payment Send Process and Interface

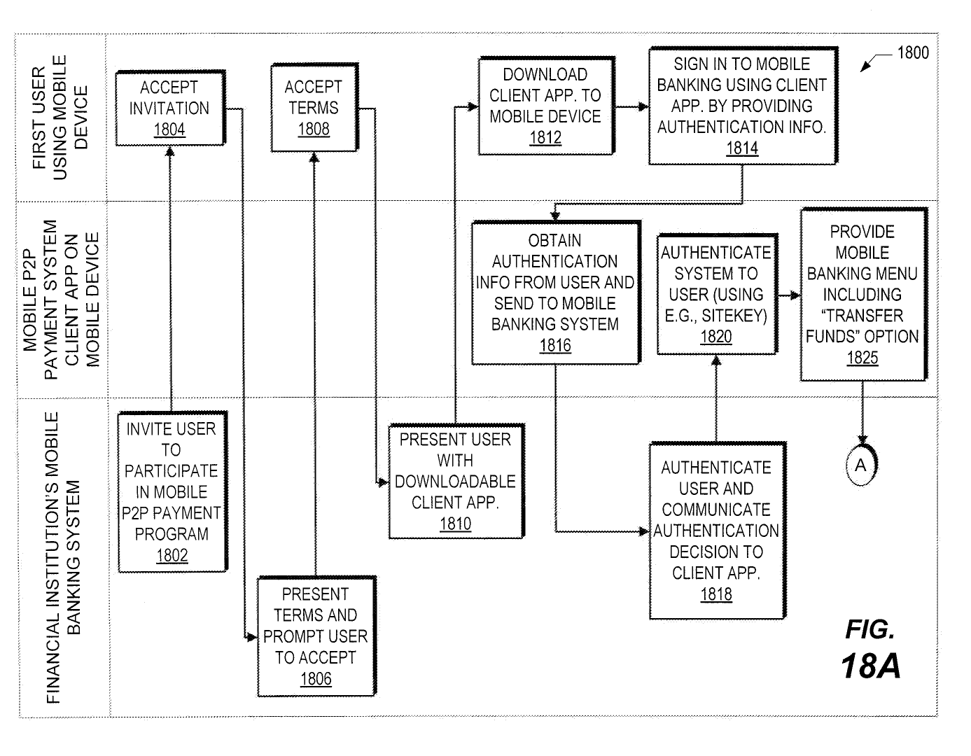

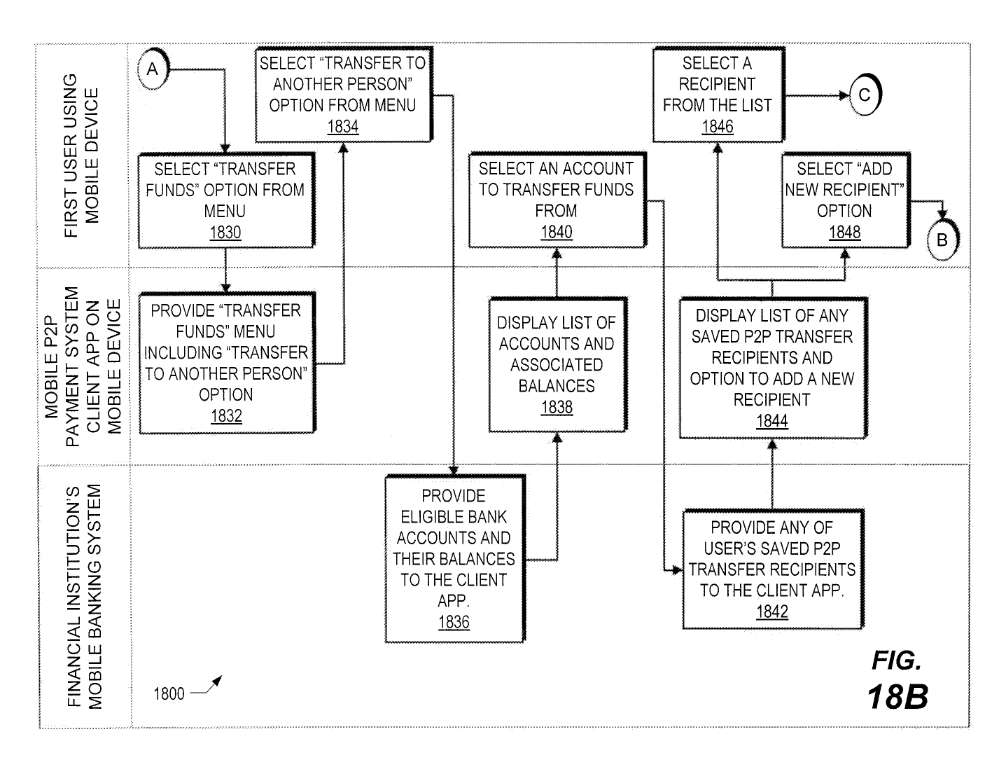

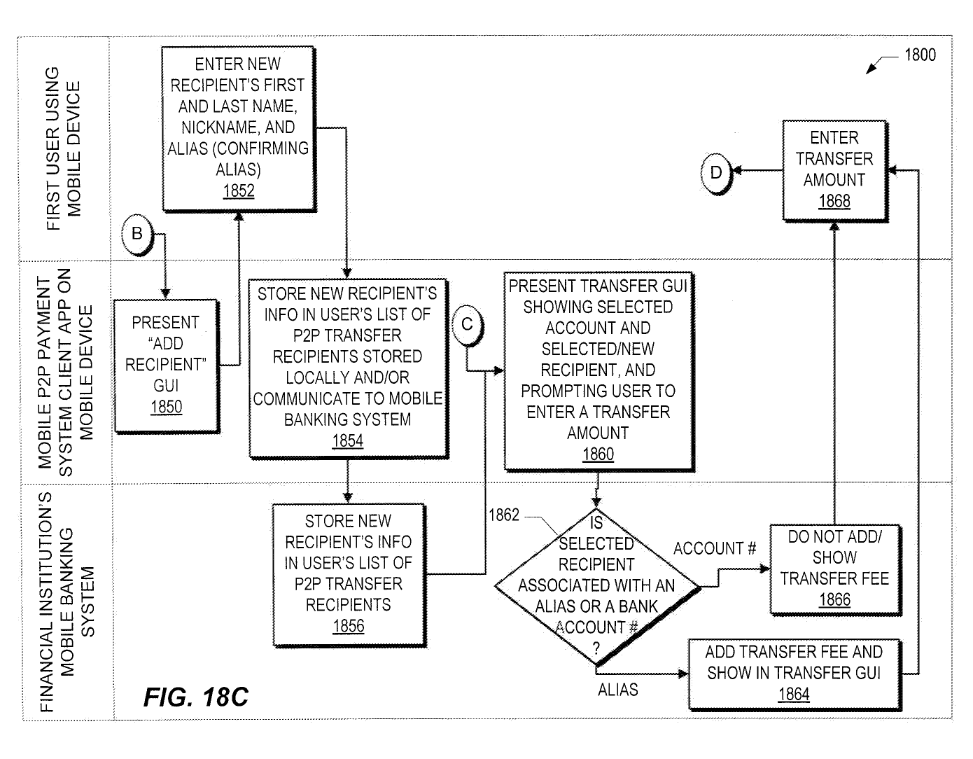

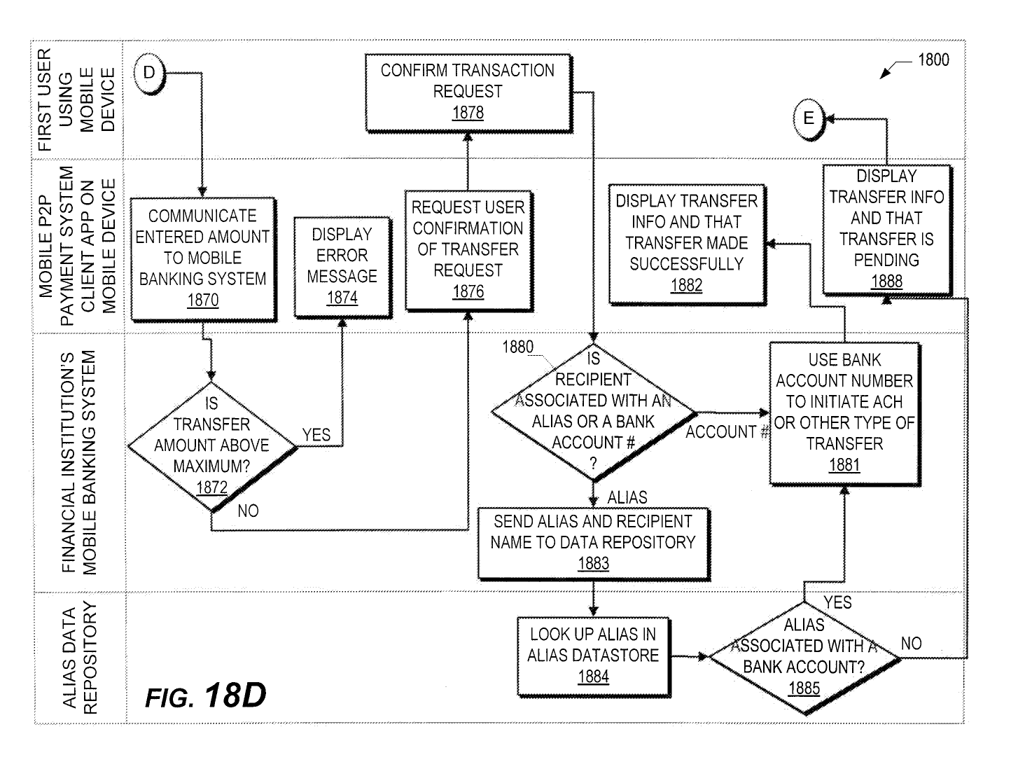

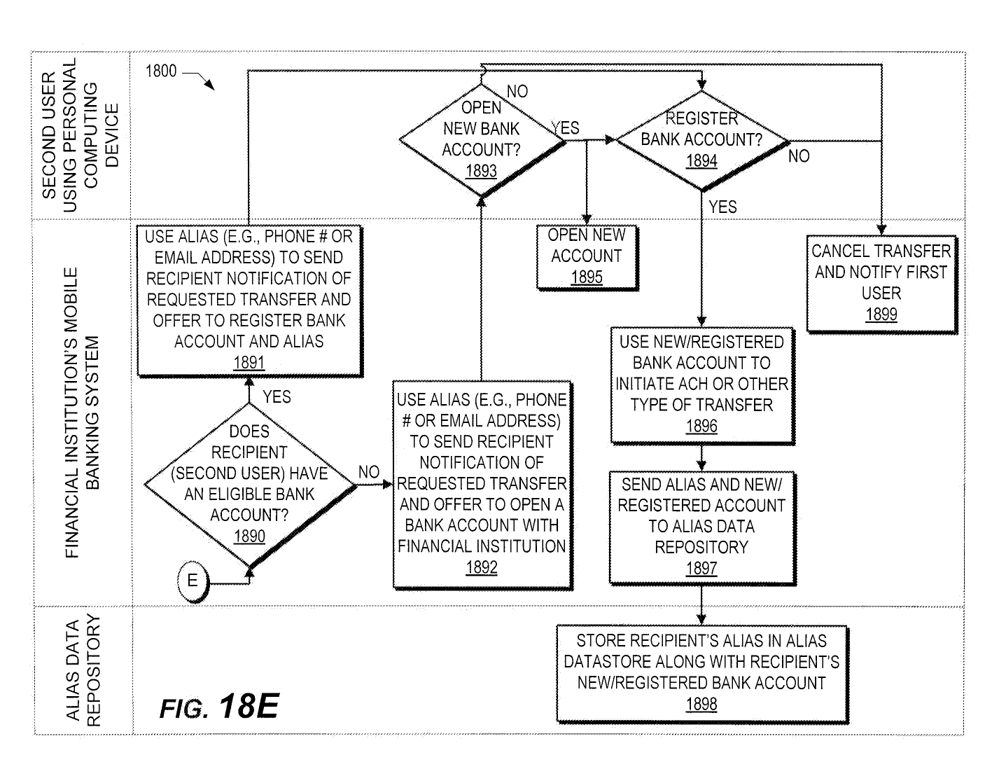

FIGS. 18A-18E provide flow charts illustrating a process 1800 for sending P2P payments via alias using a mobile device, in accordance with an embodiment of the invention. FIGS. 18A-18E illustrate the flow chart in terms of “swim lanes” associated with entities which may perform the operations in each respective swim lane. The entities illustrated in the exemplary Figures are a financial institution's mobile banking system, a first user using a mobile device, an alias data repository, and a second user using a second personal computing device. However, it should be noted that other entities could also be involved and some embodiments of the invention may not be limited to the four entities illustrated in FIGS. 18A-18E. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins at block 1802 of FIG. 18A where a financial institution's mobile banking system 1600 invites a user to participate in a mobile P2P payment program. In one embodiment, the mobile banking system 1600 only invites certain existing mobile banking users who fit certain criteria, including, but not limited to, pre-determined minimum account balance, number of years since the user first opened an account, etc.

The process then moves to block 1804 where the first user 1310 using mobile computing device 1400 accepts the invitation.

The process then moves to block 1806 of FIG. 18A where the mobile banking system 1600 presents to the first user the terms of the mobile P2P transfer feature that will govern the transfer of funds. In one embodiment, the first user can read the terms on the first user's mobile device 1400, whereas in another embodiment, the first user can only read the terms on a personal computing device.

The process then moves to block 1808 of FIG. 18A. The first user accepts the terms of the P2P service by activating an appropriate button on the mobile webpage.

The process then moves to block 1810 of FIG. 18A where the mobile banking system 1600 presents the first user with a downloadable client application.

The process then moves to block 1812 of FIG. 18A where the first user 1310 downloads the client application to the first user's mobile device 1400.

The process then moves to block 1814 of FIG. 18A where the first user 1310 signs in to the mobile banking system 1600 using the client application by providing appropriate authentication information.

The process then moves to block 1816 of FIG. 18A where the mobile P2P payment system client application 1694 on the mobile device 1400 obtains authentication information from the first user and sends the authentication information to the mobile banking system 1600.

The process then moves to block 1818 of FIG. 18A where the mobile banking system 1600 authenticates the first user 1310 and communicates the authentication decision to the mobile P2P payment system client application 1694.

The process then moves to block 1820 of FIG. 18A where the mobile P2P payment system client application 1694 authenticates the system to the first user 1310. In one embodiment of the invention, the authentication is achieved using “SiteKey™,” which is a web-based security system that provides mutual authentication between end-users and websites. In a challenge-response process of SiteKey™, the first user has to identify himself or herself on a secure website by entering a username. Subsequently, the website authenticates itself to the first user by displaying an image and an accompanying phrase that the first user had previously configured. If the user recognizes this image and the accompanying phrase, the first user can authenticate himself or herself to the website by entering a password. Other embodiments of the invention may use other authentication systems.

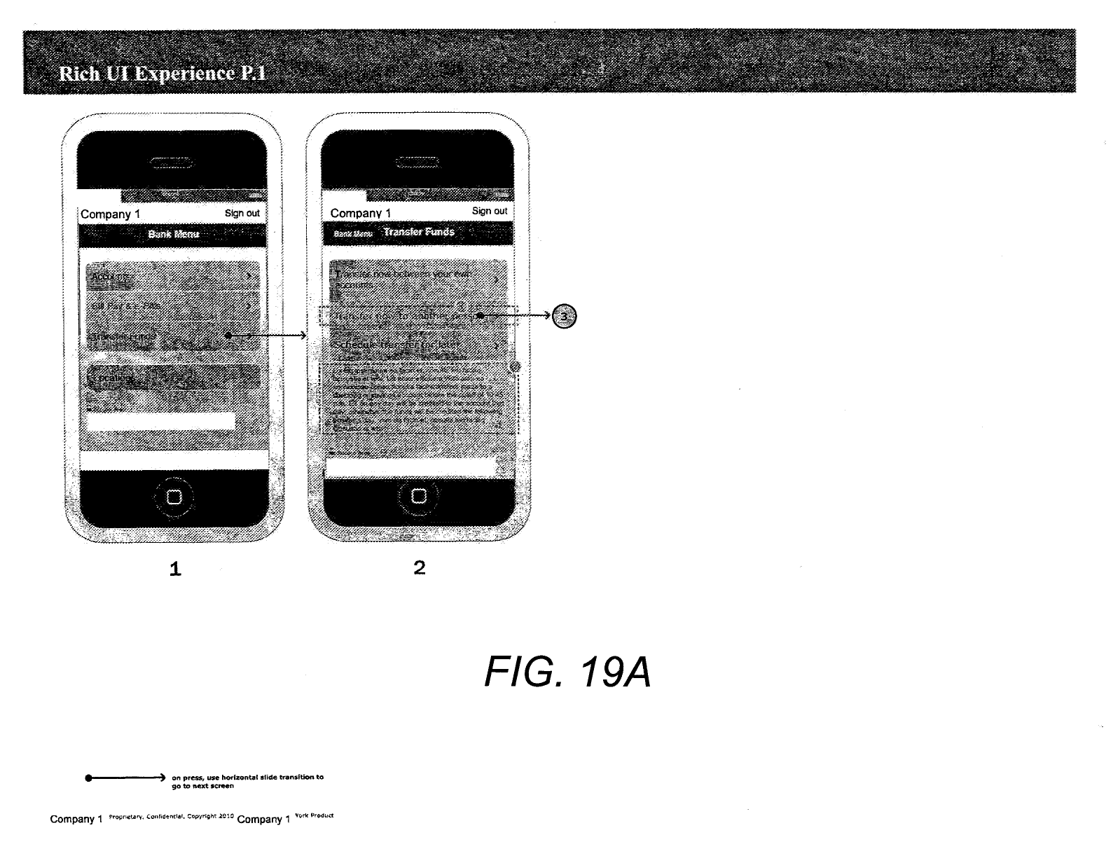

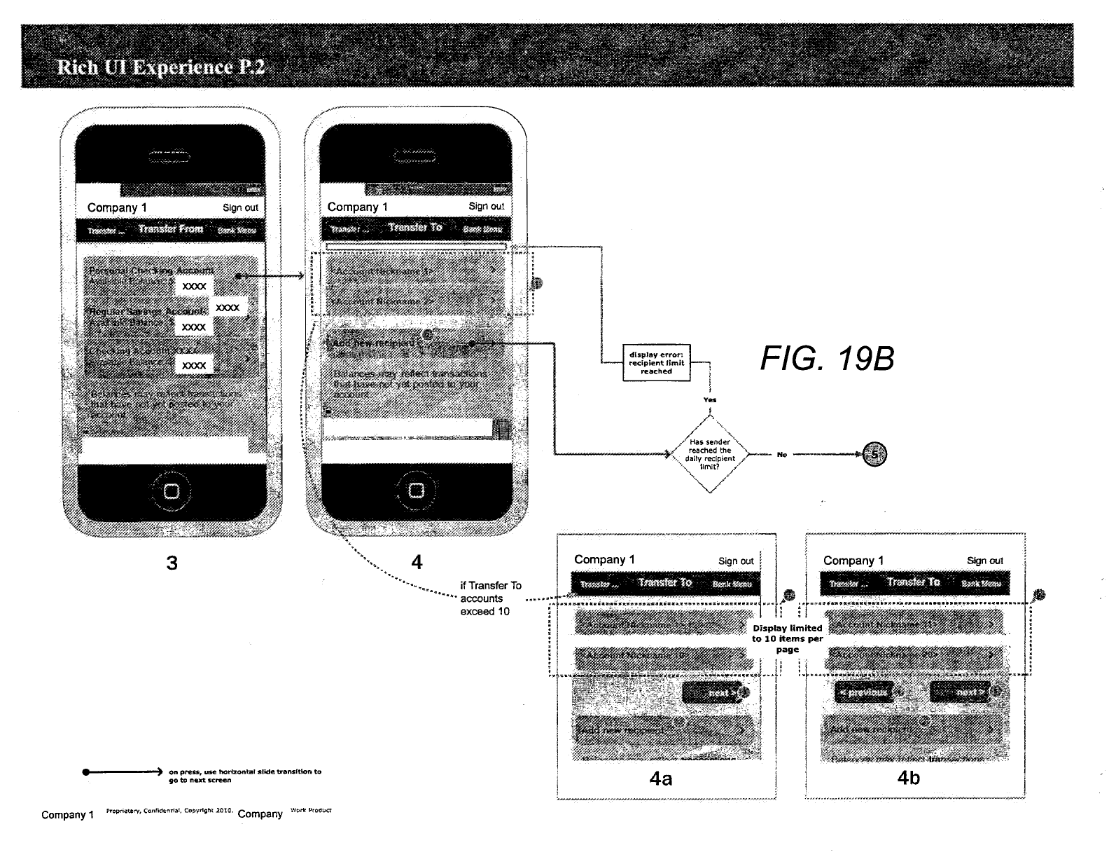

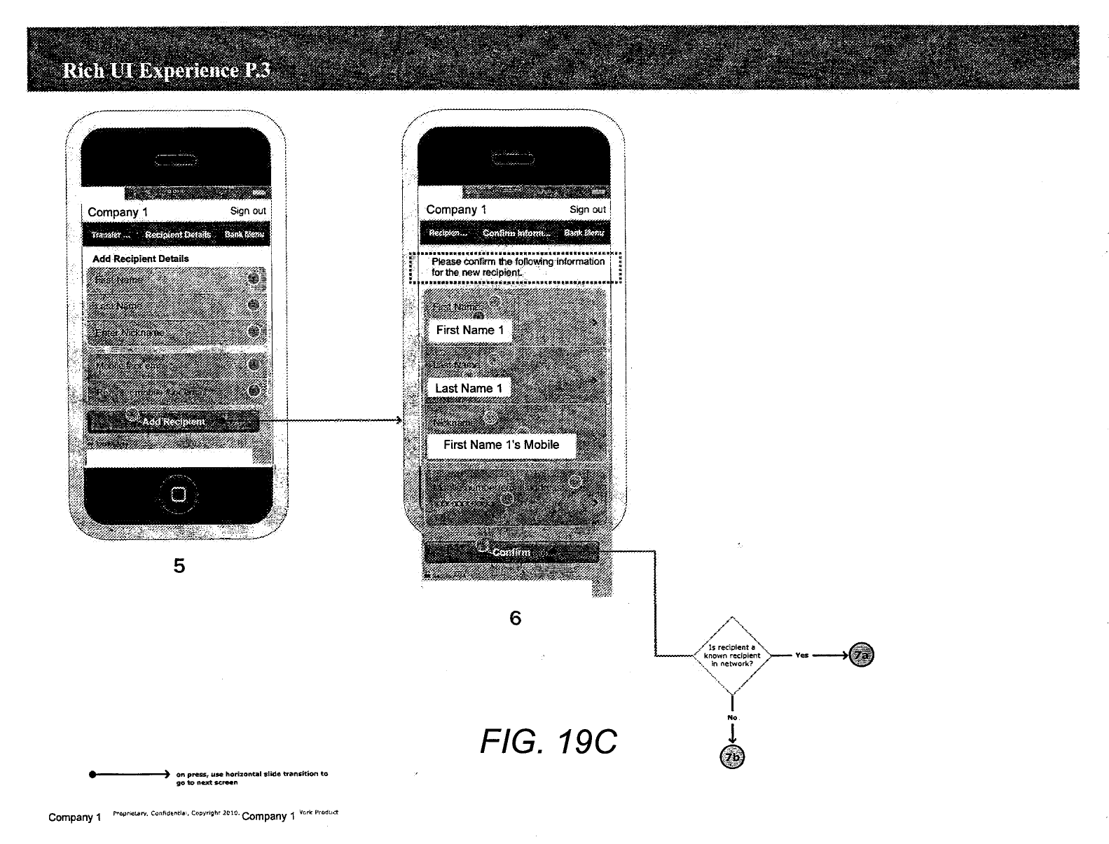

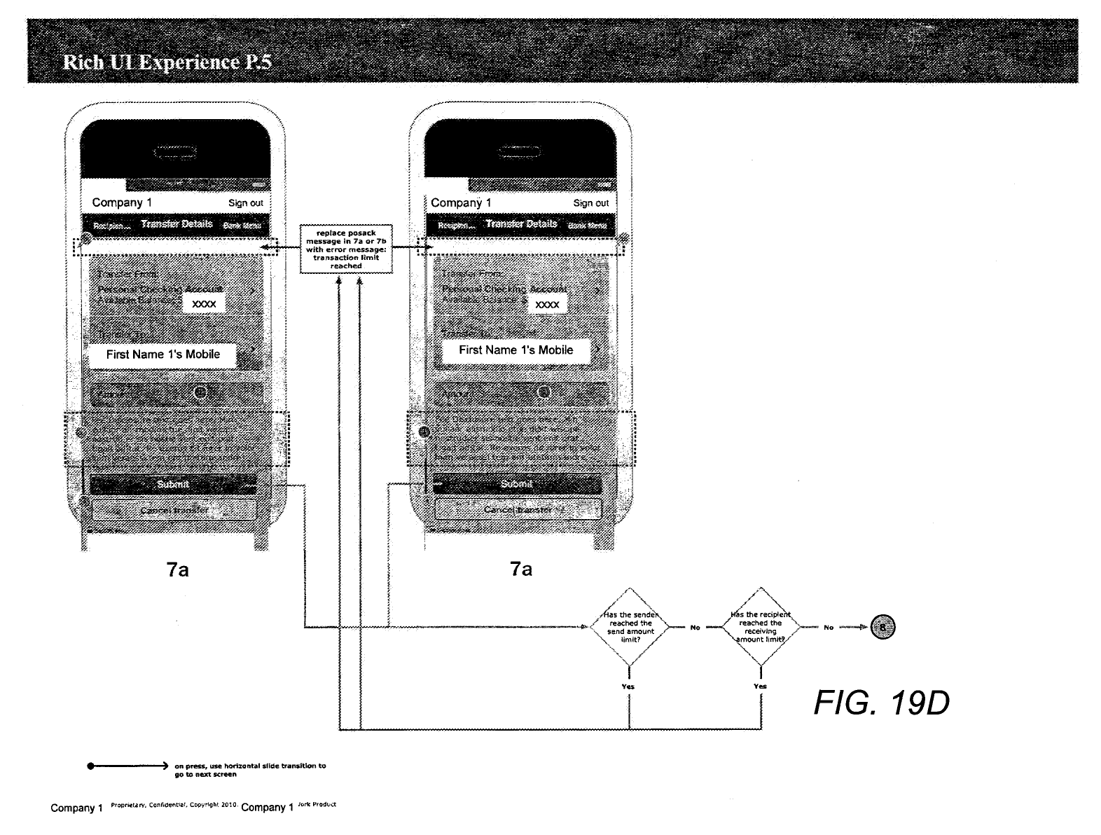

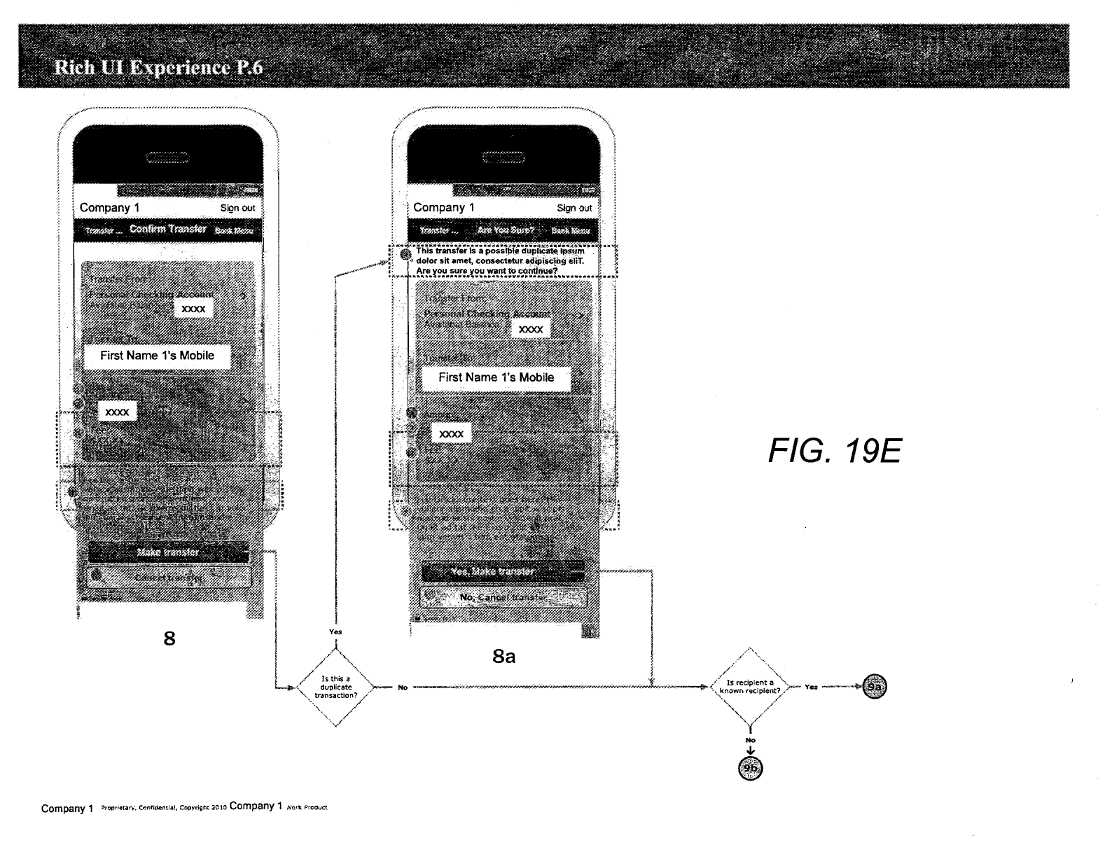

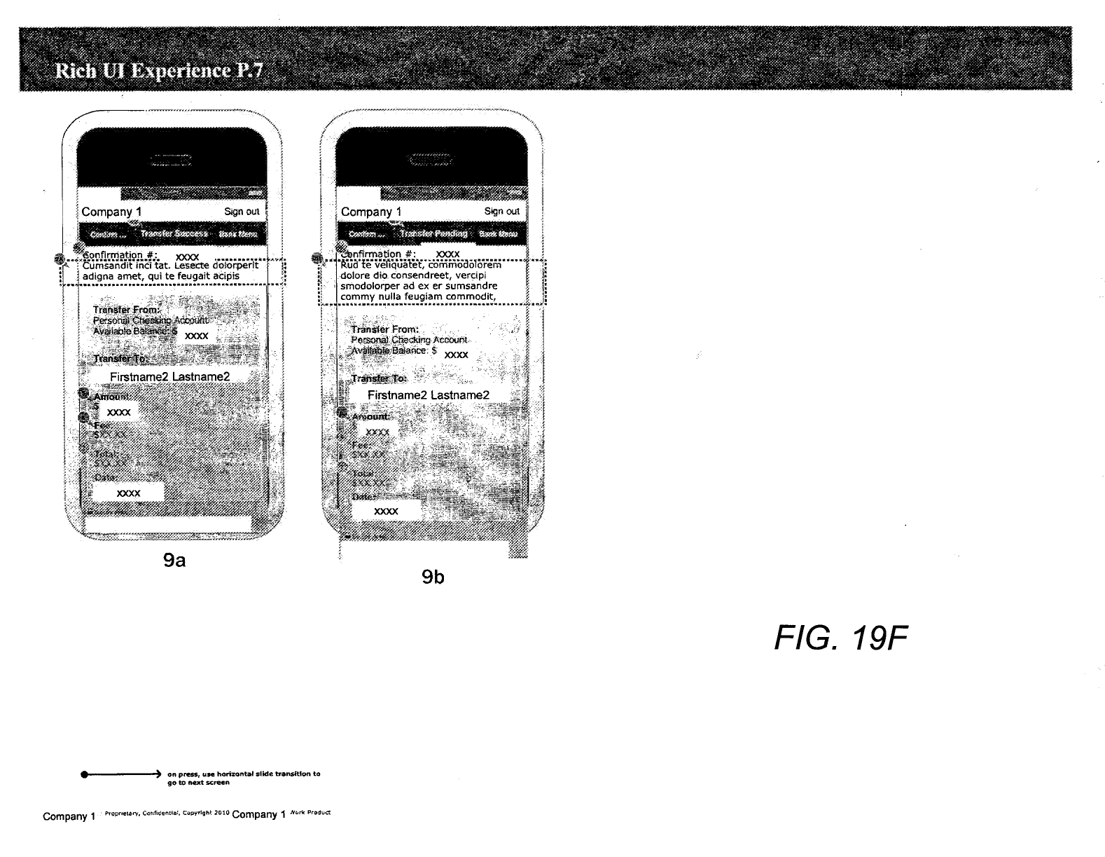

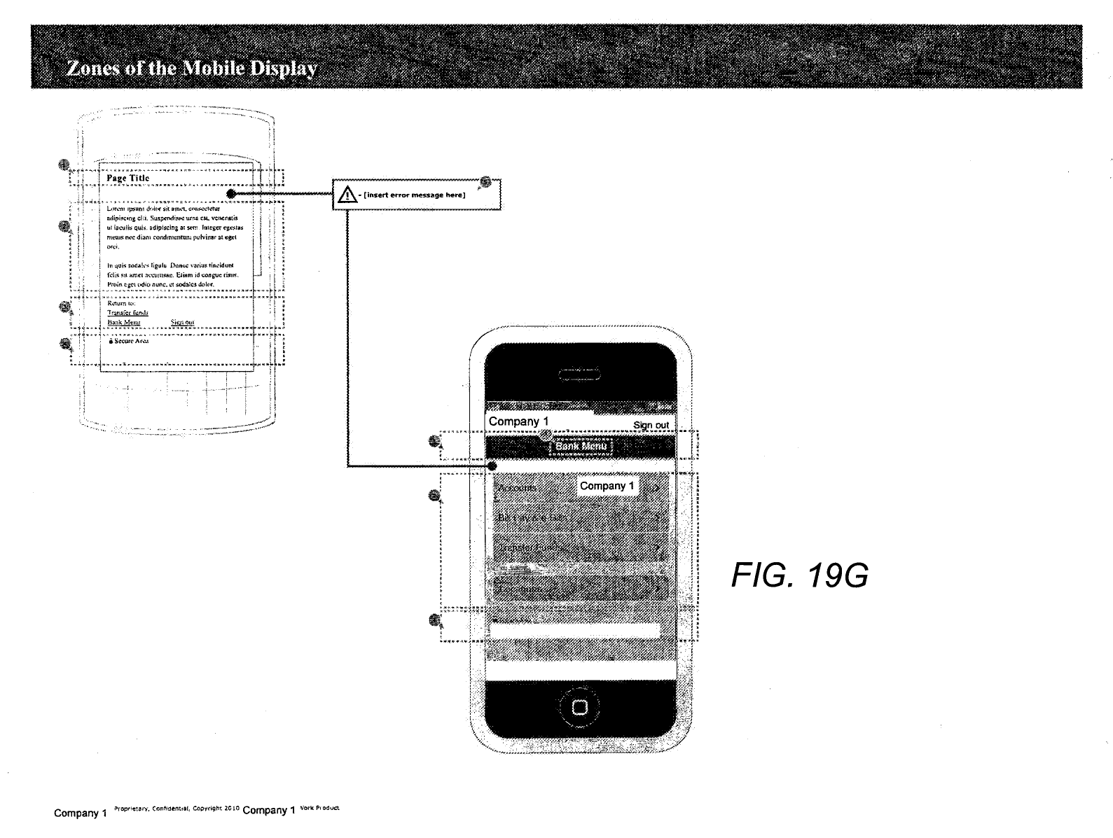

The process then moves to block 1825 of FIG. 18A where the mobile P2P payment system client application 1694 provides a mobile banking menu including an option to transfer funds. A screenshot is illustrated in FIG. 19A(1). As shown in FIG. 19A(1), the mobile P2P payment system client application 1694 displays a bank menu page on which the first user can navigate to an accounts function, a bill-paying function, a transfer funds function, or a location function. Further, the mobile P2P payment system client application 1694 indicates to the first user that the first user is in a secure area of the mobile banking system 1600. The bank menu page also has a text area where error messages are displayed. The mobile P2P payment system client application 1694 always allows users to sign out from their accounts on any mobile webpage by providing an appropriate hyperlink or button.

The process then moves to block 1830 of FIG. 18B where the first user 1310 selects the transfer funds option from the menu displayed in FIG. 19A(1).

The process then moves to block 1832 of FIG. 18B where the mobile P2P payment system client application 1694 provides a transfer funds menu that includes an option to transfer to another person. This can be seen in FIG. 19A(2), where based on the user activating the transfer funds function on the screenshot of FIG. 19A(1), the mobile P2P payment system client application 1694 displays three options for the first user including an option to transfer between the first user's own accounts, an option to transfer to another person, and an option to schedule a transfer for later execution. In one embodiment, each of these three options are hyperlinks that are linked to mobile payment system 1600. The mobile P2P payment system client application 1694 indicates to the first user using a static textbox that any transfers made to an account before a cutoff time on any day will be credited to that account; otherwise the transfer will credited on the following business day.

The process then moves to block 1834 of FIG. 18B where the first user 1310 selects the option to transfer to another person from the transfer funds menu.

The process then moves to block 1836 of FIG. 18B where the mobile banking system 1600 provides eligible financial institution accounts and their balances to the mobile P2P payment system client application 1694.

The process then moves to block 1838 of FIG. 18B where the mobile P2P payment system client application 1694 displays a list of eligible financial institution accounts that can participate in the mobile P2P transfer as well as their associated balances. A relevant screenshot is shown in FIG. 19B(3) where the mobile P2P payment system client application 1694 displays the eligible accounts and their balances. The mobile P2P payment system client application 1694 also indicates to the first user that the balances may reflect transactions that have not yet been posted to the first user's account. In the illustrated example of FIG. 19B(3), a personal checking account, a regular savings account and a another checking account and their respective balances are depicted.

The process then moves to block 1840 of FIG. 18B where the first user 1310 can select an account to transfer funds from.

The process then moves to block 1842 of FIG. 18B where the mobile banking system 1600 provides any of first user's saved P2P transfer recipients to the mobile P2P payment system client application 1694.

The process then moves to block 1844 of FIG. 18B where the mobile P2P payment system client application 1694 displays a list of any saved P2P transfer-to accounts or recipients and an option to add a new recipient. A screenshot of this list is shown in FIG. 19B(4) where any saved P2P transfer recipients are visible in the region displayed as “Account Nickname 1” and “Account Nickname 2.” Activating any particular transfer-to account that is in the name of or otherwise associated with the first user will take the first user to an account details page for that particular account. Activating any particular transfer-to account not in the name of or associated with by the first user (i.e., another user's account) will not take the first user to an account details page for that particular account. In one embodiment, the first user cannot see the balance of a transfer-to account not in the name of or associated with the first user. FIG. 19B(4) also displays a hyperlink to add a new transfer recipient. This link is only available if the first user has agreed to the terms and conditions page on the first user's mobile banking account. In one embodiment, the mobile P2P payment system client application 1694 can only display a first pre-determined number of transfer-to accounts or recipients per page. Therefore as shown in FIG. 19B(4a), if the number of transfer-to accounts are greater than a first pre-determined number, then a first user has to activate the next button to choose other recipients if the user wants to choose a recipient who is not in the initial pre-determined displayed list of recipients. If the number of transfer-to accounts or recipients are greater than a second higher pre-determined number, then as shown in FIG. 19B(4b), the mobile P2P payment system client application 1694 provides the first user with the next button and the previous button to navigate between groups of recipients. If the number of transfer-to accounts or recipients is greater than a first pre-determined number but smaller than a second higher pre-determined number, then the mobile P2P payment system client application 1694 provides the first user with a previous button but not a next button. In one embodiment of the invention, the first pre-determined number is 10 and the second higher pre-determined number is 20.

The process then moves to block 1846 of FIG. 18B where the first user 1310 can select a recipient from the list to participate in the P2P transfer by activating the link associated with a particular recipient. If the user selects an existing recipient, then the mobile P2P payment system client application 1694 presents to the user the transfer GUI of block 1860 (FIG. 18C) that is described later. Alternatively, the process can move to block 1848 of FIG. 18B where the first user adds a new recipient by activating the link to add a new recipient. In one embodiment, in which the user is limited to adding a predetermined number of new recipients in a daily period, if the first user has reached the pre-determined daily recipient limit, the mobile P2P payment system client application 1694 displays an error message on an area of the mobile webpage displayed in FIG. 19B(4).

The process then moves to block 1850 of FIG. 18C where the mobile P2P payment system client application 1694 presents to the first user a GUI to add a new recipient. A screenshot of this GUI is shown in FIG. 19C. As shown in FIG. 19C(5), the mobile P2P payment system client application 1694 presents an input field to enter the recipient's first name, an input field to enter the recipient's last name, an input field to enter a nickname associated with the recipient as chosen by the first user, a first input field to enter an alias, and a second input field to re-enter the alias which is checked against the alias entered into the first input field to verify that both aliases match. In one embodiment, the alias can be, but is not limited to, a mobile device number or an email address. The GUI also presents the user with a button to add the new recipient. The process then moves to block 1852 of FIG. 18C where the first user enters the new recipient's first name, last name, nickname, and alias, along with re-entering the alias and activating the button the add the recipient. As shown in FIG. 19C(6), a pre-confirmation page is now displayed where the mobile P2P payment system client application 1694 asks the first user to confirm the details of the recipient by activating the confirm button. In one embodiment, the complete set of characters comprising the alias are not displayed on the pre-confirmation page. By activating any of the entries entered by the first user, the first user can be taken back to the mobile webpage for adding recipient details. For instance, if the first user activates the first name that is displayed on the pre-confirmation page, a hyperlink embedded into the text allows the first user to return to the pre-confirmation page FIG. 19C(5) for editing the first name.

Once the first user activates the confirm button, the process moves to block 1854 of FIG. 18C where the mobile P2P payment system client application 1694 locally stores the new recipient's information in the first user's list of P2P transfer recipients and/or communicated to the mobile banking system 1600.

The process then moves to block 1856 of FIG. 18C where the mobile banking system 1600 stores the new recipient's information in the first user's list of P2P transfer recipients.

The process then moves to block 1860 of FIG. 18C where the mobile P2P payment system client application 1694 presents a transfer GUI showing selected account and selected/new recipient, and prompting the first user to enter a transfer amount. This is shown in FIG. 19D where the screenshot shows that on a transfer details page, the mobile P2P payment system client application 1694 displays the transfer-from account, the transfer-to account or recipient alias, and an input text box for entering the amount that the first user 1310 wishes to transfer. As shown in FIG. 19D, the GUI also presents disclosure text regarding any possible fees that will be incurred by the first user for making this transfer. The GUI also displays a submit button for submitting the transfer and a cancel button for canceling the transfer and returning to the menu page shown in FIG. 19A.

The process then moves to block 1862 of FIG. 18C where the mobile banking system 1600 determines if the selected recipient is associated with an alias or a financial institution account number.

If, in block 1862 of FIG. 18C, the mobile banking system 1600 determines that the selected recipient is associated with an alias, then the process moves to block 1864 where the mobile banking system 1600 adds the transfer fee and shows this transfer fee in a GUI. If, in block 1862 of FIG. 18C, the mobile banking system 1600 determines that the selected recipient is not associated with an alias, then the process moves to block 1866 where the mobile banking system 1600 does not show or add a transfer fee. As stated above and as shown in FIG. 19D, the mobile P2P payment system client application 1694 displays any possible transfer fee disclosure (along with the transfer fee in some embodiments) in a text box. In one embodiment, this fee disclosure text box is placed under the text input field where the first user enters the amount to be transferred.

The process then moves to block 1868 of FIG. 18C where the first user enters a transfer amount in the appropriate text input field as shown in FIG. 19D.

The process then moves to block 1870 of FIG. 18D where the mobile P2P payment system client application 1694 communicates the amount to be transferred to the mobile banking system 1600.

The process then moves to block 1872 of FIG. 18D where the mobile banking system 1600 determines if the transfer amount is above a maximum limit placed on the transfer. In one embodiment, there is a pre-determined amount limit placed on the first user (sender). In another embodiment, there is a pre-determined amount limit placed on the recipient. In still another embodiment, both these pre-determined amount limits place a ceiling on the amount that can be transferred via a mobile P2P transfer. There may be several factors that affect this limit including, but not limited to, the first user's identity, the recipient's identity, the length and nature of the first user's relationship with the financial institution, the length and nature of the recipient's relationship with the financial institution, the amount of funds that the first user has deposited at the financial institution, the first user's status with the financial institution, etc. In one embodiment, the maximum amount that can be transferred using the mobile P2P transfer method is dynamically determined, at the time of the transfer request, by a supporting application that works in conjunction with or is embedded within the mobile P2P payment system client application 1694.

If in block 1872 of FIG. 18D the transfer amount is above the maximum allowable limit, then the mobile P2P payment system client application 1694 displays an error message to the first user.

If in block 1872 of FIG. 18D the transfer amount is below or equal to the maximum allowable limit, the mobile P2P payment system client application 1694 requests user confirmation of the transfer request. A GUI that captures a screenshot of this pre-confirmation page is displayed in FIG. 19E(8). Here, the mobile P2P payment system client application 1694 displays the transfer-from account, the transfer-to account or recipient alias, the amount to be transferred, and the fee to be incurred by the first user for making this transfer. The GUI also displays fee disclosure text on the page. In some embodiments, there is no fee incurred by the first user for making the transfer. As shown in FIG. 19E(8), the GUI also displays two buttons or hyperlinks, one for making the transfer and one for canceling the transfer and returning to the bank menu page shown in FIG. 19A.

The process then moves to block 1878 of FIG. 18D where the first user confirms the transaction request by activating the button or hyperlink for making the transfer. If the mobile banking system 1600 recognizes that this transaction is a duplicate of another transaction executed within a pre-determined amount of time in the past, then, as shown in FIG. 19E(8a), the mobile P2P payment system client application 1694 displays another pre-confirmation page informing the first user that the transfer is a possible duplicate of a recently executed transaction. As shown in FIG. 19E(8a), the GUI also displays two buttons or hyperlinks, one for making the transfer and one for canceling the transfer and returning to the bank menu page shown in FIG. 19A.

The process then moves to block 1880 of FIG. 18D where the mobile banking system 1600 determines whether the recipient is associated with an alias or a financial institution account number. If the recipient is associated with a financial institution account number, the process moves to block 1881 where the mobile banking system 1600 uses the financial institution account number to initiate an Automated Clearing House (ACH) transfer or other type of transfer. Subsequently, the process moves to block 1882 of FIG. 18D where the mobile P2P payment system client application 1600 provides notification to the first user that a transfer or a notice of transfer request to the recipient (second user) has been initiated and displays the information regarding the transfer to the first user. An instance of this notification is shown in FIG. 19G. FIG. 19G shows a confirmation page that displays the transfer-from account, the transfer-to account or recipient alias, the amount transferred, the fee incurred by the first user for making this transfer, the total cost of the transfer, and the date on which the transfer was executed. The confirmation page also displays a confirmation number associated with the transfer.

If, in block 1880, the recipient is associated with an alias then, the process moves to block 1883 where the mobile banking system 1600 sends the alias and the recipient's name to an alias data repository 1700.

The process then moves to block 1884 where the alias data repository 1700 looks up the alias in an alias datastore. Then the process moves to block 1885, where the alias data repository 1700 determines whether the alias is associated with a financial institution account. If the alias is associated with a financial institution account, then, if the alias data repository 1700 determines that the provided name matches the name in the datastore, then the process moves to block 1881 of FIG. 18D where the mobile banking system 1600 uses the financial institution account number to initiate the ACH transfer or other type of transfer. Subsequently, the process moves to block 1882 of FIG. 18D where the mobile P2P payment system client application 1694 provides notification to the first user that a transfer or a notice of transfer request to the recipient (second user) has been initiated and displays the information regarding the transfer to the first user. An instance of this notification is shown in FIG. 19F. FIG. 19F shows a confirmation page that displays the transfer-from account, the transfer-to account or recipient alias, the amount transferred, the fee incurred by the first user for making this transfer, the total cost of the transfer, and the date on which the transfer was executed. The confirmation page also displays a confirmation number associated with the transfer. The confirmation page also displays whether the transfer has been successful FIG. 19F(9a) or whether it is still pending FIG. 19F(9b).

If in block 1885 of FIG. 18D, the alias data repository 1700 determines that the alias is not associated with a financial institution account, then the process moves to block 1888 where the mobile P2P payment system client application 1694 displays information about the transfer to the first user and indicates that the transfer is pending.

The process then moves to block 1890 of FIG. 18E where the mobile banking system determines whether if the recipient (second user) has an eligible financial institution account. If the recipient (second user) does not have an eligible financial institution account, then in block 1892, the mobile banking system 1600 uses an alias to send the recipient notification of requested transfer from the first user and an offer to open a financial institution account with the financial institution that manages the mobile banking system 1600. In one embodiment, the alias is a phone number or an email address.

The process then moves on from block 1892 to block 1893 of FIG. 18E, where if the second user decides to not open a financial institution account at the financial institution that manages the mobile banking system 1600, then the mobile banking system 1600 cancels the transfer and notifies the first user in block 1899.

If in block 1893 of FIG. 18D, the second user (recipient) decides to open a new financial institution account, the mobile banking system 1600, in block 1895, opens a new account for the second user. Subsequently, the second user (recipient) must determine in block 1894 whether the second user registers the new financial institution account for the mobile P2P service.

As shown in FIG. 18E, if the second user in block 1894 does not register the new financial institution account opened in block 1895, then the mobile banking system 1600 cancels the transfer and notifies the first user in block 1899.

As shown in FIG. 18E, if the second user registers the new financial institution account in block 1894 for mobile P2P transfers, then the mobile banking system 1600, in block 1896, uses the new registered financial institution account to initiate an ACH transfer or other type of transfer. The process then moves to block 1897 where the mobile banking system 1600 sends the alias and the new registered account information to the alias data repository 1700. The process then moves to block 1898 of FIG. 18E where the alias data repository 1700 stores recipient's alias in alias datastore along with recipient's (second user's) new registered financial institution account.

If the recipient (second user) has an eligible financial institution account as determined by the mobile banking system 1600 in block 1890, then the process moves to block 1891 in FIG. 18E where the mobile banking system 1600 uses an alias (e.g., phone number or email address) to send recipient (second user) notification of requested transfer, and offers to register the recipient's financial institution account and alias. As shown in FIG. 18E, then the process moves to block 1894 where if the second user (recipient) decides not to register the second user's financial institution account for mobile P2P transfers, then the mobile banking system 1600 cancels the transfer and notifies the first user.

As shown in FIG. 18E, if the second user (recipient) registers the eligible financial institution account in block 1894, then the mobile banking system 1600 uses the eligible registered financial institution account to initiate an ACH transfer or other type of transfer in block 1896. The process then proceeds to block 1897 where the mobile banking system 1600 sends alias and the eligible registered account information to the alias data repository 1700. The process then moves to block 1898 of FIG. 18E where the alias data repository 1700 stores recipient's alias in alias datastore along with recipient's eligible registered financial institution account.

### Mobile Banking Alias Registration and P2P Payment Receive Process and Interface

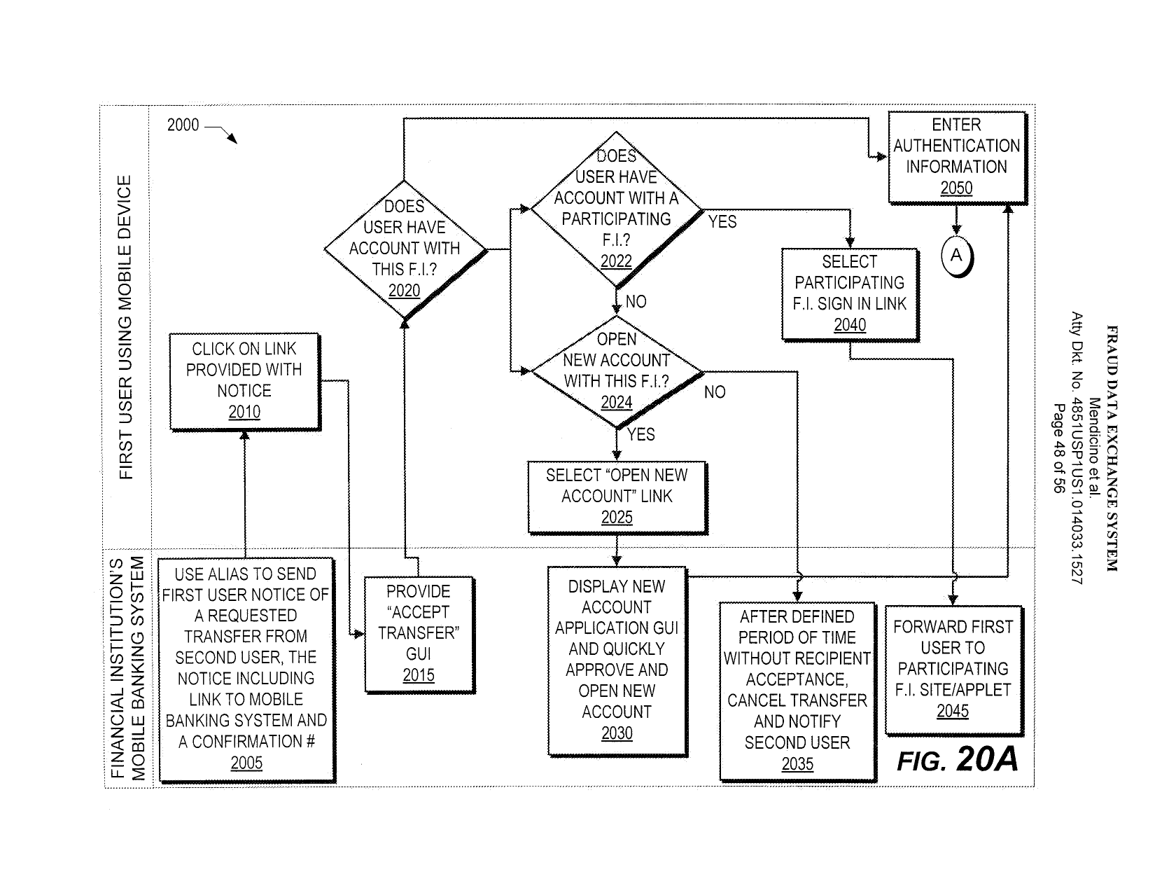

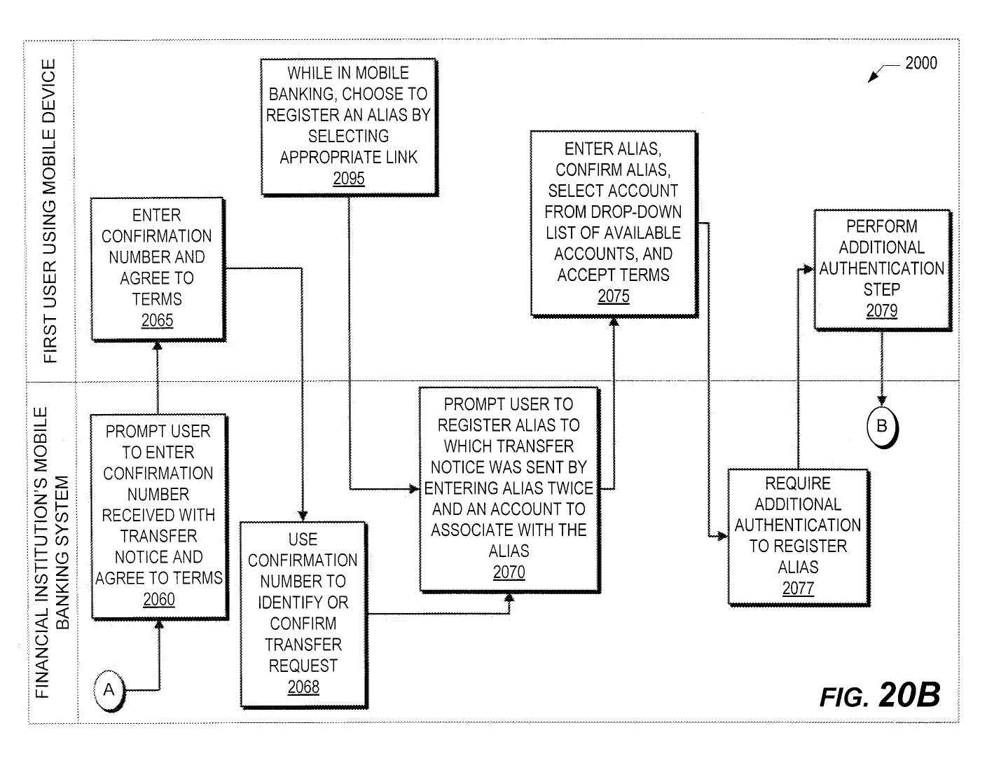

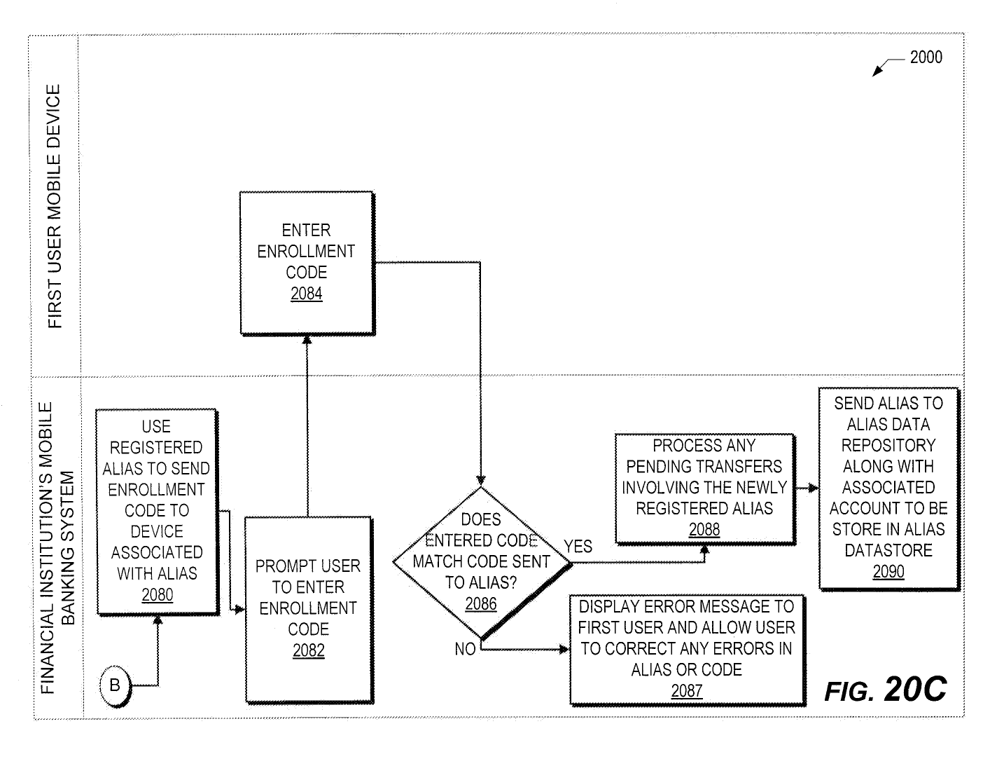

FIGS. 20A-20C provide flow charts illustrating a process 2000 for receiving P2P payments, in accordance with an embodiment of the invention. FIGS. 20A-20C illustrate the flow chart in terms of “swim lanes” associated with entities which may perform the operations in each respective swim lane. The entities illustrated in the exemplary Figures are a financial institution's mobile banking system 1600 and a first user (recipient) using a first personal computing or mobile device. However, it should be noted that other entities could also be involved and some embodiments of the invention may not be limited to the two entities illustrated in FIGS. 20A-20C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process 2000 in FIG. 20A starts with block 2005 where a mobile banking system 1600 sends a first user (recipient) notice of a requested transfer from a second user, the notice including a link to the mobile banking system 1600 and a confirmation number.

The process then proceeds to block 2010 where a first user (recipient) activates the link provided with the notice.

The mobile banking system 1600 alerts the first user (recipient) that to accept the transfer, the first user will need an eligible checking or saving account at a participating financial institution. For customers who hold accounts at the financial institution that manages the mobile banking system 1600, the mobile banking system 1600 presents a widget with a textbox that allows the first user to enter login or other authenticating information. The mobile banking system 1600 also provides a link for the first user to enroll with the financial institution's mobile banking system. For customers of other participating financial institutions, the mobile banking system 1600 provides a sign-in button, which might either display a sign-in widget on the instant page or might provide for a link to another page where the first user can enter login information for the participating financial institution. The mobile banking system 1600 also notifies the first user that if the first user does not have an account with one of the participating banks, that first user can open an account at the financial institution that maintains the mobile banking system 1600. The mobile banking system 1600 notifies the first user that he or she may review the terms of opening a new account at this financial institution, including any fees that may be incurred by the first user in opening this new account. The mobile banking system 1600 also notifies the first user that if the first user does not want to open a new financial institution account, the first user may notify the sender to arrange an alternate transfer method. The mobile banking system 1600 also notifies the first user that the transaction will be canceled if it is not accepted within a pre-determined period of time.

The process then proceeds to block 2020 of FIG. 20A where the first user (recipient) determines whether the first user has an account with the financial institution that manages the mobile banking system 1600. If the first user has a financial institution account with the financial institution that manages the mobile banking system 1600, then the process moves to block 2050 where the first user enters authentication information into the appropriate textbox.

As shown in FIG. 20A, if the first user does not have a financial institution account with the financial institution that manages the mobile banking system 1600 then the process proceeds to block 2022 where the first user determines whether the first user has an account with participating financial banks or financial institutions. If the first user has a financial institution account with a participating financial institution, the process proceeds to block 2040 where the first user can select the participating financial institution sign-in link. The process then moves to block 2045 where the mobile banking system 1600 forwards the first user to a participating financial institution's website or alternatively, the mobile banking system 1600 opens a widget or an applet on the same window or new pop-up window.

As shown in FIG. 20A, if, in block 2020, the first user does not have an account the financial institution that manages the mobile banking system 1600 and if, in block 2024, the first user (recipient) does not open a new account with the financial institution that manages the mobile banking system 1600, then, as shown in block 2035, after a defined period of time without recipient (first user) acceptance, the mobile banking system 1600 cancels the transfer and notifies the second user (sender).

As shown in FIG. 20A if, in block 2024, the first user opens a new account with the financial institution that manages the mobile banking system 1600, then the first user, in block 1025, selects the link directing the first user to open a new account with the financial institution that manages the mobile banking system 1600.

As shown in FIG. 20A, the link in block 2025 directs the mobile banking system 1600 to display a new account application GUI to the first user (see block 2030), which new account application quickly approves and opens a new account for the first user after receiving any pertinent information that may be required to open and be approved for a new account at the financial institution that manages the mobile banking system 1600. The process then proceeds to block 2050 in FIG. 20A where the first user enters authentication information into a textbox.

The process then moves to block 2060 in FIG. 20B where the mobile banking system 1600 prompts the first user to enter a confirmation number received with the transfer notice and agree to the terms governing the transfer. The mobile banking system 1600 indicates to the first user that this is the start of the procedure to accept a transfer to money to the first user's email address or mobile number. The mobile banking system 1600 prompts the first user to enter the received confirmation number in a textbox. The webpage also has two buttons—a first button configured to allow the first user to indicate a desire not to proceed with accepting the transfer and a second button configured to allow the first user to indicate a desire to proceed with the transfer. The second button can move from a dormant state to an activatable state by checking the check-box to confirm that the first user has a) has read and agrees to the terms of the service agreement, including the terms of the Email/Mobile Network Transfer section; b) consents to receive email and automated text messages about Email/Mobile Transfers; c) will only register mobile numbers where the first user is the account holder; or if the first user is not the account holder, he or she has the account holder's permission to register that mobile number; and d) will obtain the consent of the person to whom he or she wants to send a Mobile Transfer text message to receive the automated text message. In one embodiment, the first user has to always go through the procedure of accepting the transfer. In other embodiments, the first user does not have to go through the procedure accepting the transfer for any transfer after the first transfer.

Subsequently, in block 2065, the first user enters a confirmation number in the appropriate textbox and agrees to the terms that govern the transaction by activating the appropriate checkbox. The first user then activates on the second button to continue the process of accepting the transfer.

The process then moves to block 2068 of FIG. 20B where the mobile banking system 1600 uses the confirmation number entered in block 2065 to identify or confirm the transfer request.

Then the process proceeds to block 2070 of FIG. 20B where the mobile banking system 1600 prompts the user to register the alias to which the transfer notice was sent. The mobile banking system 1600 indicates to the first user that if the first user has received a notice that money was sent to the first user, then the first user will need to set up to accept transfers the same email address or mobile number that received the transfer notice. The page shows a first textbox where the user can enter the alias that received the transfer notice, and a second textbox where the user can confirm the alias entered in the first textbox by re-entering the alias in the second textbox. The mobile banking system 1600 also prompts the user to select the appropriate account to link to the alias that will receive the funds by selecting the appropriate account from a drop down list. The mobile banking system 1600 also prompts the user to check a checkbox, whereby the first user by checking the checkbox agrees that by registering the alias, he or she is the alias account holder, or has the alias account holder's permission to register it, and consents to receive email and text messages about alias transfers at this email address or phone number. In some embodiments, the mobile banking system 1600 presents an authentication widget that will be described in further detail below. The page also has two buttons—a first button configured to allow the first user to indicate a desire not to proceed with receiving the transfer and a second button configured to allow the first user to indicate a desire to proceed with receiving the transfer. This second button moves from a dormant state to an activatable state after the first user enters all the required information on the page and has been further authenticated, as in some embodiments. In one embodiment, the mobile banking system 1600 also saves the information entered on this page, so that the first user does not have to re-register an alias every time the first user receives a P2P money transfer.

The process then proceeds to block 2075 where the first user enters the alias in the appropriate textbox, confirms the alias in the appropriate textbox, selects the account to receive the funds from the drop-down list, and checks the checkbox that indicates that the first user accepts the terms that govern the transfer. In some embodiments, the accounts listed in the drop-down list are identified only by selected few digits of the account numbers.

In some embodiments, the process then proceeds to block 2077 where the mobile banking system 1600 requires additional authentication to register an alias. The mobile banking system 1600 displays a widget which serves as an additional authenticating step before saving the information of the first user's associated alias. The mobile banking system 1600 indicates to the first user that by activating in the widget on the button for a sending a code, the first user will receive a code on his or her mobile device. In another embodiment, the first user may receive a code through other means such as email, snail mail, etc. In one embodiment, the widget is a “SafePass®” widget and the user can send a “SafePass” code to the first user's mobile device.

The process then moves to block 2079 of FIG. 20B where the first user performs an additional authenticating step. The first user activates on the widget's button for sending a code to the first user's mobile device. The first user than receives on his or her mobile device the code that he or she must input into the widget. Once the first user inputs the correct code into the widget and presses a button in the widget to confirm that the code is correct, the button that corresponds to adding a new recipient is activated so that it can now be activated by the first user. The first user (recipient) activates this button so that the mobile banking system 1600 can store the first user's alias. The first user can activate a designated button on the page which indicates that the first user wishes to proceed with receiving the transfer. The mobile banking system 1600 indicates to the first user that by activating the button to continue with receiving the transfer, the first user will receive an enrollment code.

The process then moves to block 2080 of FIG. 20D where the mobile banking system 1600 uses the registered alias to send an enrollment code to the device of the first user (recipient) associated with the alias.

The process then moves to block 2082 of FIG. 20D where the mobile banking system 1600 prompts the first user to enter the enrollment code that the first user received on the device associated with the alias. The mobile banking system 1600 indicates to the first user that the first user must verify the alias (e.g., mobile number) to complete enrollment in the mobile P2P transfer service. In one embodiment, the webpage indicates to the first user that the first user should expect a text message from the financial institution that manages the mobile banking system 1600. The page also has activatable text if the first user would like to know more about the use of enrollment codes. The page indicates to the first user, the enrollment code must be entered into the appropriate textbook in order verify ownership of the mobile number or email address associated with the alias and complete enrollment with the P2P transfer service. The mobile banking system 1600 also indicates to the first user that the enrollment number expires in a pre-determined number of minutes. After the enrollment number expires, the mobile banking system 1600 will not be able use that enrollment code to verify ownership of the first user's mobile number associated with the transfer and will not be able to complete the enrollment of the first user (recipient). The webpage also has activatable text to get help if the first user has not received an enrollment code or if the enrollment code has expired. The page indicates to the first user that messaging and data rates may apply for receiving the enrollment code. The page also has two buttons—a first button configured to allow the first user to indicate a desire not to proceed with the transaction and a second button configured to allow the first user to indicate a desire to proceed with receiving the transfer. The second button only moves from a dormant state to an activatable state after the first user enters an enrollment code on the page. In an embodiment, the second button only becomes activatable after the first user enters a valid and unexpired enrollment code on the page.

The process then moves to block 2084 where the first user enters the enrollment code into the appropriate textbox.

The process then moves block 2086 where the mobile banking system 1600 determines if the enrollment code entered by the first user matches the enrollment code sent by the mobile banking system 1600 to the alias of the first user.

If the entered code in 2086 does not match the code sent to the alias, then the mobile banking system 1600 displays a graceful error message to the first user that the transaction cannot move any further. In one embodiment, the mobile banking system 1600 allows the first user to correct any errors in the alias provided by the first user or in the code received by the first user. In one embodiment, the mobile banking system 1600 only grants a pre-determined number of unsuccessful attempts to verify the code before rejecting the transfer.

If the entered code in 2086 matches the code sent to the alias, the process moves to block 2088 where the mobile banking system 1600 processes any pending transfers involving the newly registered alias. The mobile banking system 1600 indicates to the user that the verification of the alias has been completed. The mobile banking system 1600 thanks the user for setting up an alias to accept transfers. The mobile banking system 1600 indicates to the first user that people or entities can now send money to the first user using the first user's alias. The mobile banking system 1600 indicates to the first user that any transfer to the first user's newly registered alias will be deposited to the account number shown on the webpage. In one embodiment, the mobile banking system 1600 only shows a selected few digits of the first user's financial institution account number. The page also indicates to the first user that the transfer request is now in process. The page shows details of the transfer, including, but not limited to the name of the sender, the amount, the date on which the sender sent the amount, the confirmation number, and the status of the transfer. The page also two buttons. The first button allows the first user to add another alias and the second button allows the first user make a transfer using the newly registered alias.

The process then moves to block 2090 where the mobile banking system 1600 sends the alias to the alias data repository 1700 along with associated account information to be stored in the alias datastore.

In one embodiment, the mobile banking system 1600 presents four hyperlinks under the transfers hyperlink described earlier. These four hyperlinks are a hyperlink for a making a transfer, a hyperlink for reviewing transfers, a hyperlink for adding recipients, and a hyperlink for managing accounts. Using the appropriate hyperlink, the first user has the option of obtaining set up to accept transfer by activating an appropriate link. The mobile banking system 1600 indicates to the first user (recipient) that the first user may activate the link if the first user received a transfer notice, i.e., the first user received an email, text message, or other form of electronic communication that someone has sent money to the first user. The mobile banking system 1600 indicates to the first user that in order to complete the transfer and collect the funds, the first user must set up the first user's alias to accept transfers. The mobile banking system 1600 also presents a activatable link so that the first user can be directed to a page to learn more about this P2P transfer via alias method. The mobile banking system 1600 also presents a help box where the first user can understand more about what the first user can do using the mobile banking system 1600, what the first user needs to know, and what else the first user can do using the mobile banking system 1600. The mobile banking system 1600 also presents a message to the first user that transferring money within the bank is fast and free. The mobile banking system 1600 also indicates to the customer that the feature of making a P2P transfer using a recipient's alias is a new feature, and that transfers within the bank now include transfers made using a recipient's alias. Alternatively, a user who intends to receive money using an alias can get set up by activating the link associated with obtaining a set up to accept transfers. A user who accesses the mobile banking system 1600 can register an alias by selecting an appropriate link. Therefore, in one embodiment, the user does not have to wait to receive a payment using the mobile P2P transfer service before setting up an alias to receive transfers. In one embodiment, the user can register an alias using a mobile device, while in another embodiment, the user can register an alias using a personal computing device.

In one embodiment of the invention, both the sender and the recipient need to have financial institution accounts registered for mobile P2P transfer via alias. In another embodiment of the invention, the sender needs to have a financial institution account registered for mobile P2P transfer via alias, but the recipient does not need to have a financial institution account registered for mobile P2P transfer via alias. In another embodiment of the invention, the recipient needs to have a financial institution account registered for mobile P2P transfer via alias, but the sender does not need to have a financial institution account registered for mobile P2P transfer via alias.

### Text Message P2P Payment Send Process and Interface

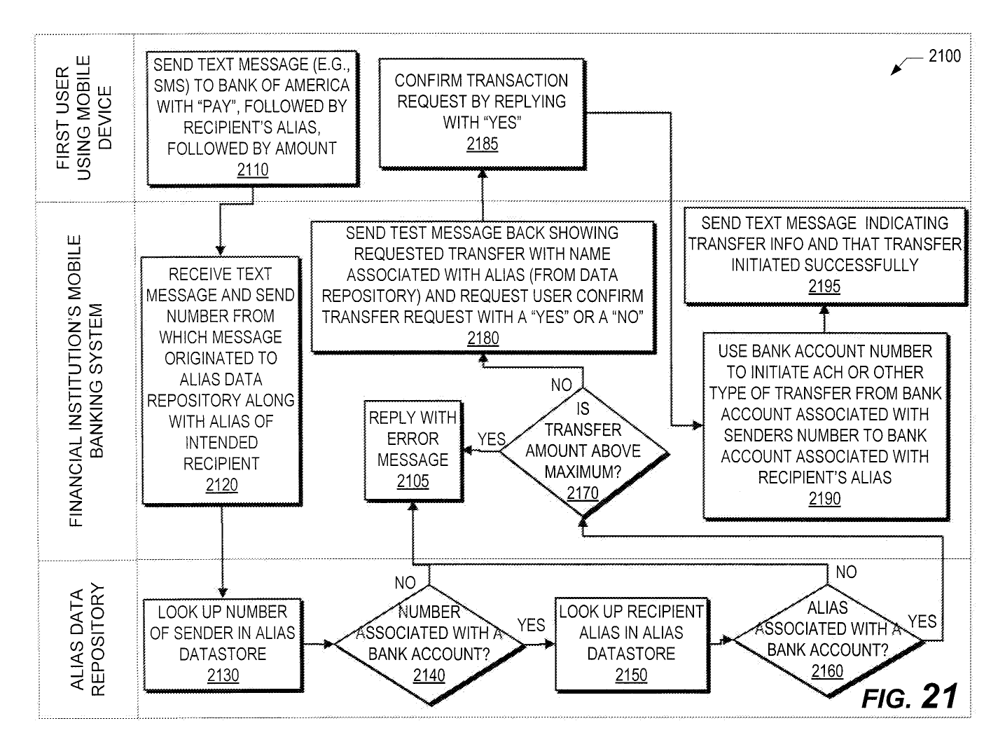

FIG. 21 provides a flow chart illustrating a process 2100 for sending P2P payments via text message, in accordance with an embodiment of the invention. FIG. 21 illustrates the flow chart in terms of “swim lanes” associated with entities which may perform the operations in each respective swim lane. The entities illustrated in the exemplary Figure are a financial institution's mobile banking system 1600, a first user (sender) 1310 using a first personal computing or mobile device 1400, and an alias data repository 1700. However, it should be noted that other entities could also be involved and some embodiments of the invention may not be limited to the three entities illustrated in FIG. 21. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

All features that are described above as being part of the mobile P2P payment process and interface are also part of the text message P2P payment process and service. In one embodiment of the invention, the text message P2P payment send process and interface is a feature provided in the mobile P2P payment send process and interface. In another embodiment of the invention, the text message P2P payment send process and interface is distinct from the mobile P2P payment send process and interface. This text message P2P transfer feature is particularly useful for users who carry mobile devices that do not have computing resources and cannot access the Internet, i.e., mobile devices that only have messaging features and can only access a phone network.

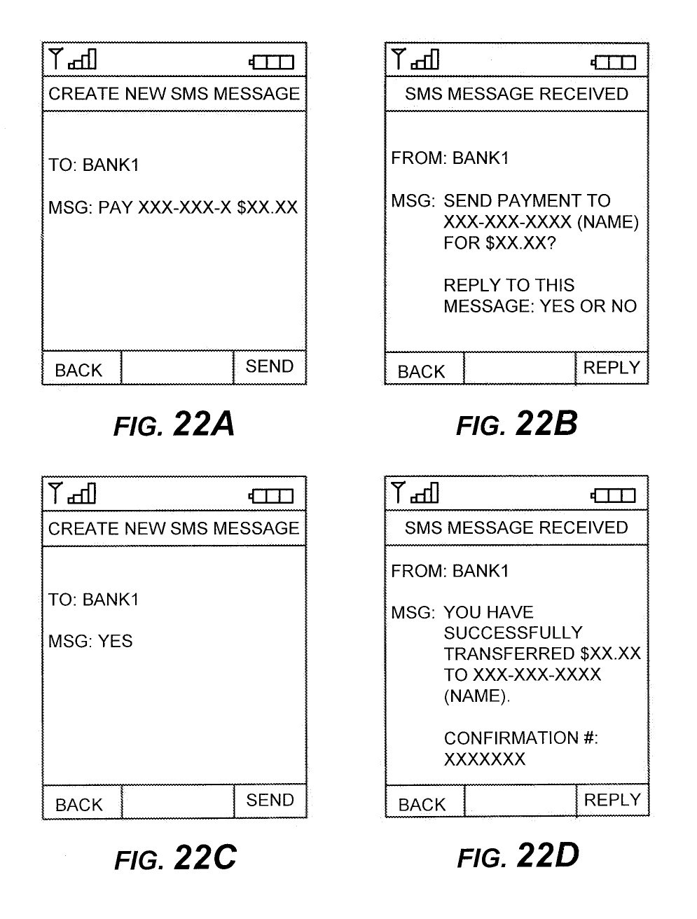

Referring to FIG. 21, the process starts in block 2110 of FIG. 21 where the first user 1310 (sender) sends a text message to a phone number associated with a mobile banking system 1600 in a format that is recognized by the mobile banking system 1600. In one embodiment, the format includes the word “Pay” followed by the recipient's alias followed by the amount that the first user intends to transfer. An illustration of the text message that the first user sends in block 2110 of FIG. 21 is displayed in FIG. 22A. FIG. 22A shows that the text message is directed to “Bank X” and the message is to pay the sum of $20 to the recipient associated with the alias phone number.

The process then moves to block 2120 in FIG. 21 where the mobile banking system 1600 receives the text message from the first user and sends the number from which the message originated to the alias data repository 1700 along with the alias of intended recipient.

The process then moves to block 2130 in FIG. 21 where the alias data repository 1700 looks up the number of the first user (sender) in the alias datastore.

The process then moves to block 2140 in FIG. 21 where the alias data repository 700 determines if the number of the first user is a number associated with a financial institution account. If the alias data repository 1700 determines that the number of the first user is not a number associated with a financial institution account, the mobile banking system 1600 replies to the first user with a graceful error message that the transaction cannot be completed (see block 2105). In one embodiment, the error message is sent via text message, however, in other embodiments, the error message can be sent by any form of communication such as email, placing a phone call to the first user, snail mail etc.

If, in block 2140, the alias data repository 1700 determines that the number of the first user is a number associated with a financial institution account, then the process moves to block 2150 in FIG. 21 where the alias data repository 1700 looks up the recipient alias in the alias data store.

The process then moves to block 2160 in FIG. 21 where the alias data repository 1700 determines if the recipient's alias is associated with a financial institution account. If the alias data repository 1700 determines that the recipient alias is not associated with a financial institution account, the mobile banking system 1600 replies to the first user with a graceful error message that the transaction cannot be completed (see block 2105). In one embodiment, the error message is sent via text message, however, in other embodiments, it can be sent by any form of communication such as email, placing a phone call to the first user, snail mail etc.

If, in block 2160, the alias data repository 1700 determines that the recipient alias is associated with a financial institution account, then the process moves to block 2170. At block 2170, the mobile banking system 1600 determines whether the transfer amount is above the maximum that may be transferred in this transaction. If the mobile banking system 1600 determines that the transfer amount is above the maximum that may be transferred in this transaction, then the mobile banking system 1600 replies to the first user with a graceful error message that the transaction cannot be completed (see block 2105). In one embodiment, the error message is sent via text message, however, in other embodiments, it can be sent by any form of communication such as email, placing a phone call to the first user, snail mail etc.

If, in block 2170, the mobile banking system 1600 determines that the transfer amount is not above the maximum that may be transferred in this transaction, then the mobile banking system 1600 sends a text message to the first user showing the requested transfer with the recipient name associated with the alias and requesting that the first user confirm the transfer request, wherein the format of the return confirmation text message is specified in the text message. In one embodiment, the recipient name associated with the alias is received from the alias data repository 1700. In one embodiment, the text message in 2180 sent from the mobile banking system 1600 specifies that the first user can confirm the transfer request with a “Yes” and can reject the transfer request with a “No.” In other embodiments, the “Yes” and the “No” can be any letters, characters, or combinations thereof as defined by the mobile banking system 1600. An illustration of the text message that the mobile banking system 1600 sends to the first user in block 2180 of FIG. 21 is displayed in FIG. 22B. FIG. 12B shows that the text message is from “Bank X” and the message is whether the mobile banking system 1600 should send a sum of money to a recipient who is identified by both an alias and a name. The text message also specifically informs the first user that the first user can confirm the payment with a “Yes” and can reject the payment with a “No.”

The process then moves to 2185 where the first user confirms the transaction request by replying to text message in 2180 with a “Yes.” In other embodiments, the first user can confirm the transaction request in the format as specified in the text message sent in 2180 from the mobile banking system 1600 to the first user. An illustration of the text message that the first user sends in block 2185 of FIG. 21 is displayed in FIG. 22C. FIG. 22C shows that the text message is directed to “Bank X” and the message is “Yes.” This indicates that the first user is willing to go ahead with the payment.

The process then moves to block 2190 where the mobile banking system 1600 uses the first user's and the recipient's financial institution account numbers to initiate ACH or other type of transfer from the financial institution account associated with the first user's (sender's) phone number to the financial institution account associated with the recipient's alias.

The process then moves to block 2195 where the mobile banking system 1600 sends a text message to the first user with information regarding the transfer and with a message that the transfer initiated successfully. An illustration of the text message that the mobile banking system 1600 sends to the first user in block 2195 of FIG. 21 is displayed in FIG. 12D. FIG. 22D shows that the text message is from “Bank X” and the message is that the first user has successfully transferred a sum of money to a recipient who is identified by name and alias. The text message also provides the first user with a confirmation number for the transfer.

### Mobile Banking P2P Payment Management Process and Interface

As shown in FIG. 19G according to one embodiment of the invention, the mobile P2P payment system client application 1694 displays a bank menu page on which the first user can navigate to an accounts function, a bill-paying function, a transfer funds function, or a location function. In one embodiment, each of these navigable options is a hyperlink, whereas in another embodiment, each of these navigable options is a button. The mobile P2P payment system client application 1694 indicates to the first user that the first user is in a secure area of the mobile banking system 1600. The bank menu page also has a text area where error messages are displayed. The mobile P2P payment system client application 1694 always allows users to sign out from their accounts by providing an appropriate button or hyperlink.

### Fraud Data Exchange System

According to embodiments of the invention, a fraud data exchange system is provided for processing a transfer request using shared fraud data including receiving a transfer request comprising information corresponding to an account to be debited and information corresponding to an account to be credited, approving the information corresponding to the account to be debited, and accessing a database to retrieve fraud data. The database includes fraud data shared among two or more financial institutions, and the fraud data includes a plurality of entries, each entry corresponding to one or more accounts and comprising one or more data fields. Each data field corresponds to a characteristic of the one or more accounts and tends to indicate whether the transfer request is fraudulent. The method includes determining a likelihood of fraudulent activity, based at least in part on the accessed fraud data and determining, based at least in part on the determined likelihood of fraudulent activity, whether to complete the transfer.

In some embodiments, the database includes a plurality of registered aliases, each associated with a user owning one or more accounts. In some embodiments, the method includes determining whether an alias received along with the transfer request is registered in the database. In some such embodiments, accessing the database to retrieve fraud data includes accessing fraud data associated with the alias received along with the transfer request.

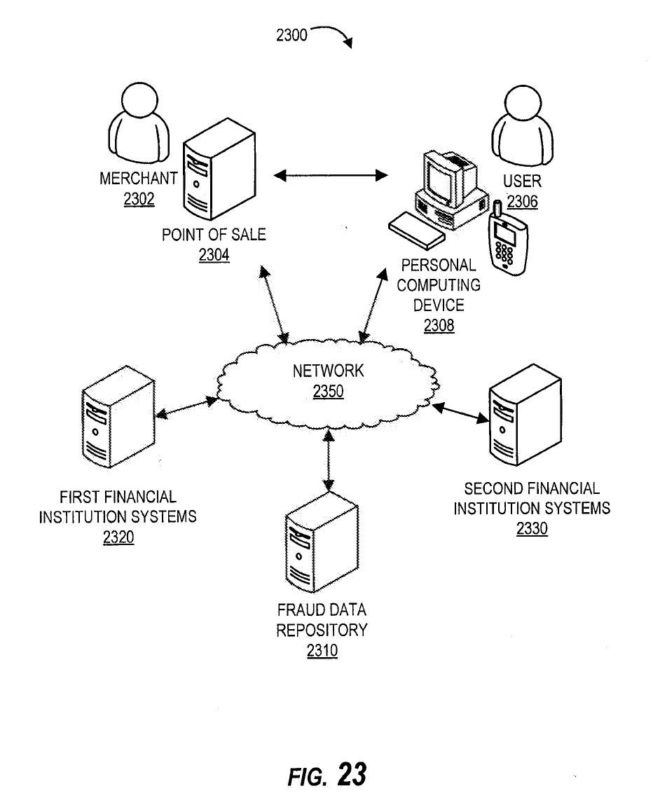

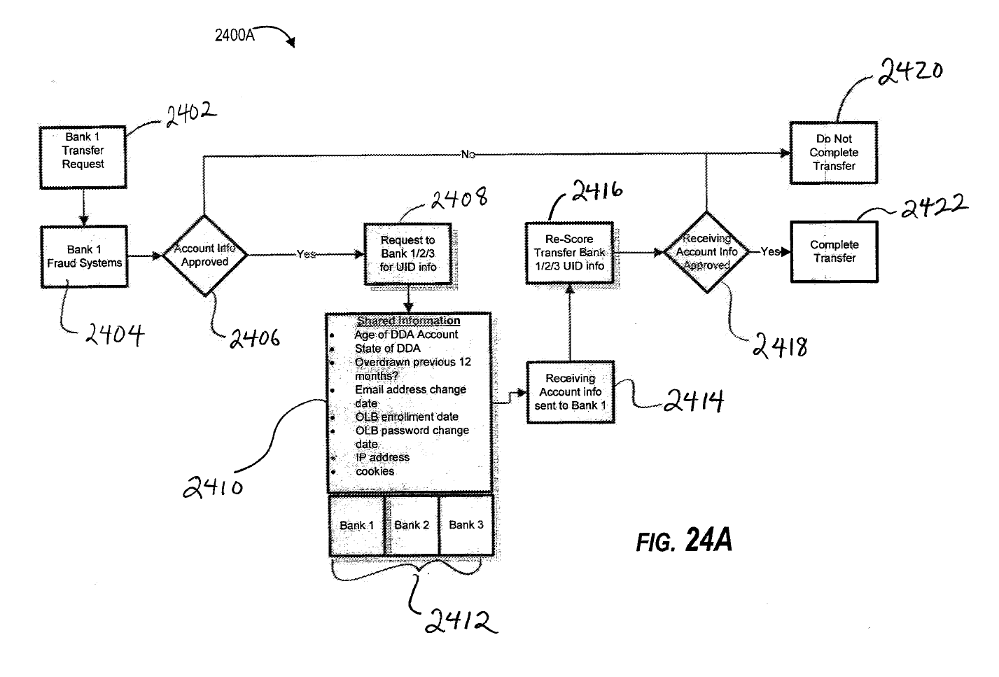

Referring to FIG. 23, a fraud data exchange system 2300 according to embodiments of the invention is illustrated. As shown, a merchant 2302 owns, manages or is otherwise associated with a point of sale 2304, which may be a virtual point of sale such as an online marketplace or a physical point of sale such as a register in a store. A user 2306, in some embodiments, interacts with the point of sale 2304 using a personal computing device 2308 such as a computer system or mobile device as described in detail above with reference to FIG. 3 and FIG. 13, respectively. In other embodiments, a first user initiates a transaction with a second user or a user initiates a transfer request, either from an automated teller machine (ATM) or an online banking interface or otherwise from a transferring account to a transferee account. In some embodiments, the user 2306 interacts with the merchant 2302 or other user directly, that is, with communicating across a network outside a physical point of sale, and in other embodiments, the user 2306 communicates with the merchant or other user across a network.

In various other embodiments, the user 2306 interacts over a network 2350 with one or more financial institution systems and/or servers such as first financial institution systems 2320. For example, in some instances, the user 2306 communicates with the first financial institution systems 2320 by way of an authenticated online banking interface, and in another example, the user 2306 communicates with the first financial institution systems 2320 by way of a directed interaction with a bank teller, an ATM or otherwise. In one example, the user 2306 requests a transfer from an account maintained by the first financial institution with another account, such as another account maintained by the first financial institution or an account maintained by another financial institution.

Various pieces of data tend to indicate a fraudulent transaction. For example, an age of a demand deposit account (DDA) such as a checking or savings account tends to indicate whether a transfer request to the account is fraudulent. For example, if the DDA has only been open a week, then the changes that a transfer into the DDA is higher than a transfer request into a DDA having been open a year. Likewise, the state of the DDA may indicate a fraudulent request. For example, if the transferee account has a zero balance, it is more likely that the transfer request is fraudulent than if the transferee account has a high balance. Other data that may be indicative of a fraudulent transfer request include whether the transferee account has been overdrawn in the previous 12 months, whether there has been an email address change recently regarding either the transferring account or the transferee account, whether the online banking enrollment date for either account is recent or not, whether the online banking password change date is recent or not, whether the IP address associated with the computer initiating the request has been identified as an IP address associated with previous fraudulent transfer requests, transactions, and/or other fraudulent activity, whether any cookies associated with the computer initiating the request identify the computer as one previously identified as being associated with fraudulent activity, and the like.

Such information is available to a financial institution in certain situations, such as, for example, where the transferee account was opened and is maintained by the financial institution, such as by using the second financial institution systems 2330. However, some of this information is not publicly available to other financial institutions, such as the first financial institution. A fraud data repository 2310 is a centralized location in which multiple financial institutions may store fraud data such as the data discussed above so that other financial institutions may utilize the fraud data as they see fit. In one example, two or three financial institutions contract with one another to share data indicative of fraudulent activity and that is not tied to non-public information (NPI). That is, sensitive information is not exchanged in many embodiments. The fraud data regarding the transactions and customers of the participating financial institutions is compiled and stored for access by any of the participating institutions in the event of a transfer request involving an account maintained by one of the participating financial institutions. In this regard, the financial institution accessing the stored data may retrieve the stored data and perform analysis of the data. Such analysis may be unique to the specific financial institution processing the transfer request. That is, each of the participating financial institutions may have different methods by which fraudulent activity is determined and/or predicted based on the accessed data. In other embodiments, two or more of the participating financial institutions may share methodology for determining predicted fraudulent activity. In some embodiments, the fraud data repository 2310 includes one or more computing devices configured to calculate the likelihood of fraudulent activity and communicate the calculation to the requesting financial institution system, such as first financial institution systems 2320.

In various embodiments, the fraud data repository 2310 is or is part of the alias data repository 700 of FIG. 3 and/or FIG. 13. In some embodiments, alias information stored in the alias data repository 700 of FIG. 3 and/or FIG. 13 includes fraud data associated with the each alias. In other embodiments, the fraud data is associated with one or more accounts associated with one or more aliases. In this way, when a user provides an alias for recognition, the system may access the fraud data associated with the alias and provide it to the requesting financial institution.

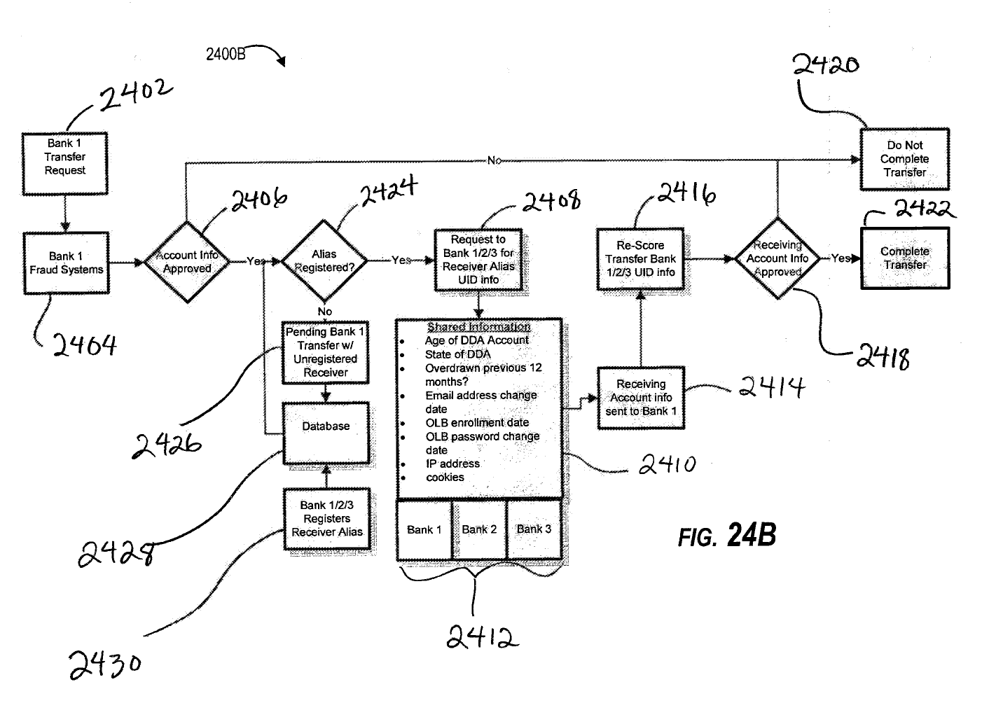

Referring now to FIG. 24A, a combined flow chart and block diagram illustrates a method 2400A for processing a transfer request according to embodiments of the invention. First, Bank 1 requests a transfer, as represented by block 2402. This request is in response to a request from a user, such as from an online banking user. As represented by block 2404, Bank 1 then communicates the transfer request to one or more of its servers, which are referred to as back end systems in some embodiments. Next, a determination is made, as represented by decision block 2406, regarding whether the account information provided with the transfer request is approved. For example, Bank 1's back end systems determine that the account is a valid, active account. If so, the next step, as represented by block 2408, is that Bank 1 requests fraud data corresponding to the account or accounts associated with the transfer request from a database of shared information 2410. If the account information is not approved by Bank 1's back end systems, then the transfer is not completed, as represented by block 2420.

As illustrated, in various embodiments, two or more financial institutions, such as Bank 1, Bank 2 and Bank 3, as represented by blocks 2412, may collaborate and form an arrangement whereby fraud data is pulled from each of the participating institutions and stored in a central database for retrieval by a requesting participating institution. In some embodiments, no central database is constructed, but rather, one or more of the institutions retains their fraud data in a format and location accessible to the other participating institution(s). In some embodiments, one or more of the participating institutions consolidate their fraud data into a central database accessible by the participating institutions and one or more of the participating institutions retain their fraud data in one or more repositories maintained by the respective participating institutions and accessible to the other participating institutions. In some embodiments, a participating institution may consolidate some of its fraud data in the central database and retain some of its fraud data in one or more repositories maintained by the institution and accessible to the other participating institutions.

Once the requesting institution, such as Bank 1, has received the account information and/or the fraud data, as represented by block 2414, Bank 1 determines a likelihood of fraudulent activity score, as represented by block 2416 based at least in part on the shared information or fraud data. In some embodiments, the institution takes into consideration one or more of the characteristics represented in the fraud data. In some embodiments, each of the characteristics is analyzed to determined whether a potentially fraudulent activity is requested. For example, in some embodiments, predetermined thresholds are established such that if the particular characteristic is higher or lower than the threshold then a certain point total is assigned. In some embodiments, once the cumulative point total rises above a predetermined threshold, then the institution makes a determination that the likelihood of a fraudulent activity is high enough to justify declining the transaction.

The next step, as represented by decision block 2418 is approving the receiving account information. For example, once the likelihood of fraudulent activity is determined, then a determination is made regarding whether to approve the transaction based on the likelihood of fraudulent activity score. If the receiving account information is approved, then the transfer is completed as represented by block 2422. If it is not approved, then the transfer is not completed as represented by block 2420.

In some embodiments, determination of decision block 2418 is performed manually. That is, for example, once the likelihood of fraudulent activity score is determined, the score is escalated for consideration. In some embodiments, the determination is escalated automatically, either if it rises above a predetermined threshold or, in some embodiments, every score is escalated for review to determine whether the transfer should be completed. In some embodiments, one or more of the characteristics represented in the fraud data are analyzed for a first likelihood of fraudulent activity score, and if the first score rises above a predetermined threshold, then the transfer is further considered, either manually or automatically based on one or more of the remaining characteristics represented by the fraud data.

Referring now to FIG. 24B, a combined flow chart and block diagram illustrates another method 2400B for processing a transfer request according to embodiments of the invention. FIG. 24B is very similar to FIG. 24A, however, it includes a determination, as represented by decision block 2424, regarding whether a submitted alias is registered in an alias database, such as database 700 of FIG. 3 and/or FIG. 13. For example, when a user submits a request for a transfer, the user also authenticates and submits an alias for consideration. If the alias is registered, then the alias is accessed in the database and information associated with the alias is retrieved. In some embodiments shared fraud data is stored in the alias database such that a system accessing an alias may retrieve fraud data associated with one or more accounts associated with the alias. For example, a user may own a DDA associated with an alias. When a financial institution receives a request from the user to transfer funds from the user's account, the alias may be retrieved from the database in combination with some of all the fraud data stored therein. The requesting institution may then make a likelihood of fraudulent activity determination based on the retrieved fraud data.

As represented by block 2426, if the alias is unregistered with the alias database 700 or 2428, then the requesting institution, such as Bank 1, Bank 2 or Bank 3 may register the receiver alias, as represented by block 2430. Similar to the method discussed with regard to FIG. 24A, once the likelihood of fraudulent activity has been determined, then it is determined whether the transfer should proceed, as represented by decision block 2418.

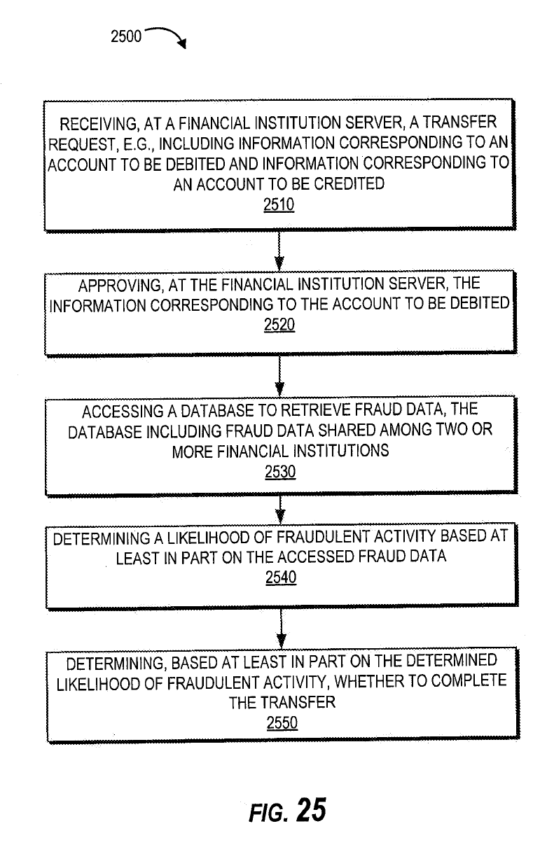

Referring now to FIG. 25, a flowchart illustrates a method 2500 for processing a transfer request according to embodiments of the invention. The first step, as represented by block 2510, is receiving, at a financial institution server, a transfer request. For example, the transfer request may include information corresponding to an account to be debited in a transfer or transaction as well as, in some embodiments, information corresponding to an account to be credited in the transfer or transaction.

The next step, as represented by block 2520, is approving, at the financial institution server, the information corresponding to the account to be debited and/or the information corresponding to the account to the credited.

The next step, as represented by block 2530, is accessing a database, such as fraud data repository 2310 of FIG. 23, to retrieve fraud data shared among two or more financial institutions. In various embodiments, as discussed above, the fraud data repository 2310 may include one or more of the alias data repositories 700 and/or 1700, the customer account data repositories 680 and/or 1680, and/or other components, servers, computers or the like discussed herein or otherwise.

The next step, as represented by block 2540, is determining a likelihood of fraudulent activity based at least in part on the accessed fraud data. The determination of the likelihood of fraudulent activity may be made on an institution-by-institution basis. For example, if three institutions, Bank A, Bank B, and Bank C participate in the fraud data exchange system and exchange pieces of data with one another, then each of Banks A, B and C may have different metrics configured for determining likelihood of fraudulent activity. As a specific example, Bank A may evaluate a first set of the pieces of data to determine whether the set of pieces of data indicate a likely fraudulent activity, whereas Bank B may evaluate a second set of pieces of data different than Bank A's first set in order to determine a likely fraudulent activity. In some embodiments, for example, each of the set of pieces of data are weighted based on their importance, as characterized by each individual financial institution, to the determination of likelihood of fraudulent activity. In some embodiments, for example, the most important data may be weighted by a factor of 10, whereas the least important data may be weighted by a factor of 1, thereby resulting in the most important data having 10 times the effect on the fraud determination score than the least important data.

The final step, as represented by block 2550, is determining, based at least in part on the determined likelihood of fraudulent activity, whether to complete the transfer. For example, if the likelihood of fraudulent activity is a score from 0 to 100, then a financial institution may predetermine that any transfer request associated with a score over 60 indicates that a fraudulent transfer request has likely occurred, and therefore, the transfer should be declined. In this example, if the score is less than 60, then the transfer is completed, and if not, the transfer is cancelled. In various embodiments, a range of scores, such as from 50 to 60 may require escalation for consideration by a secondary analysis and/or an administrator or other individual(s).

In some embodiments, additional steps may be included in addition to those shown. For example, information regarding the likelihood of fraudulent activity may be stored for subsequent further analysis, the determination may be incorporated into new or modified fraud data stored in the fraud data repository, communications may be initiated to the owner of the transferring account and/or the transferee account if appropriate, and/or the like.

In various embodiments, one or more of the components illustrated are not included in the system 2300, and in other embodiments, additional components not illustrated in FIG. 23 are included in the system 2300. For example, additional financial institution systems and/or servers may be included in various embodiments.

As will be appreciated by one of skill in the art, the invention may be embodied as a method (including, for example, a computer-implemented process, a business process, and/or any other process), apparatus (including, for example, a system, machine, device, computer program product, and/or the like), or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the invention may be written in an object oriented, scripted or unscripted programming language such as Java, Perl, Smalltalk, C++, or the like. However, the computer program code for carrying out operations of embodiments of the invention may also be written in conventional procedural programming languages, such as the “C” programming language or similar programming languages.

Embodiments of the invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for processing a transfer request using shared fraud data, the method comprising:
receiving, at a computing device, a transfer request comprising information corresponding to an account to be debited and information corresponding to an account to be credited;
approving, using a computing device, the information corresponding to the account to be debited;
accessing, using a computing device, a database to retrieve fraud data, the database comprising fraud data shared among two or more financial institutions, the fraud data comprising a plurality of entries, each entry corresponding to one or more accounts and comprising one or more data fields, each corresponding to a characteristic of the one or more accounts and tending to indicate whether the transfer request is fraudulent;
determining, using a computing device, a likelihood of fraudulent activity, based at least in part on the accessed fraud data; and
determining, based at least in part on the determined likelihood of fraudulent activity, whether to complete the transfer.

2. The method of claim 1, wherein the database comprises a plurality of registered aliases, each associated with a user owning one or more accounts.

3. The method of claim 2, further comprising determining whether an alias received along with the transfer request is registered in the database.

4. The method of claim 3, wherein accessing the database to retrieve fraud data comprises accessing fraud data associated with the alias received along with the transfer request.

5. The method of claim 1, wherein the fraud data comprises one or more of age of an account, state of an account, overdrawn information, email address change information, online banking enrollment information, online banking password change information, IP address information, or cookie information.

6. The method of claim 1, wherein the fraud data comprises only publicly available information.

7. The method of claim 1, wherein the fraud data comprises non-sensitive information.

8. A system for processing a transfer request using shared fraud data, the system comprising a computing device configured for:
receiving a transfer request comprising information corresponding to an account to be debited and information corresponding to an account to be credited;
approving the information corresponding to the account to be debited;
accessing a database to retrieve fraud data, the database comprising fraud data shared among two or more financial institutions, the fraud data comprising a plurality of entries, each entry corresponding to one or more accounts and comprising one or more data fields, each corresponding to a characteristic of the one or more accounts and tending to indicate whether the transfer request is fraudulent;
determining a likelihood of fraudulent activity, based at least in part on the accessed fraud data; and
determining, based at least in part on the determined likelihood of fraudulent activity, whether to complete the transfer.

9. The system of claim 8, wherein the database comprises a plurality of registered aliases, each associated with a user owning one or more accounts.

10. The system of claim 9, wherein the computing device is further configured for determining whether an alias received along with the transfer request is registered in the database.

11. The system of claim 10, wherein accessing the database to retrieve fraud data comprises accessing fraud data associated with the alias received along with the transfer request.

12. The system of claim 8, wherein the fraud data comprises one or more of age of an account, state of an account, overdrawn information, email address change information, online banking enrollment information, online banking password change information, IP address information, or cookie information.

13. The system of claim 8, wherein the fraud data comprises only publicly available information.

14. The system of claim 8, wherein the fraud data comprises non-sensitive information.

15. A computer program product comprising a non-transient computer-readable medium comprising computer-executable instructions for processing a transfer request using shared fraud data, the instructions comprising:
instructions for receiving a transfer request comprising information corresponding to an account to be debited and information corresponding to an account to be credited;
instructions for approving the information corresponding to the account to be debited;
instructions for accessing a database to retrieve fraud data, the database comprising fraud data shared among two or more financial institutions, the fraud data comprising a plurality of entries, each entry corresponding to one or more accounts and comprising one or more data fields, each corresponding to a characteristic of the one or more accounts and tending to indicate whether the transfer request is fraudulent;
instructions for determining a likelihood of fraudulent activity, based at least in part on the accessed fraud data; and
instructions for determining, based at in part on the determined likelihood of fraudulent activity, whether to complete the transfer.

16. The computer program product of claim 15, wherein the database comprises a plurality of registered aliases, each associated with a user owning one or more accounts.

17. The computer program product of claim 16, wherein the instructions further comprise instructions for determining whether an alias received along with the transfer request is registered in the database.

18. The computer program product of claim 17, wherein the instructions for accessing the database to retrieve fraud data comprise instructions for accessing fraud data associated with the alias received along with the transfer request.

19. The computer program product of claim 15, wherein the fraud data comprises one or more of age of an account, state of an account, overdrawn information, email address change information, online banking enrollment information, online banking password change information, IP address information, or cookie information.

20. The computer program product of claim 15, wherein the fraud data comprises only publicly available information.

21. The computer program product of claim 15, wherein the fraud data comprises non-sensitive information.
